(19) United States
(12) Patent Application Publication
(10) Pub. No.: US 2025/0101045 A1
(43) Pub. Date: Mar. 27, 2025

(54) SYNTHESIS OF BORON-CONTAINING AMIDOXIME REAGENTS AND THEIR APPLICATION TO SYNTHESIZE FUNCTIONALIZED OXADIAZOLE AND QUINAZOLINONE DERIVATIVES

(71) Applicant: LONG ISLAND UNIVERSITY, Brookville, NY (US)

(72) Inventor: Bhaskar Das, West Nyack, NY (US)

(21) Appl. No.: 18/729,847

(22) PCT Filed: Jan. 17, 2023
(86) PCT No.: PCT/US2023/010974

§ 371 Date: Jul. 17, 2024

Related U.S. Application Data
(60) Provisional application No. 63/300,473, filed on Jan. 18, 2022.

(51) Int. Cl. C07F 5/02

(52) U.S. Cl. CPC C07F 5/025; C07F 5/027

(57) ABSTRACT

The present disclosure is concerned with borylated amidoximes useful in the synthesis of biologically relevant drug-like molecules, including functionalized oxadizole and quinazolinone derivatives. Also disclosed are methods of making borylated amidoximes, methods of making functionalized oxadiazole and quinazolinone compounds using the amidoximes, and functionalized oxadiazole and quinazolinone compounds prepared from borylated amidoximes. This abstract is intended as a scanning tool for purposes of searching in the particular art and is not intended to be limiting of the present invention.

### CROSS-REFERENCE TO RELATED APPLICATIONS

This application claims the benefit of U.S. Application No. 63/300,473, filed on Jan. 18, 2022, the contents of which are incorporated herein by reference in their entirety.

### BACKGROUND

Boron chemicals in various forms have emerged as potent drug candidates in recent years (Das et al. Future Med. Chem. 2013, 5, 653; Adamczyk-Wozniak et al. Chem. Rev. 2015, 115, 5224; Baker et al. Future Med. Chem. 2009, 1, 1275; Baker et al. Chem. Soc. Rev. 2011, 40, 4279; Diaz et al. Nat Chem 2017, 9, 731; Smoum et al. Chem Rev 2012, 112, 4156; Touchet et al. Chem Soc Rev 2011, 40, 3895). For example, Velcade is an aliphatic boronic acid that inhibits protease enzymes, and has been in the market since 2007 as a licensed drug for treating multiple myeloma (Baker et al. Future Med. Chem. 2009, 1, 1275; Pekol et al. Drug Metab Dispos 2005, 33, 771). The benzoxaborole scaffold led to the discovery of AN2690, an antifungal drug developed to treat onychomycosis, an infection of the toenail (Baker et al. J Med Chem 2006, 49, 4447; Hui et al. J Pharm Sci 2007, 96, 2622). GSK2251052, a benzoxaborole moiety tethered with a functional aliphatic alcohol has profound activity against gram-negative bacteria, with a potential to be the first new-class antibacterial in 30 years to treat serious hospital gram-negative infections (Das et al. Future Med. Chem. 2013, 5, 653). Robust clinical activity of Ixazomib against multiple myeloma led to the approval of the drug as the first orally bioavailable human proteasome inhibitor (Moreau et al. N. Engl. J. Med. 2016, 374, 1621; Nazarian and Weinberg Current opinion in investigational drugs (London, England: 2000) 2009, 10, 1236). The importance of boron to activity of the Crisaborole compound as an inflammatory drug that inhibits phosphodiesterase 4B (PDE4B) was demonstrated by replacing boron with carbon, which eliminated activity (Moustafa and Feldman Dermatol Online J 2014, 20, 22608).

Due to empty p-orbitals, boron compounds have a high tendency to accept electrons from heteroatoms and thereby form strong interactions at enzyme action sites. Boron compounds exhibit several forms such as sp² (trigonal) to sp³ (tetragonal) with different ligands affecting their binding properties. The extended stability obtained under various alcohol and water conditions provides a platform for the boron compounds to sustain and conformationally survive during synthesis. Furthermore, the boronic compounds form cyclic hydrogen bonding networks with controllable abilities affecting various biological phenomena. Subsequently the benzoxaboroles are generally advantageous over free boronic acids due to cyclic rigidity and enhanced solubility. In addition, boronic acids also have shown good selectivity towards H₂O₂, and could be potential therapeutic agents to develop new anticancer drugs (Peng and Gandhi Ther. Deliv. 2012, 3, 823; Chen et al. J. Med. Chem. 2014, 57, 4498).

Amidoximes provide extensive pathways to reach certain bioactive heterocycles, including oxadiazoles and quinazolinone (Baykov et al. Tetrahedron Lett. 2020, 152403). Oxadiazoles are highly important pharmacologically, and are well-studied core structural units of various muscarinic agonists, benzodiazepine receptor partial agonists (Katritzky et al. Comprehensive heterocyclic chemistry II; Pergamon, 1996), dopamine transporters (Orlek et al. J Med. Chem. 1991, 34, 2726), antirhinovirals (Watjen et al. J Med. Chem. 2002, 32, 2282), a growth hormone secretagogue (Carroll et al. J Med. Chem. 1993, 36, 2886), and 5-HT agonists (Diana et al. J Med. Chem. 1994, 37, 2421), as well as a urea bioisostere in β3-adrenergic receptor agonists (Ankersen et al. Bioorganic Med. Chem. Lett. 1997, 7, 1293). Despite this significance, however, a synthetic protocol to access a variety of structurally diverse amidoximes that is direct, cost-efficient, and readily amenable to scale-up, has remained elusive. Thus, there remains a need for borylated amidoximes and methods of making and using same, for example, the preparation of pharmacologically active boron compounds (e.g., functionalized oxadiazoles, quinazolinones).

### SUMMARY

In accordance with the purpose(s) of the invention, as embodied and broadly described herein, the invention, in one aspect, relates to borylated amidoxime compounds useful in, for example, the synthesis of functonalized oxadiazole and quinazolinone derivatives. These amidoxime compounds exhibit broad synthetic utility towards obtaining a variety of biologically relevant drug-like molecules. Advantages obtainable via these compounds include, but are not limited to, a metal-free route to boronated oxadiazole and quinazolinone derivatives, and reduction of the multistep sequences. Importantly, the instantly disclosed boron-rich pharmacophore derived compounds can be obtained through an efficient and inexpensive strategy.

Thus, disclosed are methods of making a compound having a structure represented by a formula:

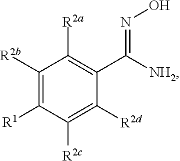

wherein R¹ is selected from —B(OR¹⁰)₂ and —B(R¹¹)₃X; wherein each occurrence of R¹⁰, when present, is independently selected from hydrogen and C1-C8 alkyl; wherein each occurrence of R¹¹, when present, is independently halogen; wherein X, when present, is a counterion; and wherein each of R^{2a}, R^{2b}, R^{2c}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof, the method comprising reacting an aryl cyanide having a structure represented by a formula:

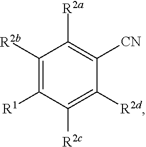

and a hydroxylamine, thereby making the compound.

Also disclosed are methods of making a compound having a structure represented by a formula:

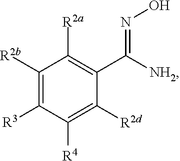

wherein R³ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, and —B(OR¹²)₂; wherein each occurrence of R¹², when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein R⁴ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, —B(OR¹³)₂, and —B(R¹⁴)₃X; wherein each occurrence of R¹³, when present, is independently selected from hydrogen and C1-C8 alkyl; wherein each occurrence of R¹⁴, when present, is independently halogen; wherein X, when present, is a counterion; and wherein each of R^{2a}, R^{2b}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, provided that either R³ is —B(OR¹²)₂ or R⁴ is selected from —B(OR¹³)₂ and —B(R¹⁴)₃, and provided that when R³ is —B(OR¹²)₂, then R⁴ is not —B(OR¹³)₂ or —B(R¹⁴)₃, or a salt thereof, the method comprising reacting an aryl cyanide having a structure represented by a formula:

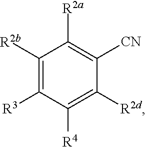

and a hydroxylamine, thereby making the compound.

Also disclosed are methods of making a compound having a structure represented by a formula:

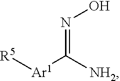

wherein R⁵ is selected from —B(OR¹⁵)₂ and —B(R¹⁶)₃X; wherein each occurrence of R, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein X, when present, is a counterion; and wherein Ar¹ is a C2-C10 heteroaryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof, the method comprising reacting an aryl cyanide having a structure represented by a formula:

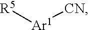

and a hydroxylamine, thereby making the compound.

Also disclosed are compounds having a structure represented by a formula:

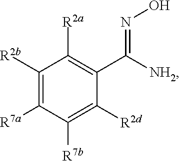

wherein each of R^{7a} and R^{7b} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, and —B(R²⁰)₃X, provided that exactly one of R^{7a} and R^{7b} is —B(R²⁰)₃X; wherein each occurrence of R²⁰, when present, is independently halogen; wherein X, when present, is a counterion; and wherein each of R^{2a}, R^{2b}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof.

Also disclosed are compounds having a structure represented by a formula:

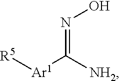

wherein R⁵ is selected from —B(OR¹⁵)₂ and —B(R¹⁶)₃X; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein X, when present, is a counterion; and wherein Ar¹ is a C2—C10 heteroaryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof.

Also disclosed are methods of making a compound having a structure represented by a formula:

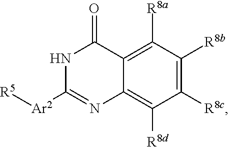

wherein R⁵ is selected from —B(OR¹⁵)₂ and —B(R¹⁶)₃; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein each of R^{8a}, R^{8b}, R^{8c}, and R^{8d}, when present, is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; and wherein Ar² is selected from a C6-C10 aryl and a C2-C10 heteroaryl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a pharmaceutically acceptable salt thereof, the method comprising reacting an amidoxime having a structure represented by a formula:

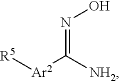

and a carboxylic acid having a structure represented by a formula:

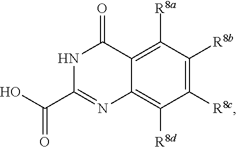

thereby making the compound.

Also disclosed are compounds having a structure represented by a formula:

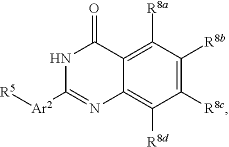

wherein R⁵ is selected from —B(OR¹⁵)₂ and —B(R¹⁶)₃X; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein X, when present, is a counterion; wherein each of R^{8a}, R^{8b}, R^{8c}, and R^{8d}, when present, is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; and wherein Ar² is selected from a C6-C10 aryl and a C2-C10 heteroaryl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a pharmaceutically acceptable salt thereof.

Also disclosed are methods of making a compound having a structure represented by a formula:

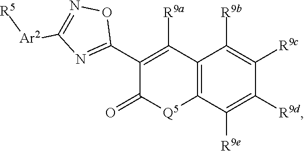

wherein Q⁵ is selected from O and NR²¹; wherein R²¹, when present, is selected from hydrogen and C1-C4 alkyl; wherein R⁵ is selected from —B(OR¹⁵)₂ and —B(R¹⁶)₃X; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein X, when present, is a counterion; wherein each of R^{9a}, R^{9b}, R^{9c}, R^{9d}, and R^{9e}, when present, is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; and wherein Ar² is selected from a C6-C10 aryl and a C2-C10 heteroaryl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a pharmaceutically acceptable salt thereof, the method comprising reacting an amidoxime having a structure represented by a formula:

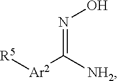

and a carboxylic acid having a structure represented by a formula:

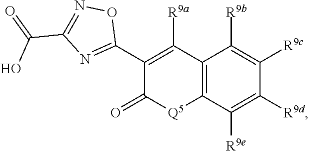

in the presence of a coupling agent, thereby making the compound.

Also disclosed are compounds having a structure represented by a formula:

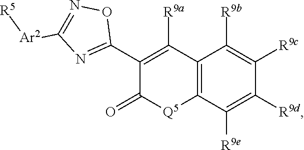

wherein Q⁵ is selected from O and NR²¹; wherein R²¹, when present, is selected from hydrogen and C1-C4 alkyl; wherein R⁵ is selected from —B(OR¹⁵)₂ and —B(R¹⁶)₃X; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein X, when present, is a counterion; wherein each of R^{9a}, R^{9b}, R^{9c}, R^{9d}, and R^{9e}, when present, is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; and wherein Ar² is selected from a C6-C10 aryl and a C2-C10 heteroaryl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a pharmaceutically acceptable salt thereof.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1A-C show representative data for the characterization of boronated amidoxime compound 5. Specifically, FIG. 1A shows a representative ¹H NMR spectrum obtained in DMSO-d₆. FIG. 1B shows a representative ¹³C NMR spectrum obtained in dimethylsulfoxide (DMSO). FIG. 1C shows a representative mass spectrum obtained using High Resolution Mass Spectrometry (HRMS) and Electron Ionization (EI).

FIG. 2A-C show representative data for the characterization of compound 4. Specifically, FIG. 2A shows a representative ¹H NMR spectrum obtained in DMSO-d₆. FIG. 2B shows a representative ¹³C NMR spectrum obtained in DMSO. FIG. 2C shows a representative mass spectrum obtained using High Resolution Mass Spectrometry (HRMS) and Electron Ionization (EI).

FIG. 3A-C show representative data for the characterization of compound 9. Specifically, FIG. 3A shows a representative ¹H NMR spectrum obtained in DMSO. FIG. 3B shows a representative ¹³C NMR spectrum obtained in DMSO. FIG. 3C shows a representative mass spectrum obtained using High Resolution Mass Spectrometry (HRMS) and Electron Ionization (EI).

FIG. 4A-C show representative data for the characterization of compound 8. Specifically, FIG. 4A shows a representative ¹H NMR spectrum obtained in DMSO-d₆. FIG. 4B shows a representative ¹³C NMR spectrum obtained in DMSO. FIG. 4C shows a representative mass spectrum obtained using High Resolution Mass Spectrometry (HRMS) and Electron Ionization (EI).

FIG. 5A-C show representative data for the characterization of compound 13. Specifically, FIG. 5A shows a representative ¹H NMR spectrum obtained in DMSO. FIG. 5B shows a representative ¹³C NMR spectrum obtained in DMSO. FIG. 5C shows a representative mass spectrum obtained using High Resolution Mass Spectrometry (HRMS) and Electron Ionization (EI).

FIG. 6A-C show representative data for the characterization of compound 12. Specifically, FIG. 6A shows a representative ¹H NMR spectrum obtained in DMSO. FIG. 6B shows a representative ¹³C NMR spectrum obtained in DMSO. FIG. 6C shows a representative mass spectrum obtained using High Resolution Mass Spectrometry (HRMS) and Electron Ionization (EI).

FIG. 7A-C show representative data for the characterization of compound 15a. Specifically, FIG. 7A shows a representative ¹H NMR spectrum obtained in DMSO-d₆. FIG. 7B shows a representative ¹³C NMR spectrum obtained in DMSO. FIG. 7C shows a representative mass spectrum obtained using High Resolution Mass Spectrometry (HRMS) and Electrospray Ionization (ESI).

FIG. 8A-C show representative data for the characterization of compound 15b. Specifically, FIG. 8A shows a representative ¹H NMR spectrum obtained in Chloroform-d. FIG. 8B shows a representative ¹³C NMR spectrum obtained in CDCl₃. FIG. 8C shows a representative mass spectrum obtained using High Resolution Mass Spectrometry (HRMS) and Electrospray Ionization (ESI).

FIG. 9A-C show representative data for the characterization of compound 15c. Specifically, FIG. 9A shows a representative ¹H NMR spectrum obtained in Chloroform-d. FIG. 9B shows a representative ¹³C NMR spectrum obtained in CDCl₃. FIG. 9C shows a representative mass spectrum obtained using High Resolution Mass Spectrometry (HRMS) and Electrospray Ionization (ESI).

FIG. 10A-C show representative data for the characterization of compound 15d. Specifically, FIG. 10A shows a representative ¹H NMR spectrum obtained in DMSO-d₆. FIG. 10B shows a representative ¹³C NMR spectrum obtained in DMSO. FIG. 10C shows a representative mass spectrum obtained using High Resolution Mass Spectrometry (HRMS) and Electrospray Ionization (ESI).

FIG. 11A-C show representative data for the characterization of compound 20. Specifically, FIG. 11A shows a representative ¹H NMR spectrum obtained in DMSO. FIG. 11B shows a representative ¹³C NMR spectrum obtained in DMSO.

FIG. 12A-C show representative data for the characterization of compound 21. Specifically, FIG. 12A shows a representative ¹H NMR spectrum obtained in CDCl₃. FIG. 12B shows a representative ¹³C NMR spectrum obtained in CDCl₃.

FIG. 13A-C show representative data for the characterization of compound 18. Specifically, FIG. 13A shows a representative ¹H NMR spectrum obtained in DMSO. FIG. 13B shows a representative ¹³C NMR spectrum obtained in DMSO. FIG. 13C shows a representative mass spectrum obtained using High Resolution Mass Spectrometry (HRMS) and Electrospray Ionization (ESI).

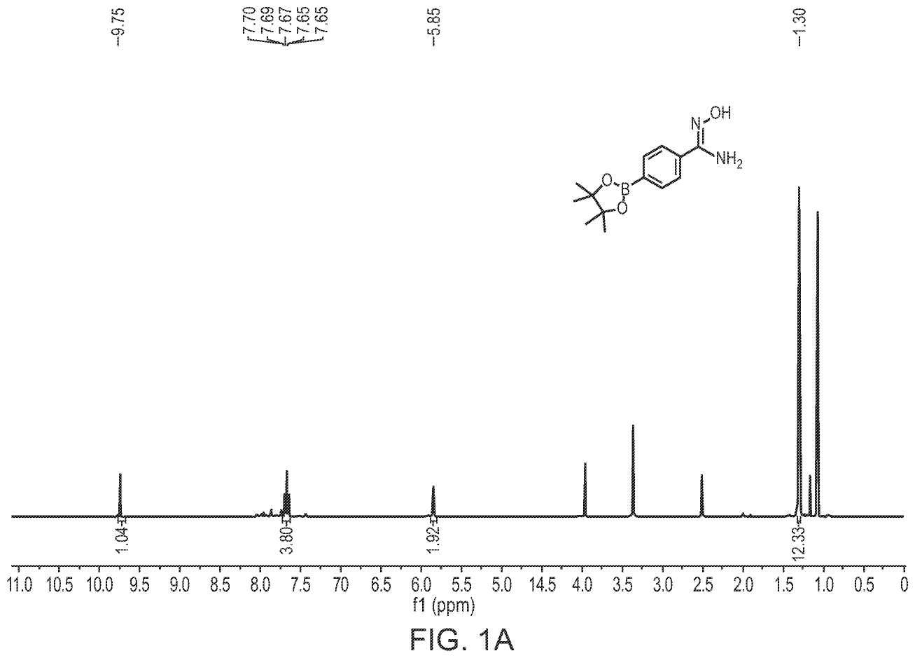

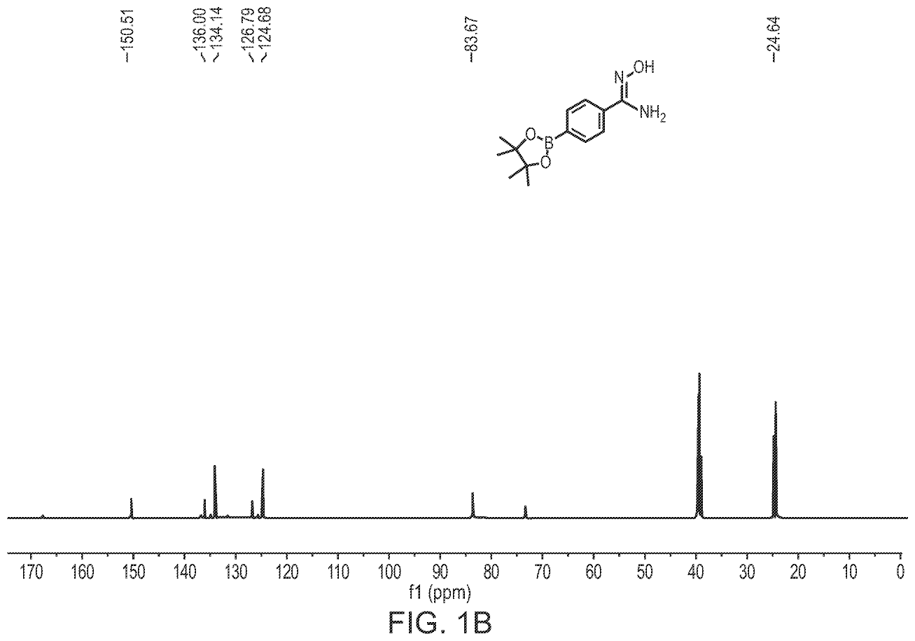

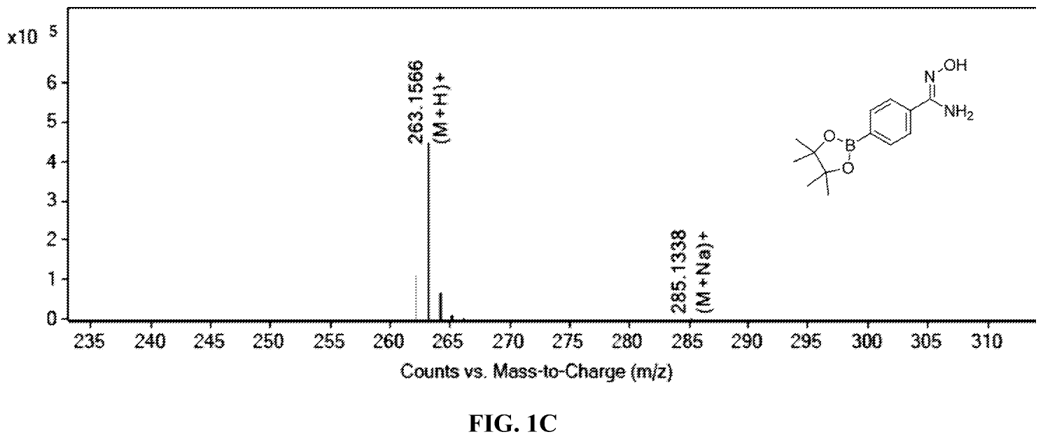

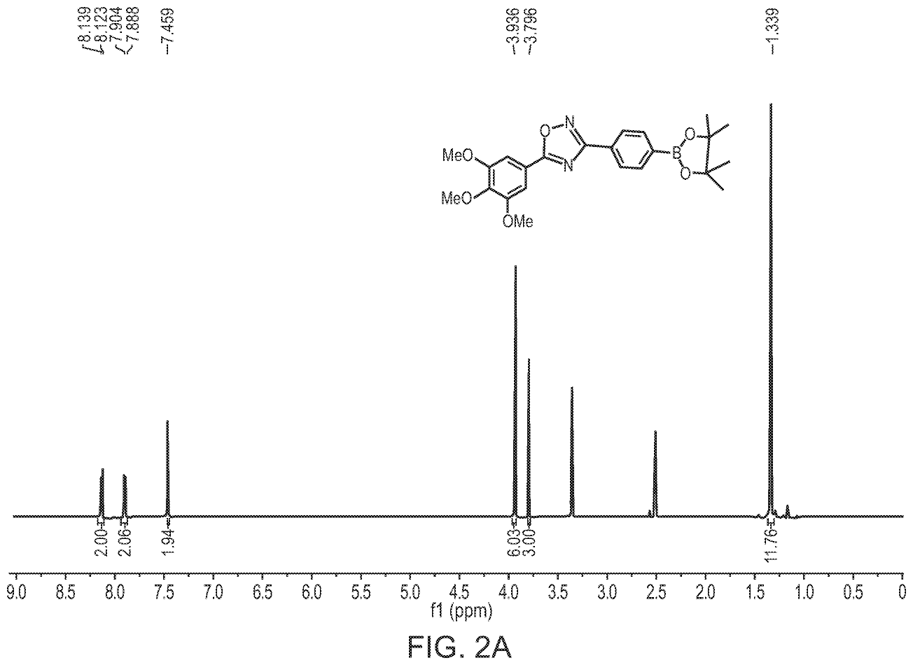

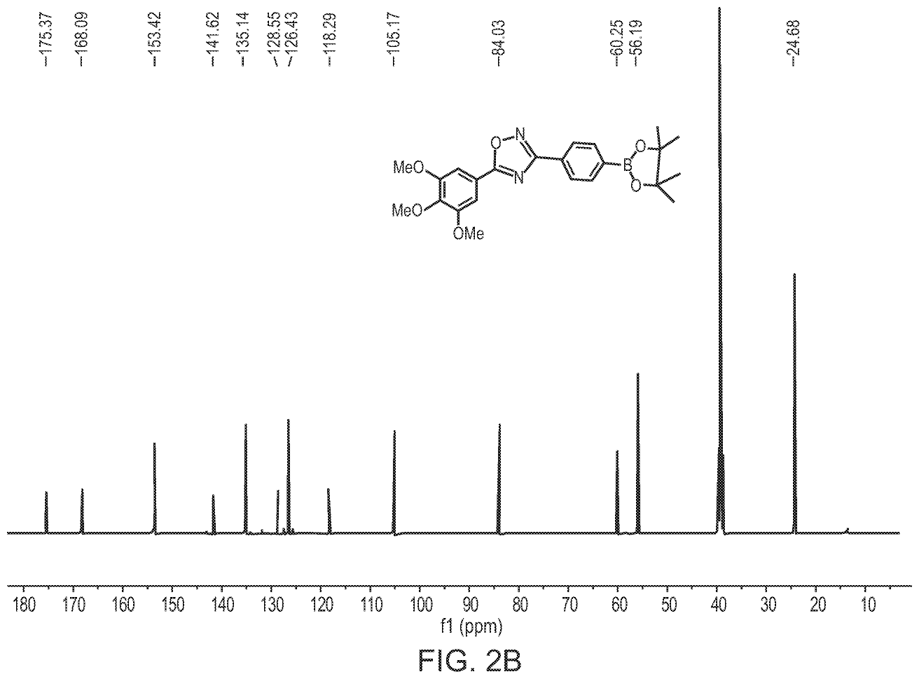

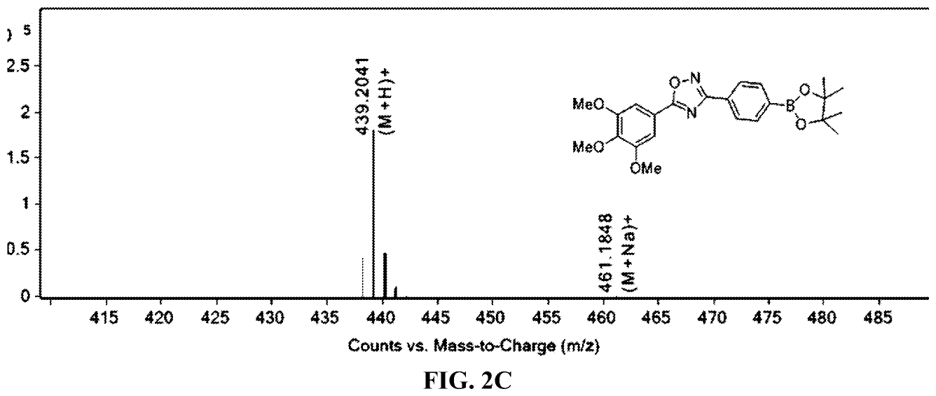

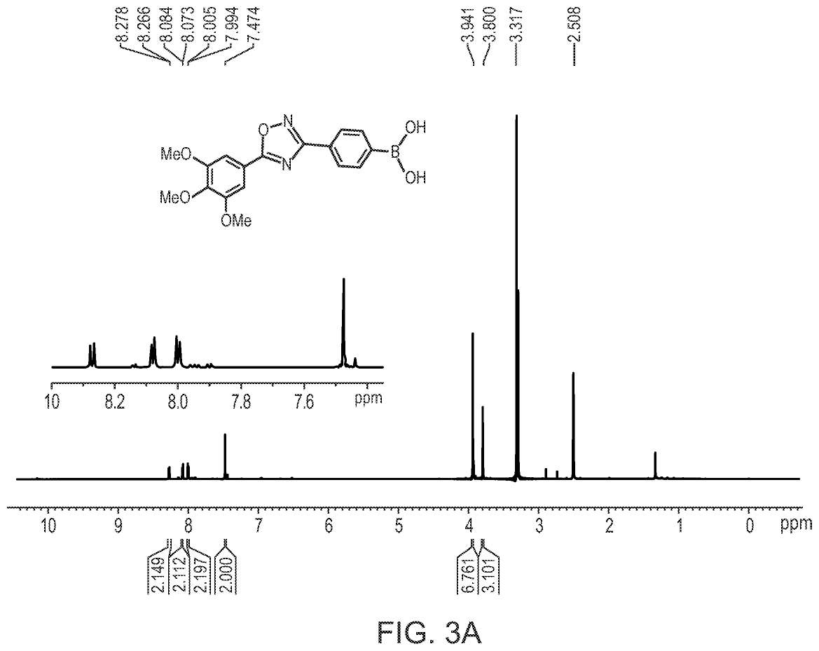

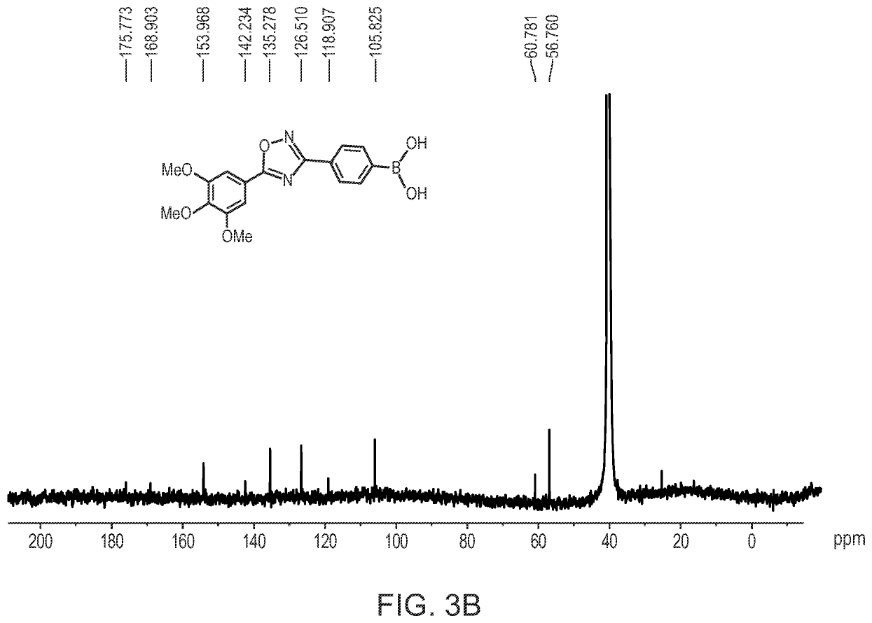

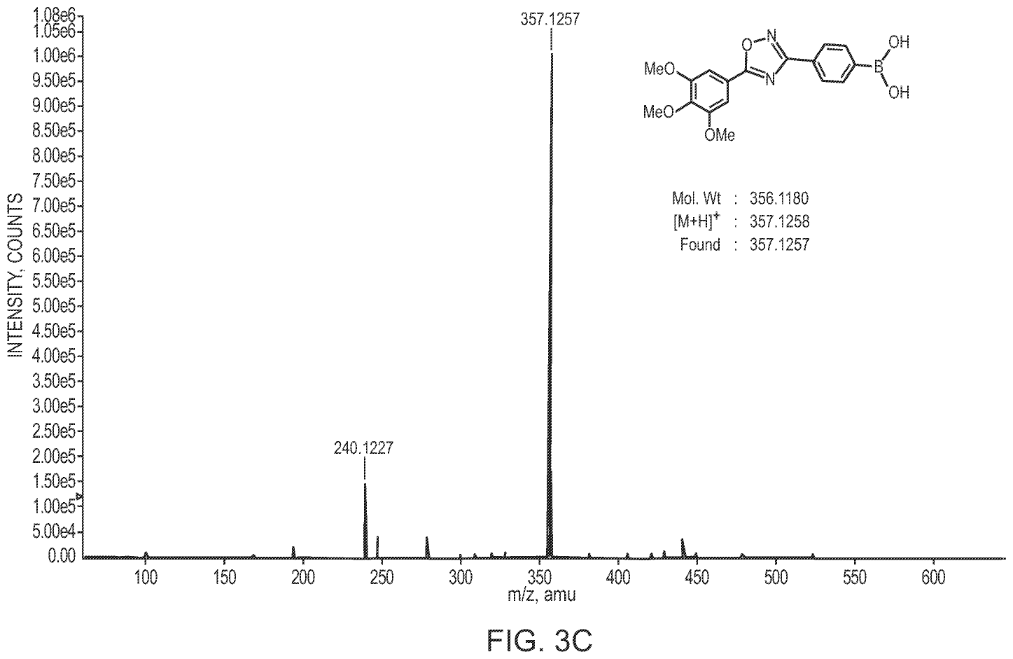

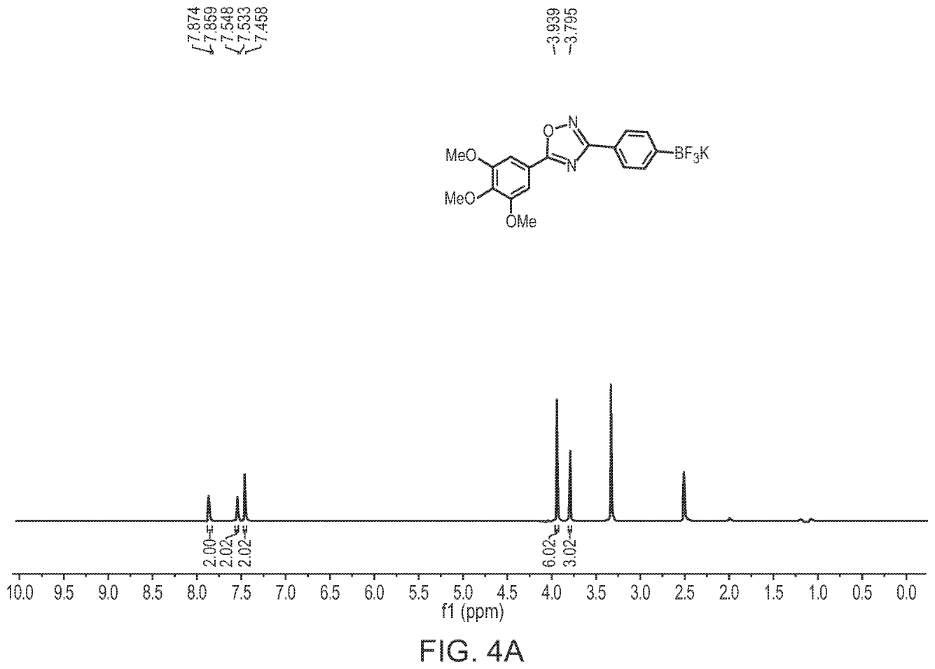

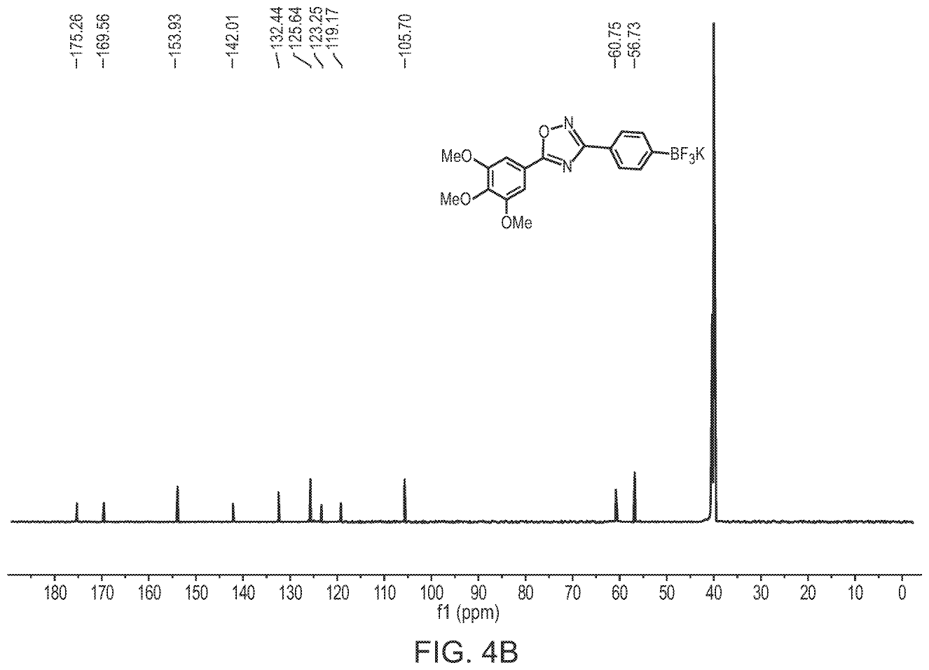

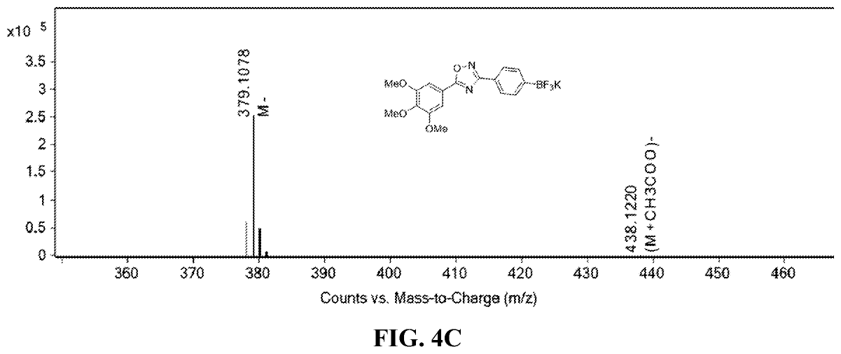

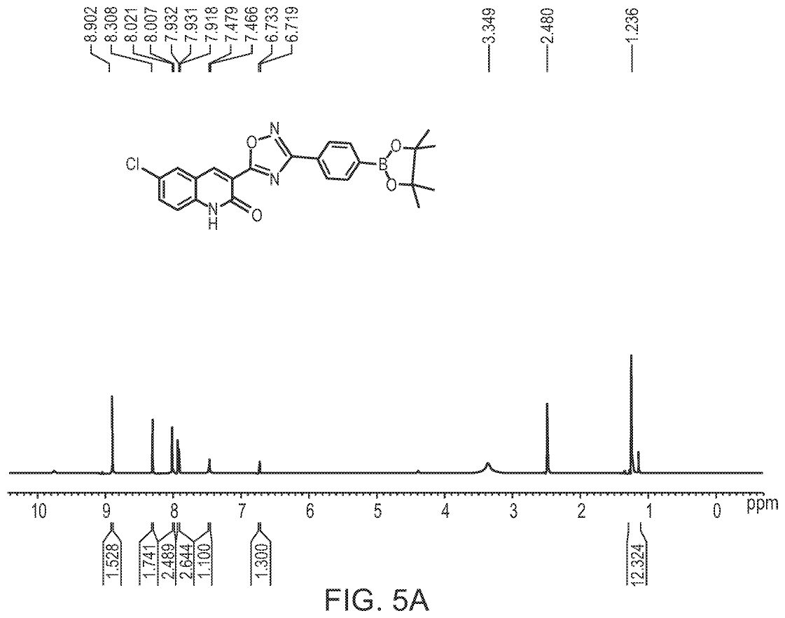

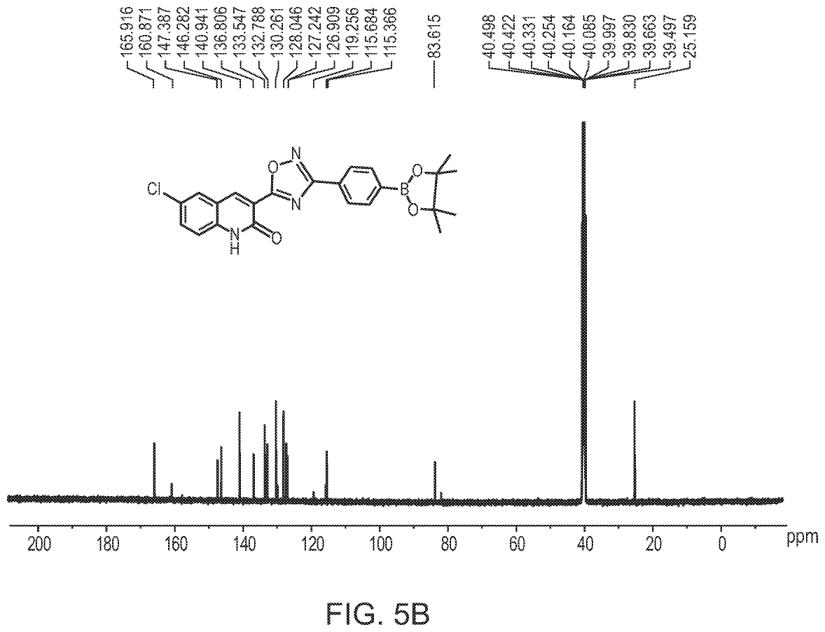

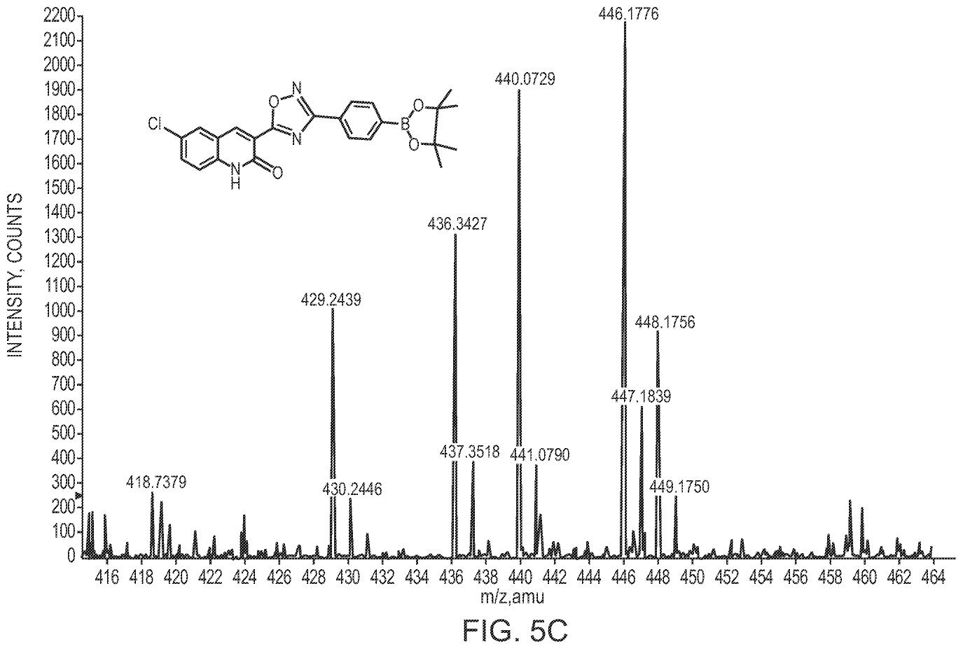

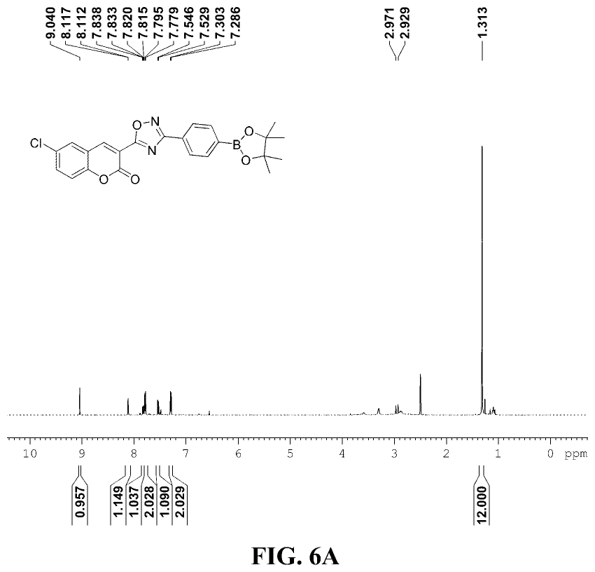

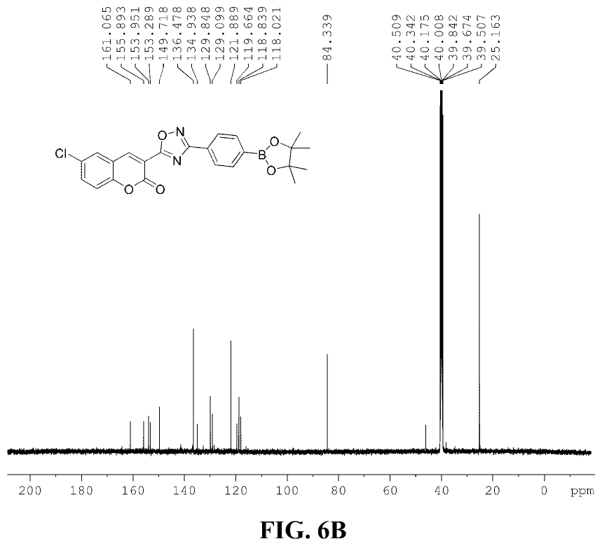

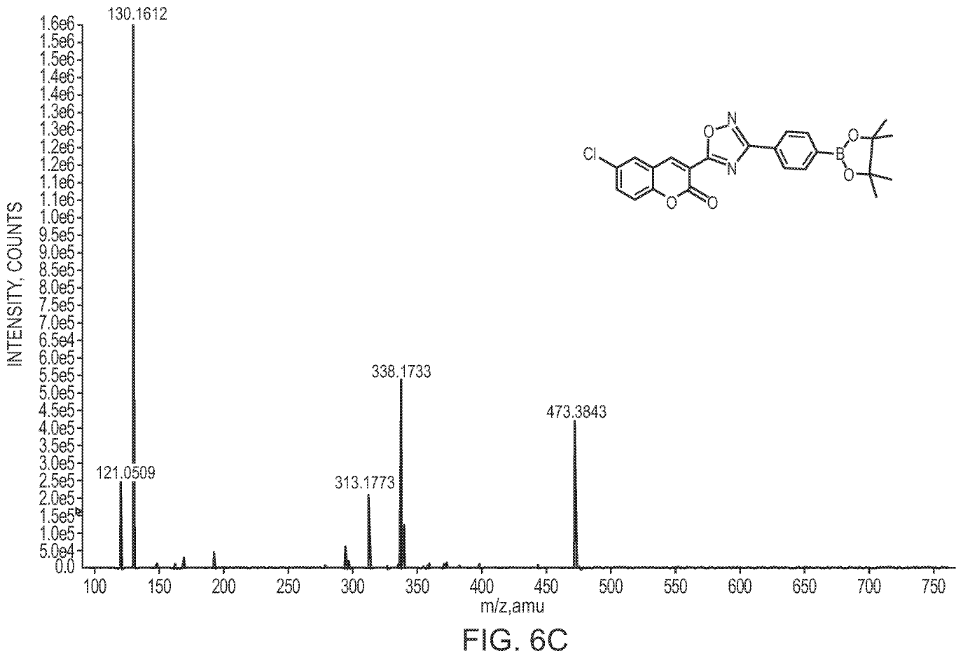

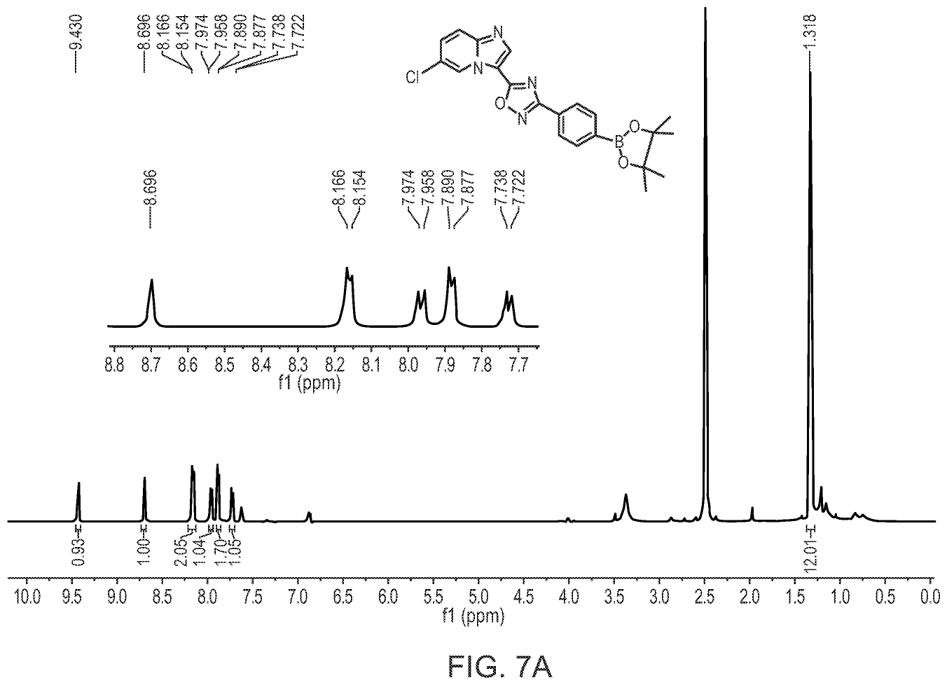

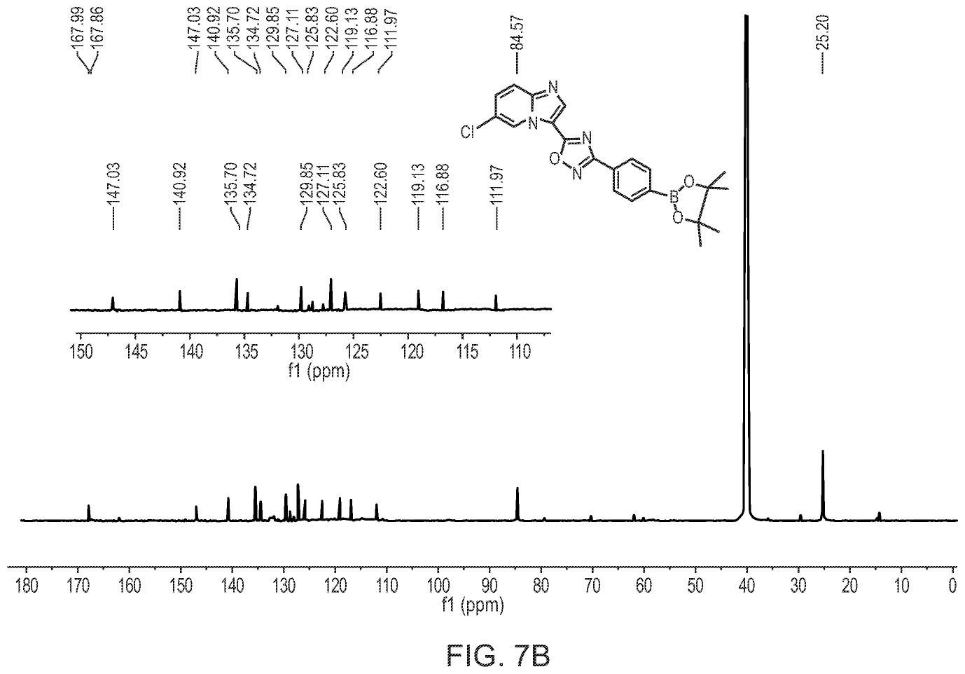

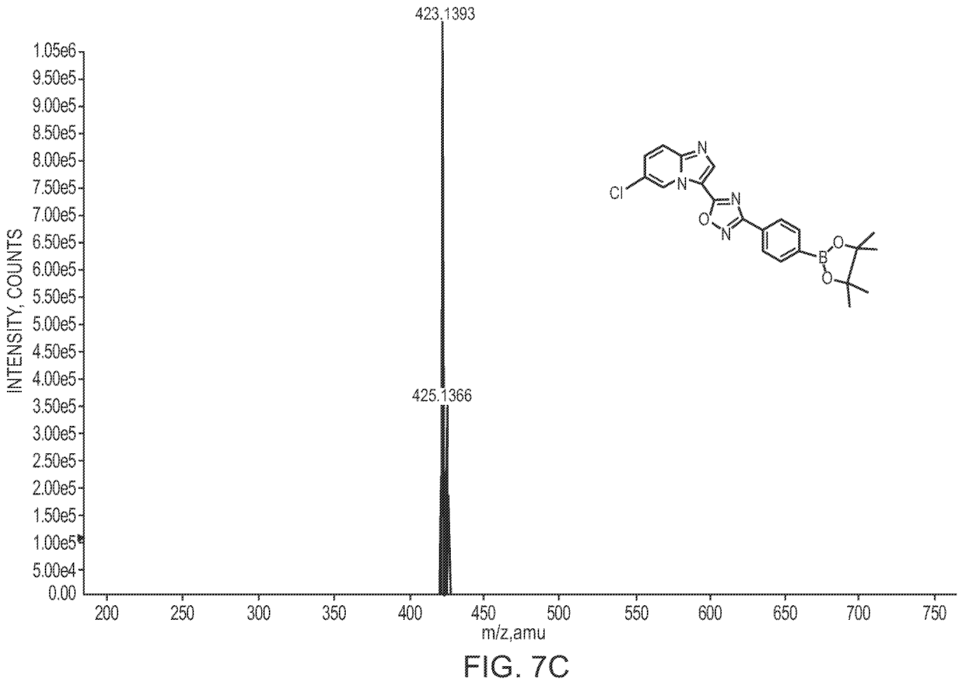

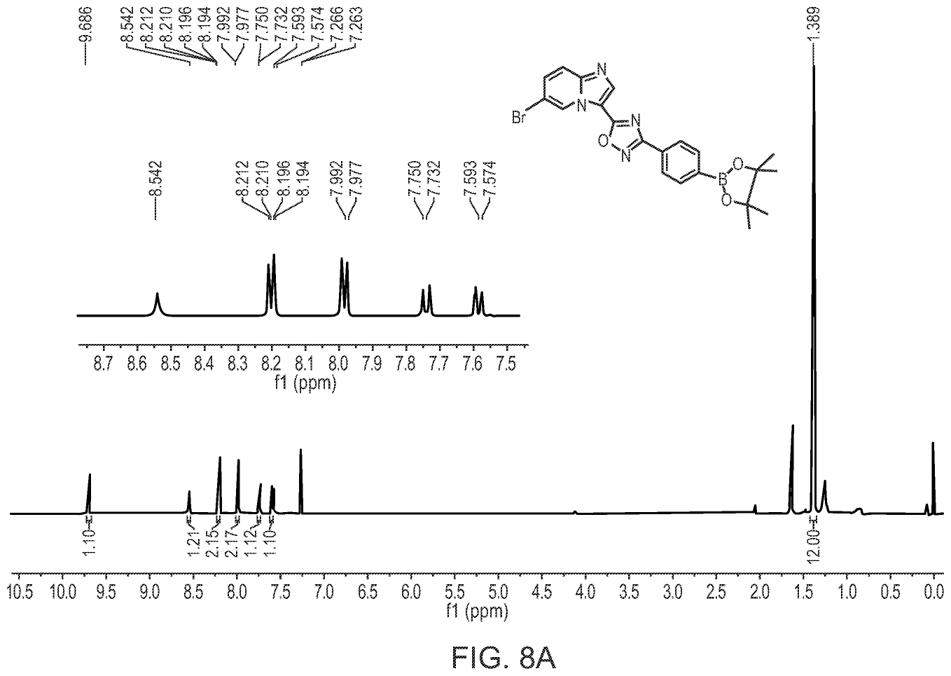

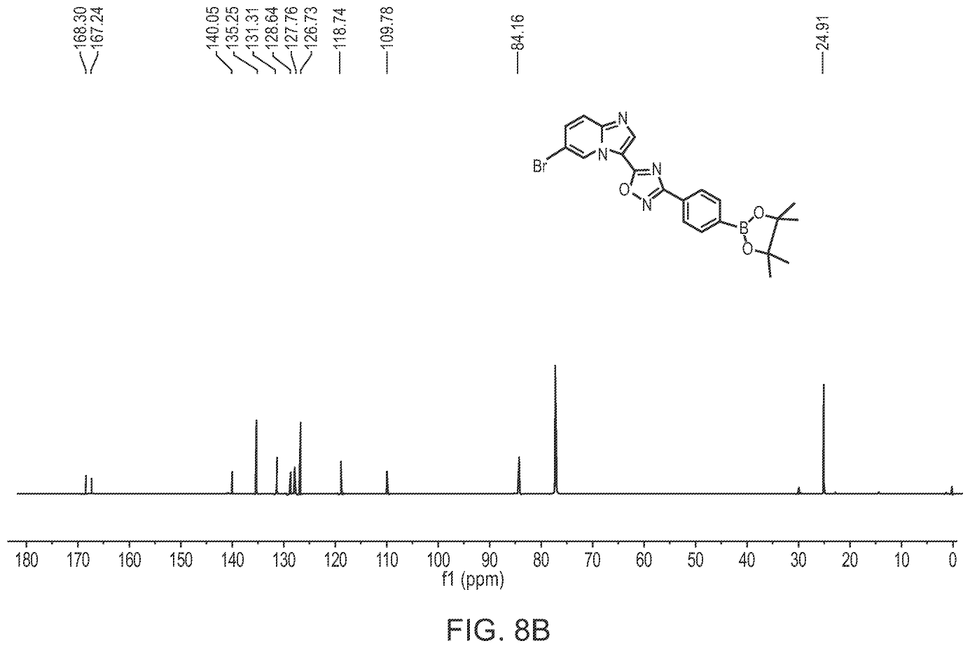

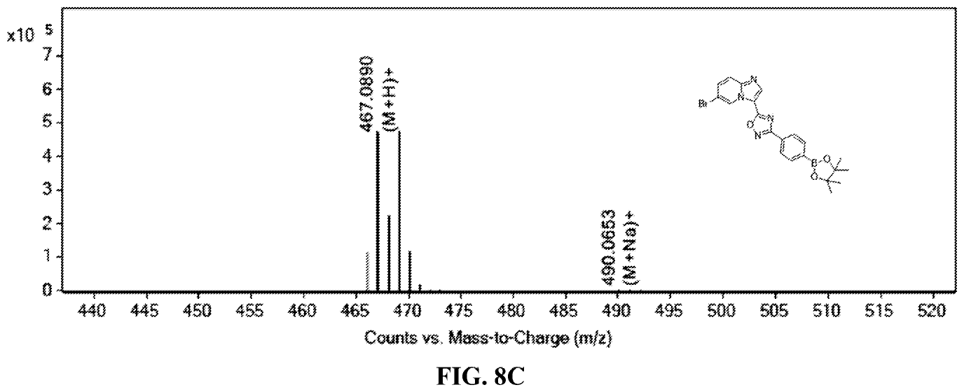

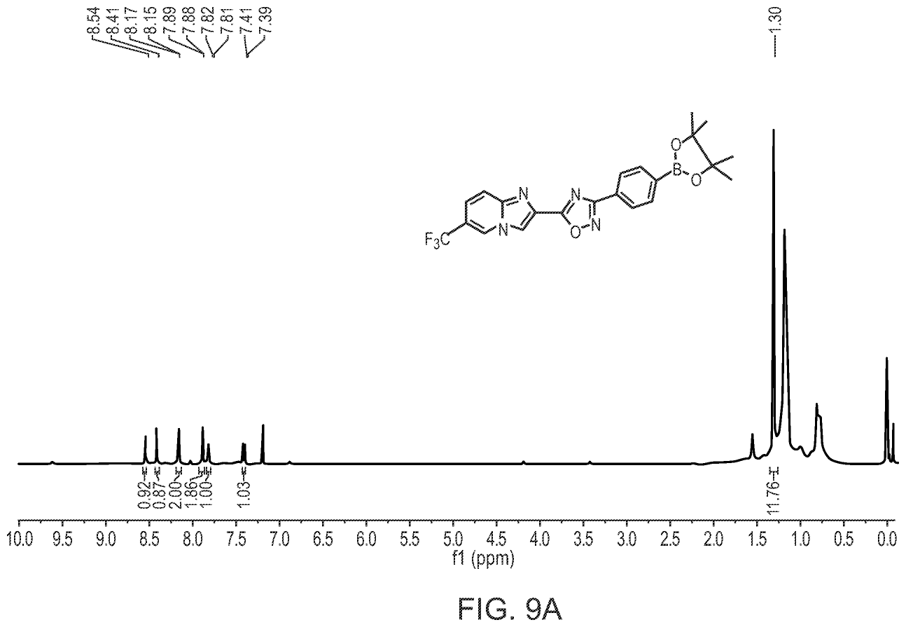

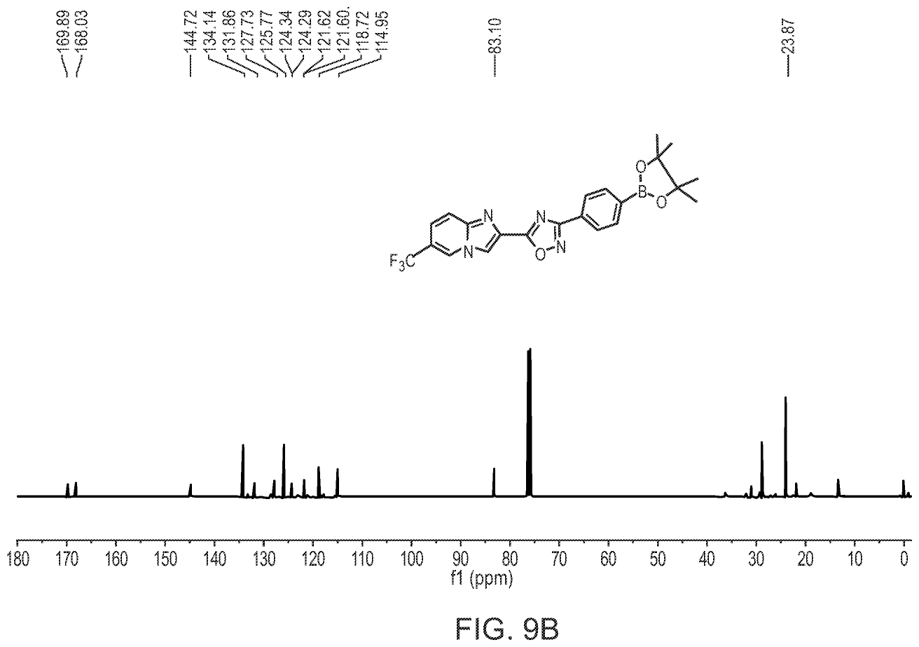

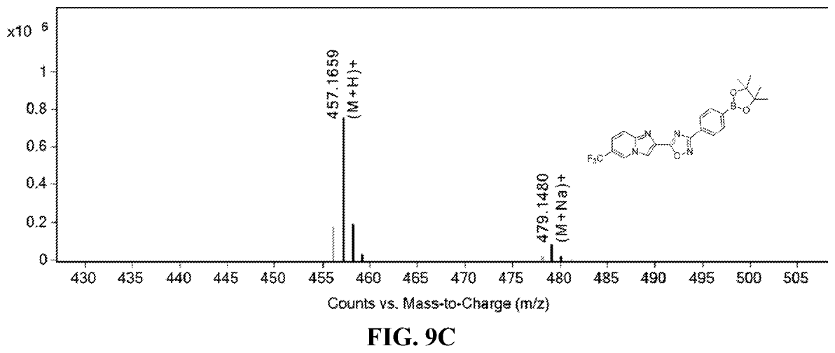

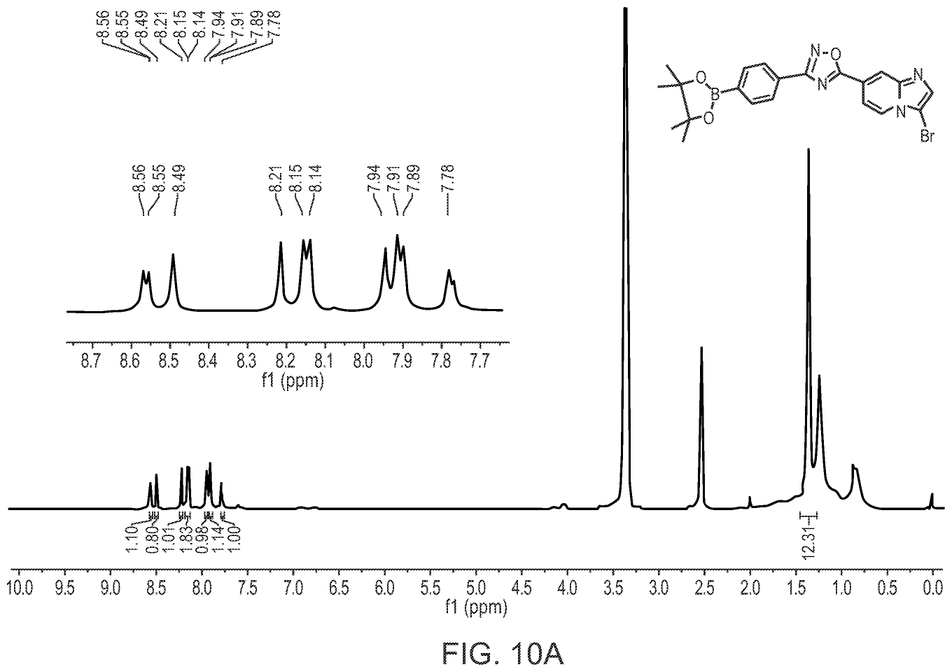

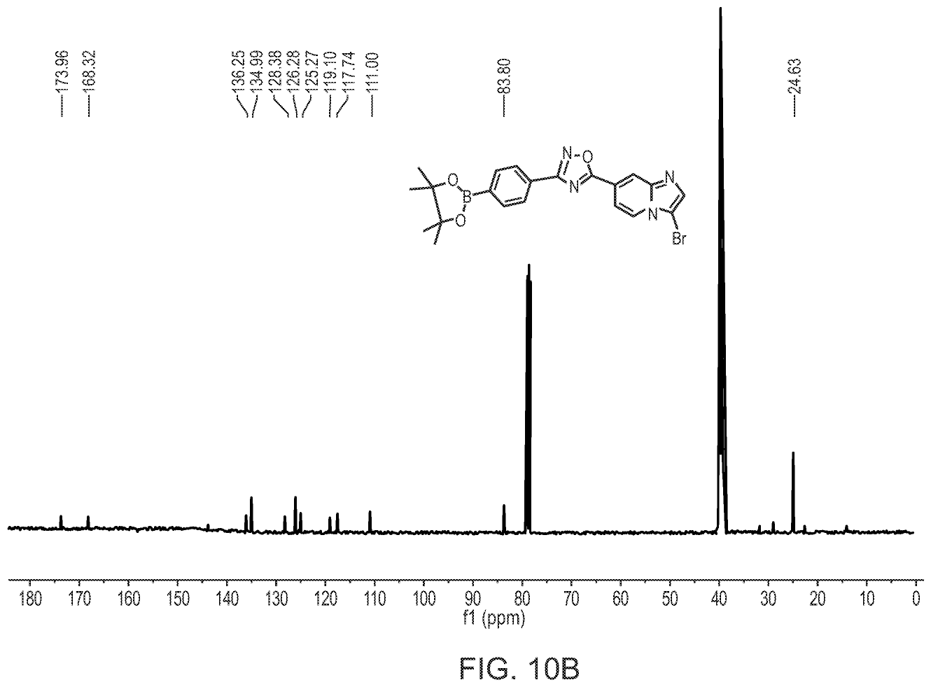

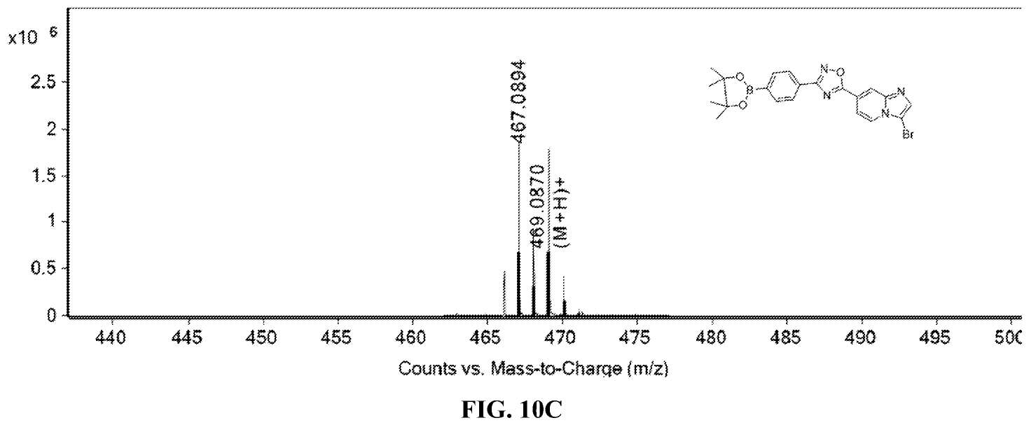

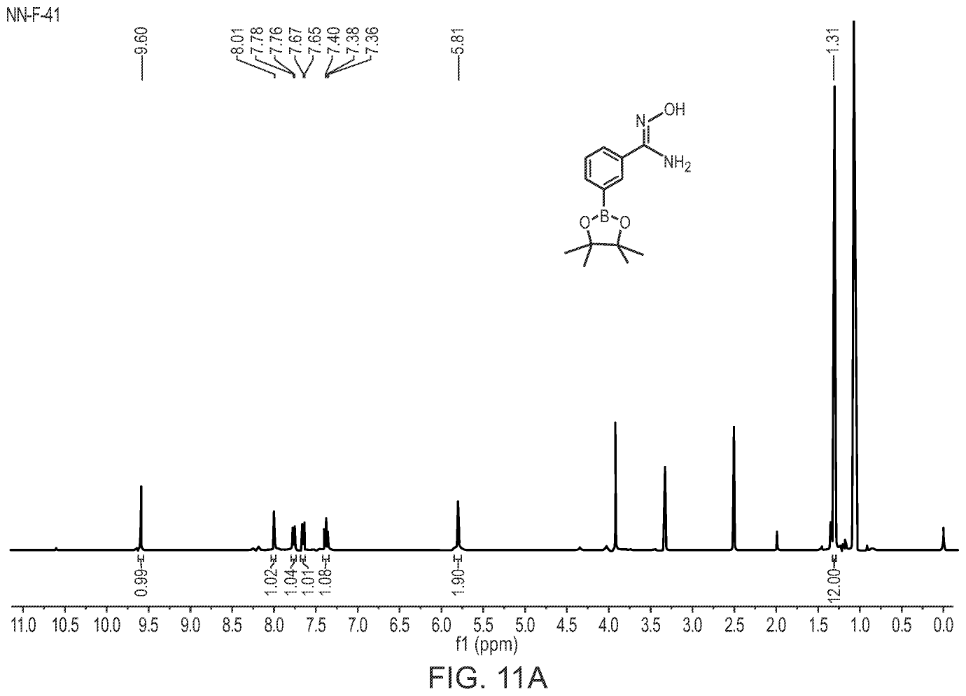

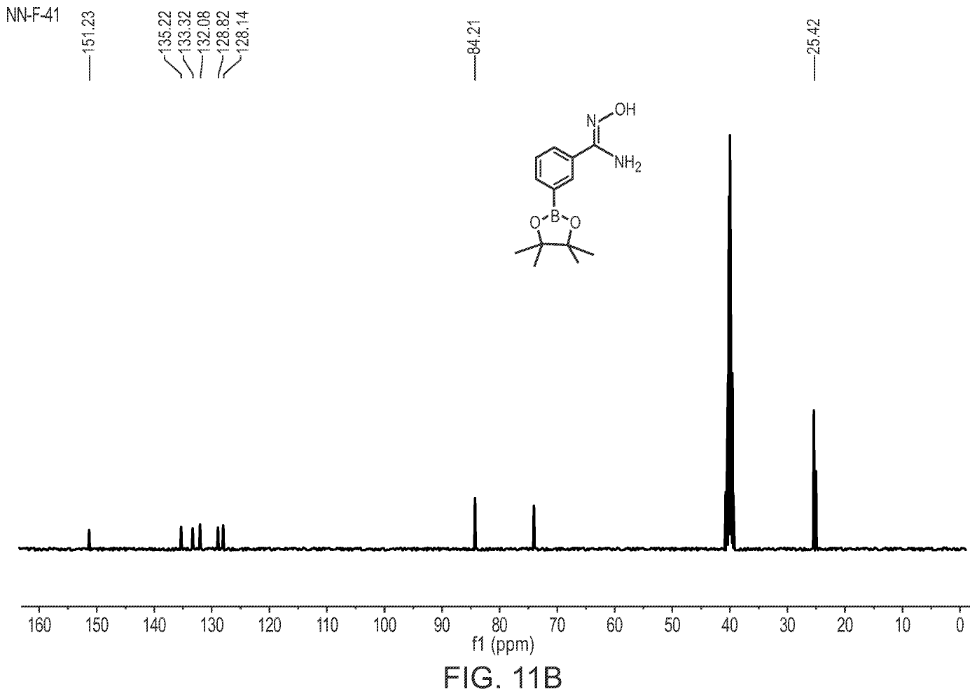

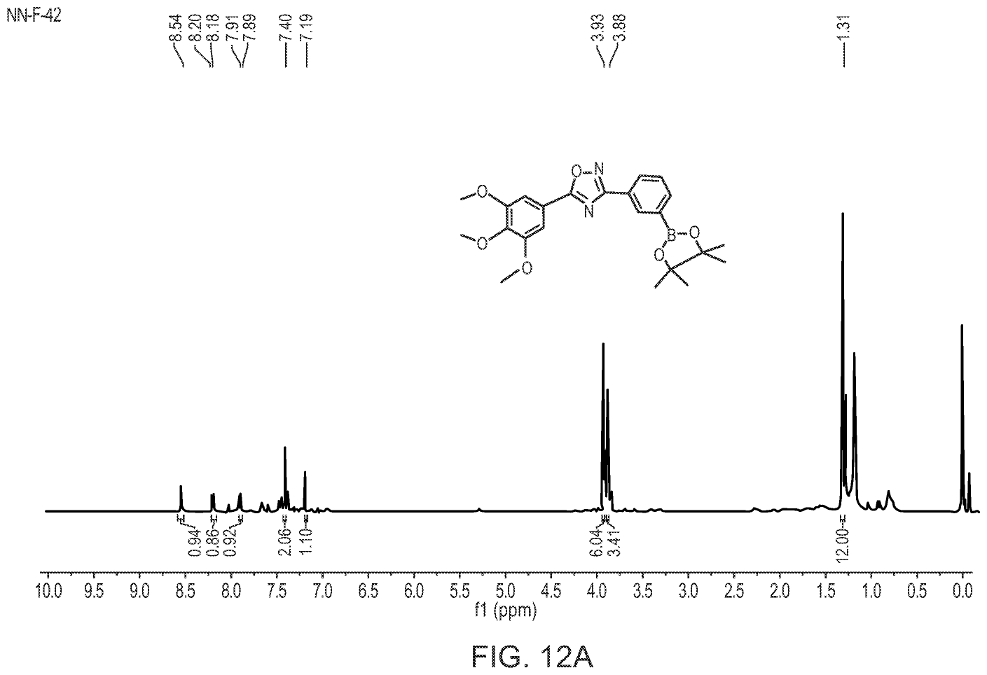

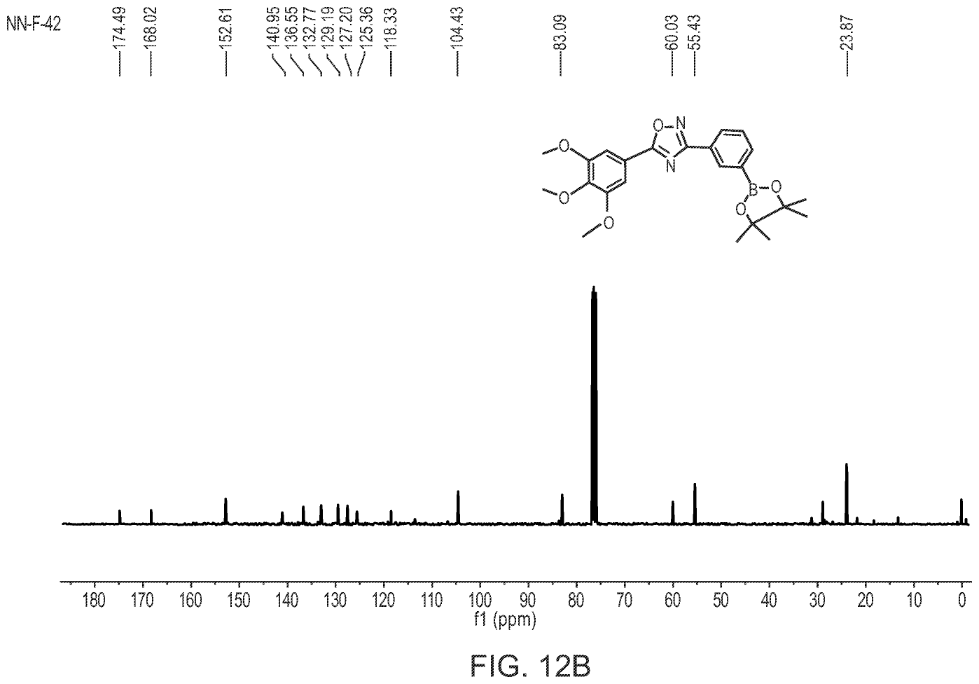

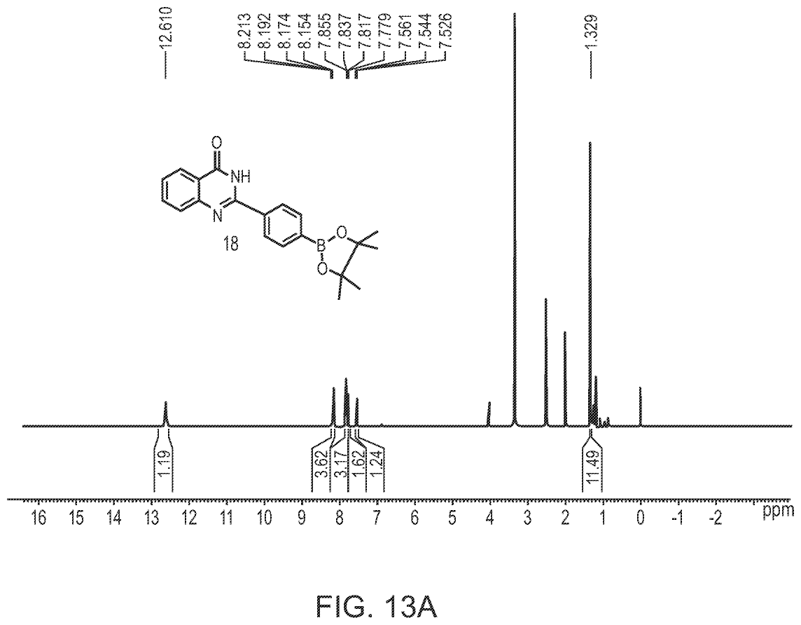

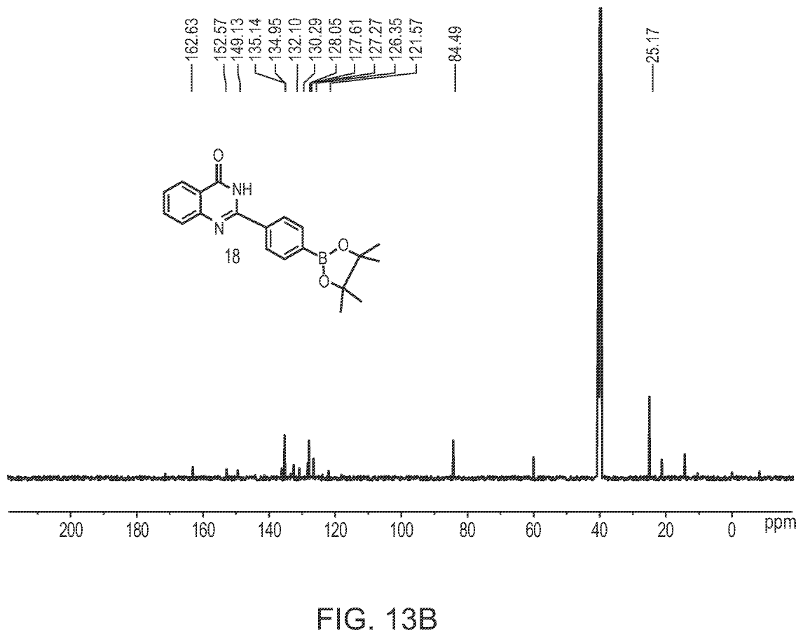

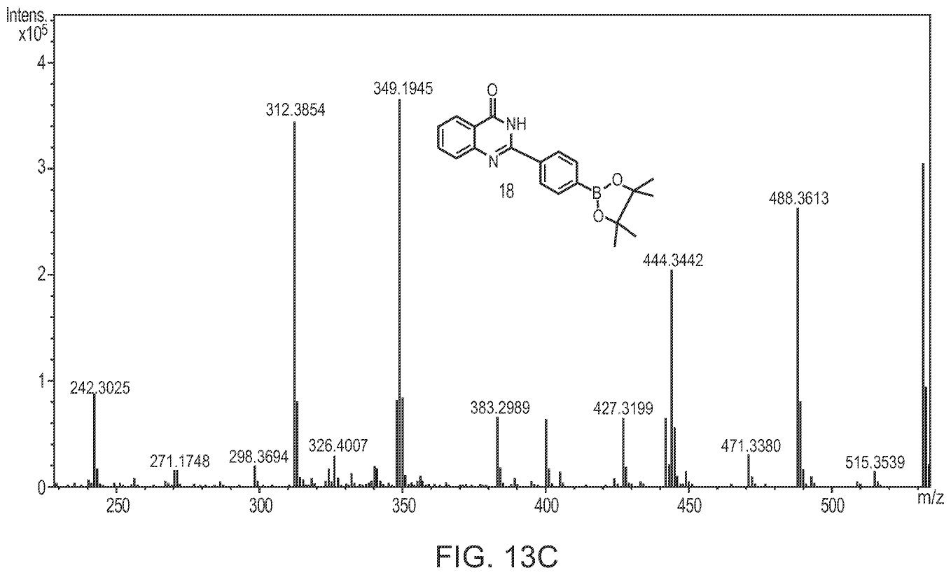

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, exemplary methods and materials are described below.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. DEFINITIONS

As used in the specification and the appended claims, the singular forms “a,” “an” and “the” include plural referents unless the context clearly dictates otherwise. Thus, for example, reference to “a functional group,” “an alkyl,” or “a residue” includes mixtures of two or more such functional groups, alkyls, or residues, and the like.

As used in the specification and in the claims, the term “comprising” can include the aspects “consisting of” and “consisting essentially of.”

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X, and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance can or cannot occur, and that the description includes instances where said event or circumstance occurs and instances where it does not.

As used herein, the term “treatment” refers to the medical management of a patient with the intent to cure, ameliorate, stabilize, or prevent a disease, pathological condition, or disorder. This term includes active treatment, that is, treatment directed specifically toward the improvement of a disease, pathological condition, or disorder, and also includes causal treatment, that is, treatment directed toward removal of the cause of the associated disease, pathological condition, or disorder. In addition, this term includes palliative treatment, that is, treatment designed for the relief of symptoms rather than the curing of the disease, pathological condition, or disorder; preventative treatment, that is, treatment directed to minimizing or partially or completely inhibiting the development of the associated disease, pathological condition, or disorder; and supportive treatment, that is, treatment employed to supplement another specific therapy directed toward the improvement of the associated disease, pathological condition, or disorder. In various aspects, the term covers any treatment of a subject, including a mammal (e.g., a human), and includes: (i) preventing the disease from occurring in a subject that can be predisposed to the disease but has not yet been diagnosed as having it; (ii) inhibiting the disease, i.e., arresting its development; or (iii) relieving the disease, i.e., causing regression of the disease. In one aspect, the subject is a mammal such as a primate, and, in a further aspect, the subject is a human. The term “subject” also includes domesticated animals (e.g., cats, dogs, etc.), livestock (e.g., cattle, horses, pigs, sheep, goats, etc.), and laboratory animals (e.g., mouse, rabbit, rat, guinea pig, fruit fly, etc.).

As used herein, the term “prevent” or “preventing” refers to precluding, averting, obviating, forestalling, stopping, or hindering something from happening, especially by advance action. It is understood that where reduce, inhibit or prevent are used herein, unless specifically indicated otherwise, the use of the other two words is also expressly disclosed.

As used herein, the terms “effective amount” and “amount effective” refer to an amount that is sufficient to achieve the desired result or to have an effect on an undesired condition. For example, a “therapeutically effective amount” refers to an amount that is sufficient to achieve the desired therapeutic result or to have an effect on undesired symptoms, but is generally insufficient to cause adverse side effects. The specific therapeutically effective dose level for any particular patient will depend upon a variety of factors including the disorder being treated and the severity of the disorder; the specific composition employed; the age, body weight, general health, sex and diet of the patient; the time of administration; the route of administration; the rate of excretion of the specific compound employed; the duration of the treatment; drugs used in combination or coincidental with the specific compound employed and like factors well known in the medical arts. For example, it is well within the skill of the art to start doses of a compound at levels lower than those required to achieve the desired therapeutic effect and to gradually increase the dosage until the desired effect is achieved. If desired, the effective daily dose can be divided into multiple doses for purposes of administration. Consequently, single dose compositions can contain such amounts or submultiples thereof to make up the daily dose. The dosage can be adjusted by the individual physician in the event of any contraindications. Dosage can vary, and can be administered in one or more dose administrations daily, for one or several days. Guidance can be found in the literature for appropriate dosages for given classes of pharmaceutical products. In further various aspects, a preparation can be administered in a “prophylactically effective amount”; that is, an amount effective for prevention of a disease or condition.

As used herein, “dosage form” means a pharmacologically active material in a medium, carrier, vehicle, or device suitable for administration to a subject. A dosage form can comprise a disclosed compound, a product of a disclosed method of making, or a salt, solvate, or polymorph thereof, in combination with a pharmaceutically acceptable excipient, such as a preservative, buffer, saline, or phosphate buffered saline. Dosage forms can be made using conventional pharmaceutical manufacturing and compounding techniques. Dosage forms can comprise inorganic or organic buffers (e.g., sodium or potassium salts of phosphate, carbonate, acetate, or citrate) and pH adjustment agents (e.g., hydrochloric acid, sodium or potassium hydroxide, salts of citrate or acetate, amino acids and their salts) antioxidants (e.g., ascorbic acid, alpha-tocopherol), surfactants (e.g., polysorbate 20, polysorbate 80, polyoxyethylene9-10 nonyl phenol, sodium desoxycholate), solution and/or cryo/lyo stabilizers (e.g., sucrose, lactose, mannitol, trehalose), osmotic adjustment agents (e.g., salts or sugars), antibacterial agents (e.g., benzoic acid, phenol, gentamicin), antifoaming agents (e.g., polydimethylsilozone), preservatives (e.g., thimerosal, 2-phenoxyethanol, EDTA), polymeric stabilizers and viscosity-adjustment agents (e.g., polyvinylpyrrolidone, poloxamer 488, carboxymethylcellulose) and co-solvents (e.g., glycerol, polyethylene glycol, ethanol). A dosage form formulated for injectable use can have a disclosed compound, a product of a disclosed method of making, or a salt, solvate, or polymorph thereof, suspended in sterile saline solution for injection together with a preservative.

As used herein, the terms “therapeutic agent” include any synthetic or naturally occurring biologically active compound or composition of matter which, when administered to an organism (human or nonhuman animal), induces a desired pharmacologic, immunogenic, and/or physiologic effect by local and/or systemic action. The term therefore encompasses those compounds or chemicals traditionally regarded as drugs, vaccines, and biopharmaceuticals including molecules such as proteins, peptides, hormones, nucleic acids, gene constructs and the like. Examples of therapeutic agents are described in well-known literature references such as the Merck Index (14^{th} edition), the Physicians' Desk Reference (64^{th} edition), and The Pharmacological Basis of Therapeutics (12^{th} edition), and they include, without limitation, medicaments; vitamins; mineral supplements; substances used for the treatment, prevention, diagnosis, cure or mitigation of a disease or illness; substances that affect the structure or function of the body, or pro-drugs, which become biologically active or more active after they have been placed in a physiological environment. For example, the term “therapeutic agent” includes compounds or compositions for use in all of the major therapeutic areas including, but not limited to, adjuvants; anti-infectives such as antibiotics and antiviral agents; anti-cancer and anti-neoplastic agents such as kinase inhibitors, poly ADP ribose polymerase (PARP) inhibitors and other DNA damage response modifiers, epigenetic agents such as bromodomain and extra-terminal (BET) inhibitors, histone deacetylase (HDAc) inhibitors, iron chelators, and other ribonucleotides reductase inhibitors, proteasome inhibitors and Nedd8-activating enzyme (NAE) inhibitors, mammalian target of rapamycin (mTOR) inhibitors, traditional cytotoxic agents such as paclitaxel, dox, irinotecan, and platinum compounds, immune checkpoint blockade agents such as cytotoxic T lymphocyte antigen-4 (CTLA-4) monoclonal antibody (mAB), programmed cell death protein 1 (PD-1)/programmed cell death-ligand 1 (PD-L1) mAB, cluster of differentiation 47 (CD47) mAB, toll-like receptor (TLR) agonists and other immune modifiers, cell therapeutics such as chimeric antigen receptor T-cell (CAR-T)/chimeric antigen receptor natural killer (CAR-NK) cells, and proteins such as interferons (IFNs), interleukins (ILs), and mAbs; anti-ALS agents such as entry inhibitors, fusion inhibitors, non-nucleoside reverse transcriptase inhibitors (NNRTIs), nucleoside reverse transcriptase inhibitors (NRTIs), nucleotide reverse transcriptase inhibitors, NCP7 inhibitors, protease inhibitors, and integrase inhibitors; analgesics and analgesic combinations, anorexics, anti-inflammatory agents, anti-epileptics, local and general anesthetics, hypnotics, sedatives, antipsychotic agents, neuroleptic agents, antidepressants, anxiolytics, antagonists, neuron blocking agents, anticholinergic and cholinomimetic agents, antimuscarinic and muscarinic agents, antiadrenergics, antiarrhythmics, antihypertensive agents, hormones, and nutrients, antiarthritics, antiasthmatic agents, anticonvulsants, antihistamines, antinauseants, antineoplastics, antipruritics, antipyretics; antispasmodics, cardiovascular preparations (including calcium channel blockers, beta-blockers, beta-agonists and antiarrythmics), antihypertensives, diuretics, vasodilators; central nervous system stimulants; cough and cold preparations; decongestants; diagnostics; hormones; bone growth stimulants and bone resorption inhibitors; immunosuppressives; muscle relaxants; psychostimulants; sedatives; tranquilizers; proteins, peptides, and fragments thereof (whether naturally occurring, chemically synthesized or recombinantly produced); and nucleic acid molecules (polymeric forms of two or more nucleotides, either ribonucleotides (RNA) or deoxyribonucleotides (DNA) including both double- and single-stranded molecules, gene constructs, expression vectors, antisense molecules and the like), small molecules (e.g., doxorubicin) and other biologically active macromolecules such as, for example, proteins and enzymes. The agent may be a biologically active agent used in medical, including veterinary, applications and in agriculture, such as with plants, as well as other areas. The term “therapeutic agent” also includes without limitation, medicaments; vitamins; mineral supplements; substances used for the treatment, prevention, diagnosis, cure or mitigation of disease or illness; or substances which affect the structure or function of the body; or pro-drugs, which become biologically active or more active after they have been placed in a predetermined physiological environment.

The term “pharmaceutically acceptable” describes a material that is not biologically or otherwise undesirable, i.e., without causing an unacceptable level of undesirable biological effects or interacting in a deleterious manner.

As used herein, the term “derivative” refers to a compound having a structure derived from the structure of a parent compound (e.g., a compound disclosed herein) and whose structure is sufficiently similar to those disclosed herein and based upon that similarity, would be expected by one skilled in the art to exhibit the same or similar activities and utilities as the claimed compounds, or to induce, as a precursor, the same or similar activities and utilities as the claimed compounds. Exemplary derivatives include salts, esters, amides, salts of esters or amides, and N-oxides of a parent compound.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

In defining various terms, “A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” or “aliphatic group,” as used herein, denotes a hydrocarbon moiety that may be straight chain (i.e., unbranched), branched, or cyclic (including fused, bridging, and spirofused polycyclic) and may be completely saturated or may contain one or more units of unsaturation, but which is not aromatic. Unless otherwise specified, aliphatic groups contain 1-20 carbon atoms. Aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C24 alkyl.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbomyl, and the like. The term “heterocycloalkyl” is a non-aromatic carbon-based ring type of cycloalkyl group as defined above, and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, cycloalkyl, alkoxy, amino, ether, halide, hydroxy, nitro, silyl, sulfo-oxo, or thiol as described herein.

The term “polyalkylene group” as used herein is a group having two or more CH₂ groups linked to one another. The polyalkylene group can be represented by the formula —(CH₂)ₐ—, where “a” is an integer of from 2 to 500.

The terms “alkoxy” and “alkoxyl” as used herein to refer to an alkyl or cycloalkyl group bonded through an ether linkage; that is, an “alkoxy” group can be defined as —OA¹ where A¹ is alkyl or cycloalkyl as defined above. “Alkoxy” also includes polymers of alkoxy groups as just described; that is, an alkoxy can be a polyether such as —OA¹-OA² or —OA¹-(OA²)ₐ-OA³, where “a” is an integer of from 1 to 200 and A¹, A², and A³ are alkyl and/or cycloalkyl groups.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The term “heterocycloalkenyl” is a type of cycloalkenyl group as defined above, and is included within the meaning of the term “cycloalkenyl,” where at least one of the carbon atoms of the ring is replaced with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “alkynyl” as used herein is a hydrocarbon group of 2 to 24 carbon atoms with a structural formula containing at least one carbon-carbon triple bond. The alkynyl group can be unsubstituted or substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkynyl” as used herein is a non-aromatic carbon-based ring composed of at least seven carbon atoms and containing at least one carbon-carbon triple bound. Examples of cycloalkynyl groups include, but are not limited to, cycloheptynyl, cyclooctynyl, cyclononynyl, and the like. The term “heterocycloalkynyl” is a type of cycloalkenyl group as defined above, and is included within the meaning of the term “cycloalkynyl,” where at least one of the carbon atoms of the ring is replaced with a heteroatom such as, but not limited to, nitrogen, oxygen, sulfur, or phosphorus. The cycloalkynyl group and heterocycloalkynyl group can be substituted or unsubstituted. The cycloalkynyl group and heterocycloalkynyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aromatic group” as used herein refers to a ring structure having cyclic clouds of delocalized π electrons above and below the plane of the molecule, where the π clouds contain (4n+2) π electrons. A further discussion of aromaticity is found in Morrison and Boyd, Organic Chemistry, (5th Ed., 1987), Chapter 13, entitled “Aromaticity,” pages 477-497, incorporated herein by reference. The term “aromatic group” is inclusive of both aryl and heteroaryl groups.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl can be two aryl groups that are bound together via a fused ring structure, as in naphthalene, or are attached via one or more carbon-carbon bonds, as in biphenyl.

The term “aldehyde” as used herein is represented by the formula —C(O)H. Throughout this specification “C(O)” is a short hand notation for a carbonyl group, i.e., C═O.

The terms “amine” or “amino” as used herein are represented by the formula —NA¹A², where A¹ and A² can be, independently, hydrogen or alkyl, cycloalkyl, alkenyl, cycloalkenyl, alkynyl, cycloalkynyl, aryl, or heteroaryl group as described herein. A specific example of amino is —NH₂.

The term “alkylamino” as used herein is represented by the formula —NH(-alkyl) where alkyl is a described herein. Representative examples include, but are not limited to, methylamino group, ethylamino group, propylamino group, isopropylamino group, butylamino group, isobutylamino group, (sec-butyl)amino group, (tert-butyl)amino group, pentylamino group, isopentylamino group, (tert-pentyl)amino group, hexylamino group, and the like.

The term “dialkylamino” as used herein is represented by the formula —N(-alkyl)₂ where alkyl is a described herein. Representative examples include, but are not limited to, dimethylamino group, diethylamino group, dipropylamino group, diisopropylamino group, dibutylamino group, diisobutylamino group, di(sec-butyl)amino group, di(tert-butyl)amino group, dipentylamino group, diisopentylamino group, di(tert-pentyl)amino group, dihexylamino group, N-ethyl-N-methylamino group, N-methyl-N-propylamino group, N-ethyl-N-propylamino group and the like.

The term “carboxylic acid” as used herein is represented by the formula —C(O)OH.

The term “ester” as used herein is represented by the formula —OC(O)A¹ or —C(O)OA¹, where A¹ can be alkyl, cycloalkyl, alkenyl, cycloalkenyl, alkynyl, cycloalkynyl, aryl, or heteroaryl group as described herein. The term “polyester” as used herein is represented by the formula -(A¹O(O)C-A²-C(O)O)ₐ— or -(A¹O(O)C-A²-OC(O))ₐ—, where A¹ and A² can be, independently, an alkyl, cycloalkyl, alkenyl, cycloalkenyl, alkynyl, cycloalkynyl, aryl, or heteroaryl group described herein and “a” is an integer from 1 to 500. “Polyester” is as the term used to describe a group that is produced by the reaction between a compound having at least two carboxylic acid groups with a compound having at least two hydroxyl groups.

The term “ether” as used herein is represented by the formula A¹OA², where A¹ and A² can be, independently, an alkyl, cycloalkyl, alkenyl, cycloalkenyl, alkynyl, cycloalkynyl, aryl, or heteroaryl group described herein. The term “polyether” as used herein is represented by the formula -(A¹O-A²O)ₐ—, where A¹ and A² can be, independently, an alkyl, cycloalkyl, alkenyl, cycloalkenyl, alkynyl, cycloalkynyl, aryl, or heteroaryl group described herein and “a” is an integer of from 1 to 500. Examples of polyether groups include polyethylene oxide, polypropylene oxide, and polybutylene oxide.

The terms “halo,” “halogen,” or “halide,” as used herein can be used interchangeably and refer to F, Cl, Br, or I.

The terms “pseudohalide,” “pseudohalogen,” or “pseudohalo,” as used herein can be used interchangeably and refer to functional groups that behave substantially similar to halides. Such functional groups include, by way of example, cyano, thiocyanato, azido, trifluoromethyl, trifluoromethoxy, perfluoroalkyl, and perfluoroalkoxy groups.

The term “heteroalkyl,” as used herein refers to an alkyl group containing at least one heteroatom. Suitable heteroatoms include, but are not limited to, O, N, Si, P and S, wherein the nitrogen, phosphorous and sulfur atoms are optionally oxidized, and the nitrogen heteroatom is optionally quaternized. Heteroalkyls can be substituted as defined above for alkyl groups.

The term “heteroaryl,” as used herein refers to an aromatic group that has at least one heteroatom incorporated within the ring of the aromatic group. Examples of heteroatoms include, but are not limited to, nitrogen, oxygen, sulfur, and phosphorus, where N-oxides, sulfur oxides, and dioxides are permissible heteroatom substitutions. The heteroaryl group can be substituted or unsubstituted. The heteroaryl group can be substituted with one or more groups including, but not limited to, alkyl, cycloalkyl, alkoxy, amino, ether, halide, hydroxy, nitro, silyl, sulfo-oxo, or thiol as described herein. Heteroaryl groups can be monocyclic, or alternatively fused ring systems. Heteroaryl groups include, but are not limited to, furyl, imidazolyl, pyrimidinyl, tetrazolyl, thienyl, pyridinyl, pyrrolyl, N-methylpyrrolyl, quinolinyl, isoquinolinyl, pyrazolyl, triazolyl, thiazolyl, oxazolyl, isoxazolyl, oxadiazolyl, thiadiazolyl, isothiazolyl, pyridazinyl, pyrazinyl, benzofuranyl, benzodioxolyl, benzothiophenyl, indolyl, indazolyl, benzimidazolyl, imidazopyridinyl, pyrazolopyridinyl, and pyrazolopyrimidinyl. Further not limiting examples of heteroaryl groups include, but are not limited to, pyridinyl, pyridazinyl, pyrimidinyl, pyrazinyl, thiophenyl, pyrazolyl, imidazolyl, benzo[d]oxazolyl, benzo[d]thiazolyl, quinolinyl, quinazolinyl, indazolyl, imidazo[1,2-b]pyridazinyl, imidazo[1,2-a]pyrazinyl, benzo[c][1,2,5]thiadiazolyl, benzo[c][1,2,5]oxadiazolyl, and pyrido[2,3-b]pyrazinyl.

The terms “heterocycle” or “heterocyclyl,” as used herein can be used interchangeably and refer to single and multi-cyclic aromatic or non-aromatic ring systems in which at least one of the ring members is other than carbon. Thus, the term is inclusive of, but not limited to, “heterocycloalkyl,” “heteroaryl,” “bicyclic heterocycle,” and “polycyclic heterocycle.” Heterocycle includes pyridine, pyrimidine, furan, thiophene, pyrrole, isoxazole, isothiazole, pyrazole, oxazole, thiazole, imidazole, oxazole, including, 1,2,3-oxadiazole, 1,2,5-oxadiazole and 1,3,4-oxadiazole, thiadiazole, including, 1,2,3-thiadiazole, 1,2,5-thiadiazole, and 1,3,4-thiadiazole, triazole, including, 1,2,3-triazole, 1,3,4-triazole, tetrazole, including 1,2,3,4-tetrazole and 1,2,4,5-tetrazole, pyridazine, pyrazine, triazine, including 1,2,4-triazine and 1,3,5-triazine, tetrazine, including 1,2,4,5-tetrazine, pyrrolidine, piperidine, piperazine, morpholine, azetidine, tetrahydropyran, tetrahydrofuran, dioxane, and the like. The term heterocyclyl group can also be a C2 heterocyclyl, C2-C3 heterocyclyl, C2-C4 heterocyclyl, C2-C5 heterocyclyl, C2-C6 heterocyclyl, C2-C7 heterocyclyl, C2-C8 heterocyclyl, C2-C9 heterocyclyl, C2-C10 heterocyclyl, C2-C11 heterocyclyl, and the like up to and including a C2-C18 heterocyclyl. For example, a C2 heterocyclyl comprises a group which has two carbon atoms and at least one heteroatom, including, but not limited to, aziridinyl, diazetidinyl, dihydrodiazetyl, oxiranyl, thiiranyl, and the like. Alternatively, for example, a C5 heterocyclyl comprises a group that has five carbon atoms and at least one heteroatom, including, but not limited to, piperidinyl, tetrahydropyranyl, tetrahydrothiopyranyl, diazepanyl, pyridinyl, and the like. It is understood that a heterocyclyl group may be bound either through a heteroatom in the ring, where chemically possible, or one of carbons comprising the heterocyclyl ring.

The term “bicyclic heterocycle” or “bicyclic heterocyclyl,” as used herein refers to a ring system in which at least one of the ring members is other than carbon. Bicyclic heterocyclyl encompasses ring systems wherein an aromatic ring is fused with another aromatic ring, or wherein an aromatic ring is fused with a non-aromatic ring. Bicyclic heterocyclyl encompasses ring systems wherein a benzene ring is fused to a 5- or a 6-membered ring containing 1, 2 or 3 ring heteroatoms or wherein a pyridine ring is fused to a 5- or a 6-membered ring containing 1, 2 or 3 ring heteroatoms. Bicyclic heterocyclic groups include, but are not limited to, indolyl, indazolyl, pyrazolo[1,5-a]pyridinyl, benzofuranyl, quinolinyl, quinoxalinyl, 1,3-benzodioxolyl, 2,3-dihydro-1,4-benzodioxinyl, 3,4-dihydro-2H-chromenyl, 1H-pyrazolo[4,3-c]pyridin-3-yl; 1H-pyrrolo[3,2-b]pyridin-3-yl; and 1H-pyrazolo[3,2-b]pyridin-3-yl.

The term “heterocycloalkyl” as used herein refers to an aliphatic, partially unsaturated or fully saturated, 3- to 14-membered ring system, including single rings of 3 to 8 atoms and bi- and tricyclic ring systems. The heterocycloalkyl ring-systems include one to four heteroatoms independently selected from oxygen, nitrogen, and sulfur, wherein a nitrogen and sulfur heteroatom optionally can be oxidized and a nitrogen heteroatom optionally can be substituted. Representative heterocycloalkyl groups include, but are not limited to, pyrrolidinyl, pyrazolinyl, pyrazolidinyl, imidazolinyl, imidazolidinyl, piperidinyl, piperazinyl, oxazolidinyl, isoxazolidinyl, morpholinyl, thiazolidinyl, isothiazolidinyl, and tetrahydrofuryl.

The term “hydroxyl” or “hydroxyl” as used herein is represented by the formula —OH.

The term “ketone” as used herein is represented by the formula A¹C(O)A², where A¹ and A² can be, independently, an alkyl, cycloalkyl, alkenyl, cycloalkenyl, alkynyl, cycloalkynyl, aryl, or heteroaryl group as described herein.

The term “azide” or “azido” as used herein is represented by the formula —N₃.

The term “nitro” as used herein is represented by the formula —NO₂.

The term “nitrile” or “cyano” as used herein is represented by the formula —CN.

The term “silyl” as used herein is represented by the formula —SiA¹A²A³, where A¹, A², and A³ can be, independently, hydrogen or an alkyl, cycloalkyl, alkoxy, alkenyl, cycloalkenyl, alkynyl, cycloalkynyl, aryl, or heteroaryl group as described herein.

The term “sulfo-oxo” as used herein is represented by the formulas —S(O)A¹, —S(O)₂A¹, —OS(O)₂A¹, or —OS(O)₂OA¹, where A¹ can be hydrogen or an alkyl, cycloalkyl, alkenyl, cycloalkenyl, alkynyl, cycloalkynyl, aryl, or heteroaryl group as described herein. Throughout this specification “S(O)” is a short hand notation for S═O. The term “sulfonyl” is used herein to refer to the sulfo-oxo group represented by the formula —S(O)₂A¹, where A¹ can be hydrogen or an alkyl, cycloalkyl, alkenyl, cycloalkenyl, alkynyl, cycloalkynyl, aryl, or heteroaryl group as described herein. The term “sulfone” as used herein is represented by the formula A¹S(O)₂A², where A¹ and A² can be, independently, an alkyl, cycloalkyl, alkenyl, cycloalkenyl, alkynyl, cycloalkynyl, aryl, or heteroaryl group as described herein. The term “sulfoxide” as used herein is represented by the formula A¹S(O)A², where A¹ and A² can be, independently, an alkyl, cycloalkyl, alkenyl, cycloalkenyl, alkynyl, cycloalkynyl, aryl, or heteroaryl group as described herein.

The term “thiol” as used herein is represented by the formula —SH.

“R¹,” “R²,” “R³,” “Rⁿ,” where n is an integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

As described herein, compounds of the invention may contain “optionally substituted” moieties. In general, the term “substituted,” whether preceded by the term “optionally” or not, means that one or more hydrogen of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. It is also contemplated that, in certain aspects, unless expressly indicated to the contrary, individual substituents can be further optionally substituted (i.e., further substituted or unsubstituted).

The term “stable,” as used herein, refers to compounds that are not substantially altered when subjected to conditions to allow for their production, detection, and, in certain aspects, their recovery, purification, and use for one or more of the purposes disclosed herein.

Suitable monovalent substituents on a substitutable carbon atom of an “optionally substituted” group are independently halogen; —(CH₂)₀₋₄R^{∘}; —(CH₂)₀₋₄OR^{∘}; —O(CH₂)₀₋₄R^{∘}, —O—(CH₂)₀₋₄C(O)OR^{∘}; —(CH₂)₀₋₄CH(OR^{∘})₂; —(CH₂)₀₋₄SR^{∘}; —(CH₂)₀₋₄Ph, which may be substituted with R^{∘}; —(CH₂)₀₋₄O(CH₂)₀₋₄Ph which may be substituted with R^{∘}; —CH═CHPh, which may be substituted with R^{∘}; —(CH₂)₀₋₄O(CH₂)₀₋₁-pyridyl which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; —(CH₂)₀₋₄N(R^{∘})C(O)NR^{∘}₂; —N(R^{∘})C(S)NR^{∘}₂; —(CH₂)₀₋₄N(R^{∘})C(O)OR^{∘}; —N(R^{∘})N(R^{∘})C(O)R^{∘}; —N(R^{∘})N(R^{∘})C(O)NR^{∘}₂; —N(R^{∘})N(R^{∘})C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)SR^{∘}; —(CH₂)₀₋₄C(O)OSiR^{∘}₃; —(CH₂)₀₋₄OC(O)R^{∘}; —OC(O)(CH₂)₀₋₄SR—, SC(S)SR^{∘}; —(CH₂)₀₋₄SC(O)R^{∘}; —(CH₂)₀₋₄C(O)NR⁰²; —C(S)NR⁰²; —C(S)SR^{∘}; —(CH₂)₀₋₄OC(O)NR⁰²; —C(O)N(OR^{∘})R^{∘}; —C(O)C(O)R^{∘}; —C(O)CH₂C(O)R^{∘}; —C(NOR^{∘})R^{∘}; —(CH₂)₀₋₄SSR^{∘}; —(CH₂)₀₋₄S(O)₂R^{∘}; —(CH₂)₀₋₄S(O)₂OR^{∘}; —(CH₂)₀₋₄OS(O)₂R^{∘}; —S(O)₂NR^{∘}₂; —(CH₂)₀₋₄S(O)R^{∘}; —N(R^{∘})S(O)₂NR^{∘}₂; —N(R^{∘})S(O)₂R^{∘}; —N(OR^{∘})R^{∘}; —C(NH)NR^{∘}₂; —P(O)₂R^{∘}; —P(O)R^{∘}₂; —OP(O)R^{∘}₂; —OP(O)(OR^{∘})₂; SiR^{∘}₃; —(C₁₋₄ straight or branched alkylene)O—N(R^{∘})₂; or —(C₁₋₄ straight or branched alkylene)C(O)O—N(R^{∘})₂, wherein each R^{∘} may be substituted as defined below and is independently hydrogen, C₁₋₆ aliphatic, —CH₂Ph, —O(CH₂)₀₋₁Ph, —CH₂-(5-6 membered heteroaryl ring), or a 5-6-membered saturated, partially unsaturated, or aryl ring having 0-4 heteroatoms independently selected from nitrogen, oxygen, or sulfur, or, notwithstanding the definition above, two independent occurrences of R^{∘}, taken together with their intervening atom(s), form a 3-12-membered saturated, partially unsaturated, or aryl mono- or bicyclic ring having 0-4 heteroatoms independently selected from nitrogen, oxygen, or sulfur, which may be substituted as defined below.

Suitable monovalent substituents on R^{∘} (or the ring formed by taking two independent occurrences of R^{∘} together with their intervening atoms), are independently halogen, —(CH₂)₀₋₂R^{●}, -(haloR^{●}), —(CH₂)₀₋₂OH, —(CH₂)₀₋₂OR^{●}, —(CH₂)₀₋₂CH(OR^{●})₂; —O(haloR^{●}), —CN, —N₃, —(CH₂)₀₋₂C(O)R^{●}, —(CH₂)₀₋₂C(O)OH, —(CH₂)₀₋₂C(O)OR^{●}, —(CH₂)₀₋₂SR^{●}, —(CH₂)₀₋₂SH, —(CH₂)₀₋₂NH₂, —(CH₂)₀₋₂NHR^{●}, —(CH₂)₀₋₂NR^{●}₂, —NO₂, —SiR^{●}3, —OSiR^{●}₃, —C(O)SR^{●}, —(C₁₋₄ straight or branched alkylene)C(O)OR^{●}, or —SSR^{●} wherein each R^{●} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{∘} include ═O and ═S.

Suitable divalent substituents on a saturated carbon atom of an “optionally substituted” group include the following: ═O, ═S, ═NNR*₂, ═NNHC(O)R*, ═NNHC(O)OR*, ═NNHS(O)₂R*, ═NR*, ═NOR*, —O(C(R*₂))₂₋₃O—, or —S(C(R*₂))₂₋₃S—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR*₂)₂₋₃O—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur.

Suitable substituents on the aliphatic group of R* include halogen, —R^{●}, -(haloR^{●}), —OH, —OR^{●}, —O(haloR^{●}), —CN, —C(O)OH, —C(O)OR^{●}, —NH₂, —NHR^{●}, —NR^{●}₂, or —NO₂, wherein each R^{●} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, —S(O)₂R^{†}, —S(O)₂NR^{†}₂, —C(S)NR^{†}₂, —C(NH)NR^{†}₂, or —N(R^{†})S(O)₂R^{†}; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur.

Suitable substituents on the aliphatic group of R^{†} are independently halogen, —R^{●}, -(haloR^{●}), —OH, —OR^{●}, —O(haloR^{●}), —CN, —C(O)OH, —C(O)OR^{●}, —NH₂, —NHR^{●}, —NR^{●}₂, or —NO₂, wherein each R^{●} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

The term “leaving group” refers to an atom (or a group of atoms) with electron withdrawing ability that can be displaced as a stable species, taking with it the bonding electrons. Examples of suitable leaving groups include halides and sulfonate esters, including, but not limited to, triflate, mesylate, tosylate, and brosylate.

The terms “hydrolysable group” and “hydrolysable moiety” refer to a functional group capable of undergoing hydrolysis, e.g., under basic or acidic conditions. Examples of hydrolysable residues include, without limitation, acid halides, activated carboxylic acids, and various protecting groups known in the art (see, for example, “Protective Groups in Organic Synthesis,” T. W. Greene, P. G. M. Wuts, Wiley-Interscience, 1999).

The term “organic residue” defines a carbon-containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-thiazolidinedione radical in a particular compound has the structure:

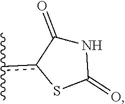

regardless of whether thiazolidinedione is used to prepare the compound. In some embodiments the radical (for example an alkyl) can be further modified (i.e., substituted alkyl) by having bonded thereto one or more “substituent radicals.” The number of atoms in a given radical is not critical to the present invention unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5, 6, 7, 8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

Compounds described herein can contain one or more double bonds and, thus, potentially give rise to cis/trans (E/Z) isomers, as well as other conformational isomers. Unless stated to the contrary, the invention includes all such possible isomers, as well as mixtures of such isomers.

Unless stated to the contrary, a formula with chemical bonds shown only as solid lines and not as wedges or dashed lines contemplates each possible isomer, e.g., each enantiomer and diastereomer, and a mixture of isomers, such as a racemic or scalemic mixture. Compounds described herein can contain one or more asymmetric centers and, thus, potentially give rise to diastereomers and optical isomers. Unless stated to the contrary, the present invention includes all such possible diastereomers as well as their racemic mixtures, their substantially pure resolved enantiomers, all possible geometric isomers, and pharmaceutically acceptable salts thereof. Mixtures of stereoisomers, as well as isolated specific stereoisomers, are also included. During the course of the synthetic procedures used to prepare such compounds, or in using racemization or epimerization procedures known to those skilled in the art, the products of such procedures can be a mixture of stereoisomers.

Many organic compounds exist in optically active forms having the ability to rotate the plane of plane-polarized light. In describing an optically active compound, the prefixes D and L or R and S are used to denote the absolute configuration of the molecule about its chiral center(s). The prefixes d and l or (+) and (−) are employed to designate the sign of rotation of plane-polarized light by the compound, with (−) or meaning that the compound is levorotatory. A compound prefixed with (+) or d is dextrorotatory. For a given chemical structure, these compounds, called stereoisomers, are identical except that they are non-superimposable mirror images of one another. A specific stereoisomer can also be referred to as an enantiomer, and a mixture of such isomers is often called an enantiomeric mixture. A 50:50 mixture of enantiomers is referred to as a racemic mixture. Many of the compounds described herein can have one or more chiral centers and therefore can exist in different enantiomeric forms. If desired, a chiral carbon can be designated with an asterisk (*). When bonds to the chiral carbon are depicted as straight lines in the disclosed formulas, it is understood that both the (R) and (S) configurations of the chiral carbon, and hence both enantiomers and mixtures thereof, are embraced within the formula. As is used in the art, when it is desired to specify the absolute configuration about a chiral carbon, one of the bonds to the chiral carbon can be depicted as a wedge (bonds to atoms above the plane) and the other can be depicted as a series or wedge of short parallel lines is (bonds to atoms below the plane). The Cahn-Ingold-Prelog system can be used to assign the (R) or (S) configuration to a chiral carbon.

When the disclosed compounds contain one chiral center, the compounds exist in two enantiomeric forms. Unless specifically stated to the contrary, a disclosed compound includes both enantiomers and mixtures of enantiomers, such as the specific 50:50 mixture referred to as a racemic mixture. The enantiomers can be resolved by methods known to those skilled in the art, such as formation of diastereoisomeric salts which may be separated, for example, by crystallization (see, CRC Handbook of Optical Resolutions via Diastereomeric Salt Formation by David Kozma (CRC Press, 2001)); formation of diastereoisomeric derivatives or complexes which may be separated, for example, by crystallization, gas-liquid or liquid chromatography; selective reaction of one enantiomer with an enantiomer-specific reagent, for example enzymatic esterification; or gas-liquid or liquid chromatography in a chiral environment, for example on a chiral support for example silica with a bound chiral ligand or in the presence of a chiral solvent. It will be appreciated that where the desired enantiomer is converted into another chemical entity by one of the separation procedures described above, a further step can liberate the desired enantiomeric form. Alternatively, specific enantiomers can be synthesized by asymmetric synthesis using optically active reagents, substrates, catalysts or solvents, or by converting one enantiomer into the other by asymmetric transformation.

Designation of a specific absolute configuration at a chiral carbon in a disclosed compound is understood to mean that the designated enantiomeric form of the compounds can be provided in enantiomeric excess (e.e.). Enantiomeric excess, as used herein, is the presence of a particular enantiomer at greater than 50%, for example, greater than 60%, greater than 70%, greater than 75%, greater than 80%, greater than 85%, greater than 90%, greater than 95%, greater than 98%, or greater than 99%. In one aspect, the designated enantiomer is substantially free from the other enantiomer. For example, the “R” forms of the compounds can be substantially free from the “S” forms of the compounds and are, thus, in enantiomeric excess of the “S” forms. Conversely, “S” forms of the compounds can be substantially free of “R” forms of the compounds and are, thus, in enantiomeric excess of the “R” forms.

When a disclosed compound has two or more chiral carbons, it can have more than two optical isomers and can exist in diastereoisomeric forms. For example, when there are two chiral carbons, the compound can have up to four optical isomers and two pairs of enantiomers ((S,S)/(R,R) and (R,S)/(S,R)). The pairs of enantiomers (e.g., (S,S)/(R,R)) are mirror image stereoisomers of one another. The stereoisomers that are not mirror-images (e.g., (S,S) and (R,S)) are diastereomers. The diastereoisomeric pairs can be separated by methods known to those skilled in the art, for example chromatography or crystallization and the individual enantiomers within each pair may be separated as described above. Unless otherwise specifically excluded, a disclosed compound includes each diastereoisomer of such compounds and mixtures thereof.

The compounds according to this disclosure may form prodrugs at hydroxyl or amino functionalities using alkoxy, amino acids, etc., groups as the prodrug forming moieties. For instance, the hydroxymethyl position may form mono-, di- or triphosphates and again these phosphates can form prodrugs. Preparations of such prodrug derivatives are discussed in various literature sources (examples are: Alexander et al., J. Med. Chem. 1988, 31, 318; Aligas-Martin et al., PCT WO 2000/041531, p. 30). The nitrogen function converted in preparing these derivatives is one (or more) of the nitrogen atoms of a compound of the disclosure.

“Derivatives” of the compounds disclosed herein are pharmaceutically acceptable salts, prodrugs, deuterated forms, radioactively labeled forms, isomers, solvates and combinations thereof. The “combinations” mentioned in this context are refer to derivatives falling within at least two of the groups: pharmaceutically acceptable salts, prodrugs, deuterated forms, radioactively labeled forms, isomers, and solvates. Examples of radioactively labeled forms include compounds labeled with tritium, phosphorous-32, iodine-129, carbon-11, fluorine-18, and the like.

Compounds described herein comprise atoms in both their natural isotopic abundance and in non-natural abundance. The disclosed compounds can be isotopically labeled or isotopically substituted compounds identical to those described, but for the fact that one or more atoms are replaced by an atom having an atomic mass or mass number different from the atomic mass or mass number typically found in nature. Examples of isotopes that can be incorporated into compounds of the invention include isotopes of hydrogen, carbon, nitrogen, oxygen, phosphorous, fluorine and chlorine, such as ²H, ³H, ¹³C, ¹⁴C, ¹⁵N, ¹⁸O, ¹⁷O, ³⁵S, ¹⁸F and ³⁶Cl, respectively. Compounds further comprise prodrugs thereof, and pharmaceutically acceptable salts of said compounds or of said prodrugs which contain the aforementioned isotopes and/or other isotopes of other atoms are within the scope of this invention. Certain isotopically labeled compounds of the present invention, for example those into which radioactive isotopes such as ³H and ¹⁴C are incorporated, are useful in drug and/or substrate tissue distribution assays. Tritiated, i.e., ³H, and carbon-14, i.e., ¹⁴C, isotopes are particularly preferred for their ease of preparation and detectability. Further, substitution with heavier isotopes such as deuterium, i.e., ²H, can afford certain therapeutic advantages resulting from greater metabolic stability, for example increased in vivo half-life or reduced dosage requirements and, hence, may be preferred in some circumstances. Isotopically labeled compounds of the present invention and prodrugs thereof can generally be prepared by carrying out the procedures below, by substituting a readily available isotopically labeled reagent for a non-isotopically labeled reagent.

The compounds described in the invention can be present as a solvate. In some cases, the solvent used to prepare the solvate is an aqueous solution, and the solvate is then often referred to as a hydrate. The compounds can be present as a hydrate, which can be obtained, for example, by crystallization from a solvent or from aqueous solution. In this connection, one, two, three or any arbitrary number of solvent or water molecules can combine with the compounds according to the invention to form solvates and hydrates. Unless stated to the contrary, the invention includes all such possible solvates.

The term “co-crystal” means a physical association of two or more molecules that owe their stability through non-covalent interaction. One or more components of this molecular complex provide a stable framework in the crystalline lattice. In certain instances, the guest molecules are incorporated in the crystalline lattice as anhydrates or solvates, see e.g. “Crystal Engineering of the Composition of Pharmaceutical Phases. Do Pharmaceutical Co-crystals Represent a New Path to Improved Medicines?” Almarasson, O., et. al., The Royal Society of Chemistry, 1889-1896, 2004. Examples of co-crystals include p-toluenesulfonic acid and benzenesulfonic acid.

It is also appreciated that certain compounds described herein can be present as an equilibrium of tautomers. For example, ketones with an α-hydrogen can exist in an equilibrium of the keto form and the enol form.

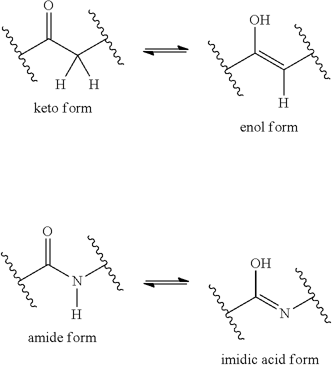 [SMILES: *CC(*)=O ; */C=C(/*)O ; *NC(*)=O ; */N=C(/*)O]

Likewise, amides with an N-hydrogen can exist in an equilibrium of the amide form and the imidic acid form. As another example, pyrazoles can exist in two tautomeric forms, N¹-unsubstituted, 3-A³ and N¹-unsubstituted, 5-A³ as shown below.

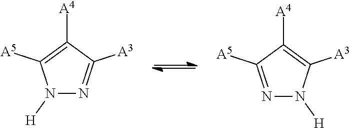

Unless stated to the contrary, the invention includes all such possible tautomers.

It is known that chemical substances form solids that are present in different states of order that are termed polymorphic forms or modifications. The different modifications of a polymorphic substance can differ greatly in their physical properties. The compounds according to the invention can be present in different polymorphic forms, with it being possible for particular modifications to be metastable. Unless stated to the contrary, the invention includes all such possible polymorphic forms.

In some aspects, a structure of a compound can be represented by a formula:

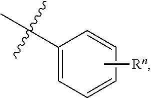

which is understood to be equivalent to a formula:

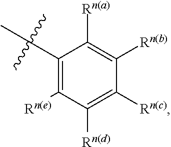

wherein n is typically an integer. That is, Rⁿ is understood to represent five independent substituents, R^{n(a)}, R^{n(b)}, R^{n(c)}, R^{n(d)}, R^{n(e)}. By “independent substituents,” it is meant that each R substituent can be independently defined. For example, if in one instance R^{n(a)} is halogen, then R^{n(b)} is not necessarily halogen in that instance.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Strem Chemicals (Newburyport, MA), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and supplemental volumes (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. BORYLATED AMIDOXIMES

In one aspect, the invention relates to borylated amidoxime analogs useful in, for example, the synthesis of functonalized oxadiazole and quinazolinone derivatives. Functionalized oxadiazole and quinazolinone derivatives have demonstrated therapeutic utility in the treatment of a variety of diseases and disorders including, but not limited to, neurodegenerative disorders, cancer, inflammatory disorders, and bacterial infections.

It is contemplated that each disclosed derivative can be optionally further substituted. It is also contemplated that any one or more derivative can be optionally omitted from the invention. It is understood that a disclosed compound can be provided by the disclosed methods. It is also understood that the disclosed compounds can be employed in the disclosed methods of using.

### 1. Structure

In one aspect, disclosed are compounds having a structure represented by a formula:

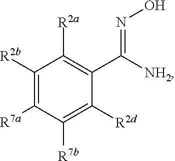

wherein each of R^{7a} and R^{7b} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, and —B(R²⁰)₃X, provided that exactly one of R^{7a} and R^{7b} is —B(R²⁰)₃X; wherein each occurrence of R²⁰, when present, is independently halogen; wherein X, when present, is a counterion; and wherein each of R^{2a}, R^{2b}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof.

In one aspect, disclosed are compounds having a structure represented by a formula:

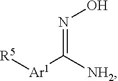

wherein R⁵ is selected from —B(OR¹⁵)₂ and —B(R¹⁶)₃X; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein X, when present, is a counterion; and wherein Ar¹ is a C2-C10 heteroaryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof.

In various aspects, the compound has a structure represented by a formula:

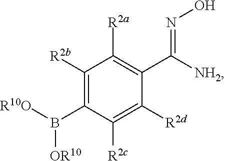

or a salt thereof.

In various aspects, the compound has a structure represented by a formula:

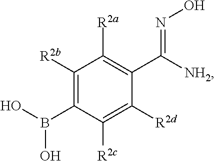

or a salt thereof.

In various aspects, the compound has a structure represented by a formula:

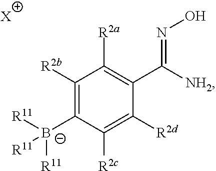

or a salt thereof.

In various aspects, the compound has a structure represented by a formula:

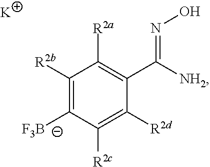

or a salt thereof.

In various aspects, the compound has a structure represented by a formula:

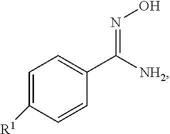

or a salt thereof.

In various aspects, the compound has a structure represented by a formula:

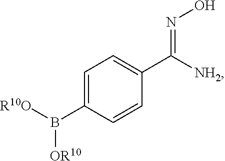

or a salt thereof.

In various aspects, the compound is:

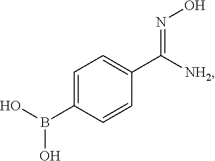 [SMILES: N/C(=N\O)c1ccc(B(O)O)cc1]

or a salt thereof.

In various aspects, the compound has a structure represented by a formula:

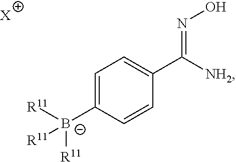

or a salt thereof.

In various aspects, the compound is:

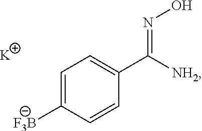

or a salt thereof.

In various aspects, the compound has a structure represented by a formula:

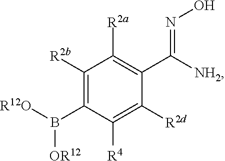

or a salt thereof.

In various aspects, the compound has a structure represented by a formula:

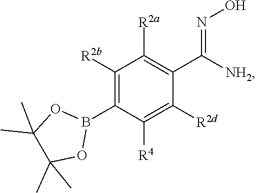

or a salt thereof.

In various aspects, the compound has a structure represented by a formula selected from:

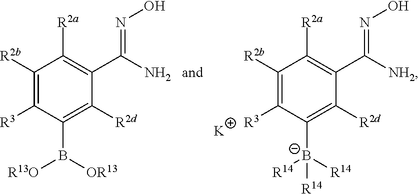

or a salt thereof.

In various aspects, the compound has a structure represented by a formula selected from:

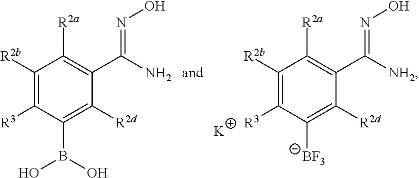

or a salt thereof.

In various aspects, the compound has a structure represented by a formula:

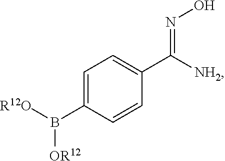

or a salt thereof.

In various aspects, the compound is:

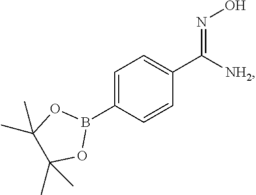 [SMILES: CC1(C)OB(c2ccc(/C(N)=N/O)cc2)OC1(C)C]

or a salt thereof.

In various aspects, the compound has a structure represented by a formula selected from:

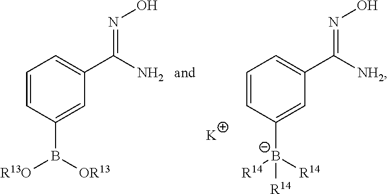

or a salt thereof.

In various aspects, the compound has a structure represented by a formula selected from:

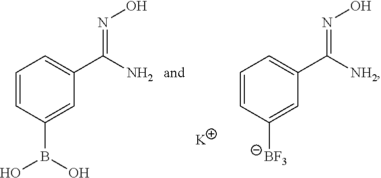

or a salt thereof.

In various aspects, the compound has a structure represented by a formula selected from:

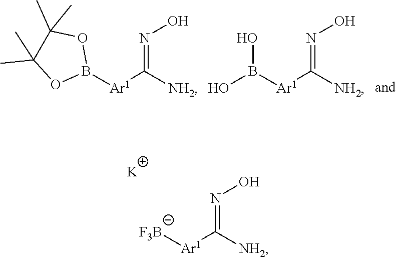

or a salt thereof.

In various aspects, the compound has a structure represented by a formula:

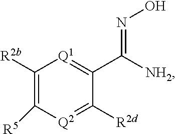

wherein each of Q¹ and Q² is independently selected from N and CR¹⁷, provided at least one of Q¹ and Q² is N; wherein R¹⁷, when present, is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; and wherein each of R^{2b} and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof.

In various aspects, the compound has a structure represented by a formula:

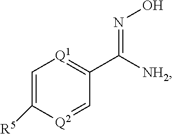

wherein each of Q¹ and Q² is independently selected from N and CH, or a salt thereof.

In various aspects, the compound has a structure represented by a formula selected from:

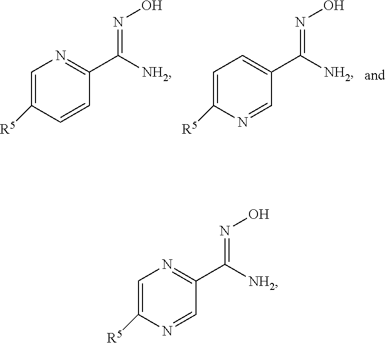

or a salt thereof.

In various aspects, the compound has a structure represented by a formula

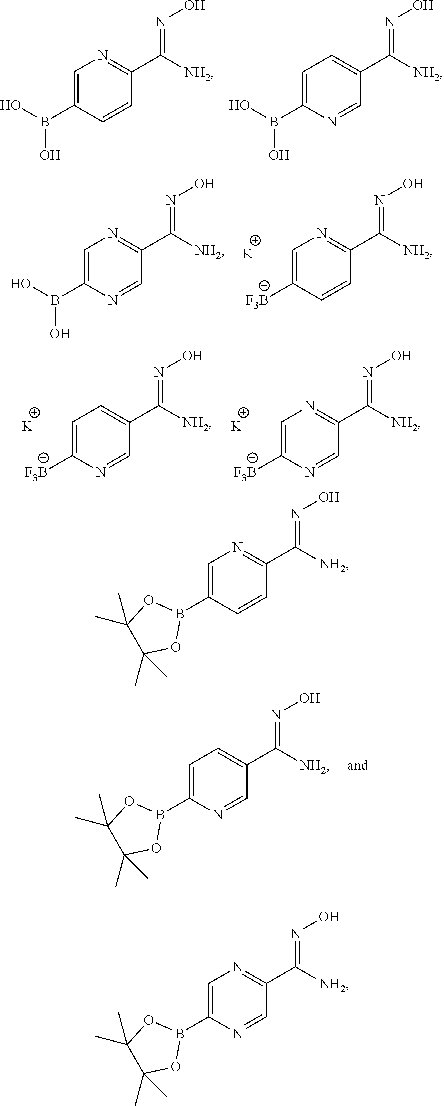

or a salt thereof.

In various aspects, the compound has a structure represented by a formula selected from:

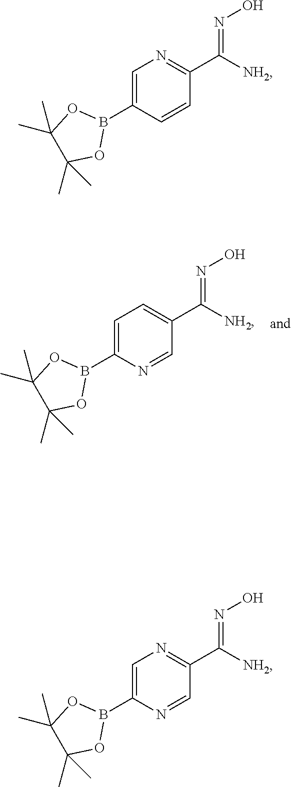 [SMILES: CC1(C)OB(c2ccc(/C(N)=N/O)nc2)OC1(C)C ; CC1(C)OB(c2ccc(/C(N)=N/O)cn2)OC1(C)C ; CC1(C)OB(c2cnc(/C(N)=N/O)cn2)OC1(C)C]

or a salt thereof.

In various aspects, the compound has a structure represented by a formula:

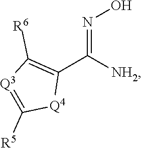

wherein Q³ is selected from N and CR¹⁸; wherein R¹⁸, when present, is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; wherein Q⁴ is selected from 0, S, and NR¹⁹; wherein R¹⁹, when present, is selected from hydrogen and C1-C4 alkyl; and wherein R⁶ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof.

In various aspects, the compound has a structure represented by a formula:

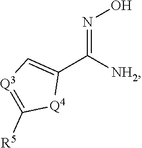

wherein Q³ is selected from N and CH, or a pharmaceutically acceptable salt thereof.

In various aspects, the compound has a structure represented by a formula selected from:

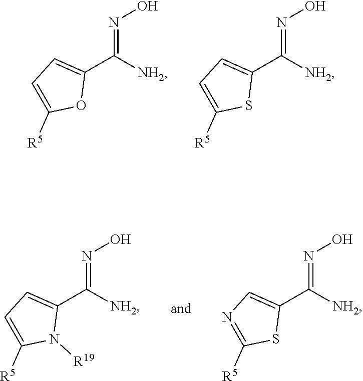

or a pharmaceutically acceptable salt thereof.

In various aspects, the compound has a structure represented by a formula selected from:

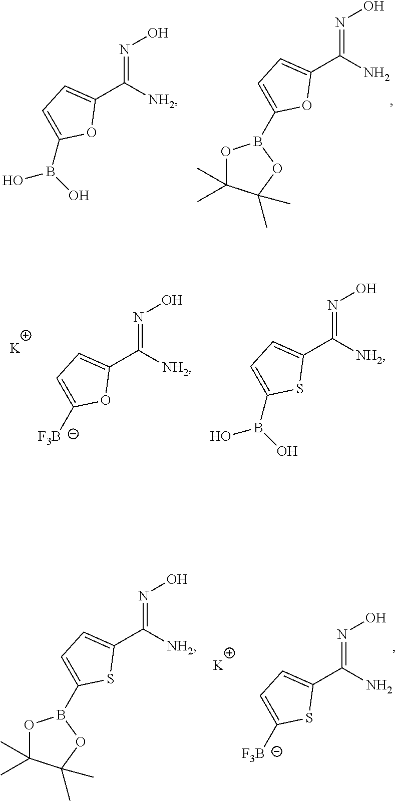

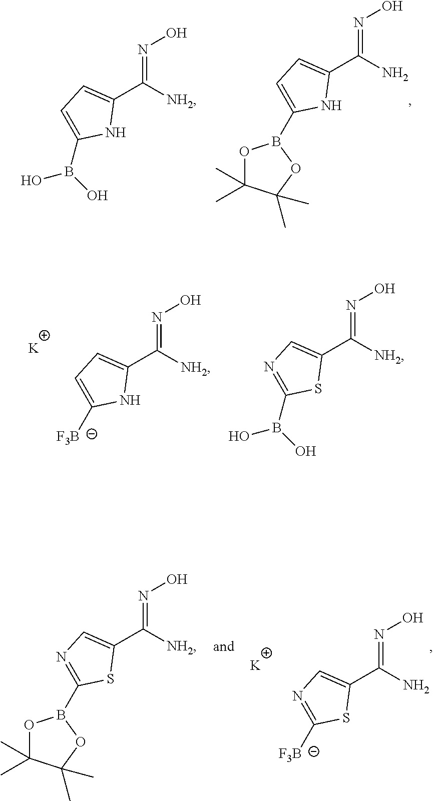

or a salt thereof.

In various aspects, the compound has a structure represented by a formula selected from:

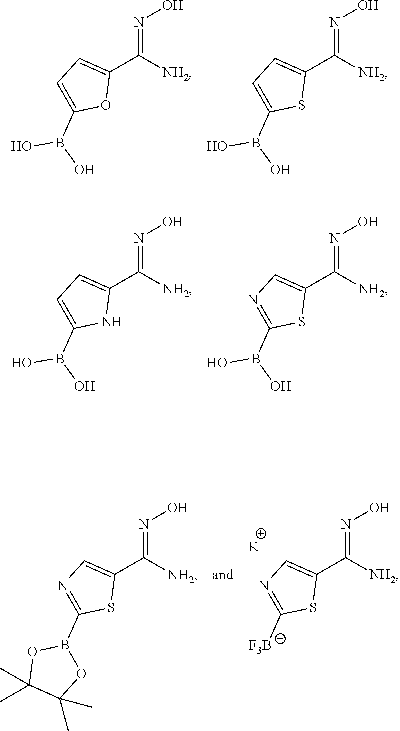

or a salt thereof.

In various aspects, the compound is selected from:

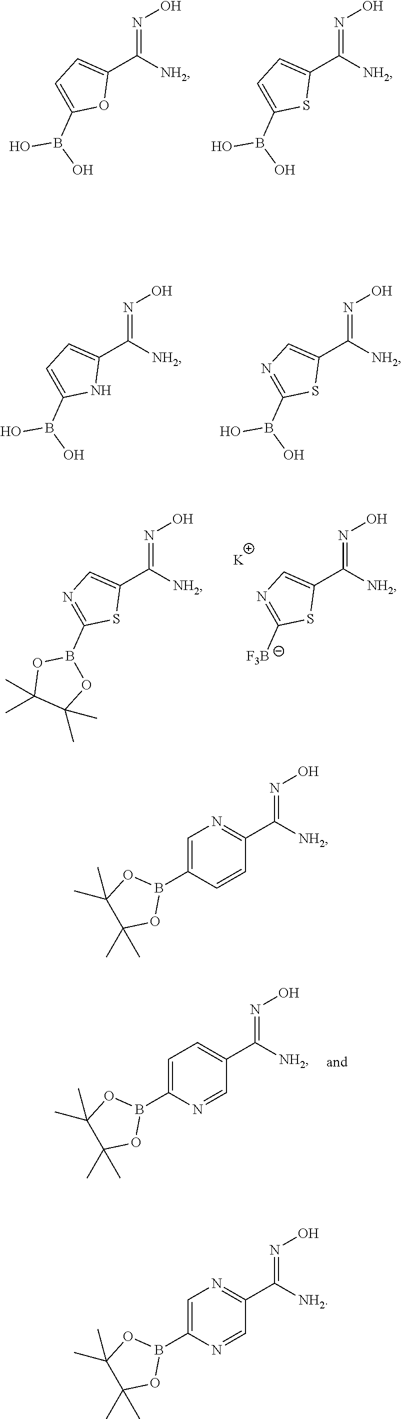

In various aspects, the compound has a structure represented by a formula selected from:

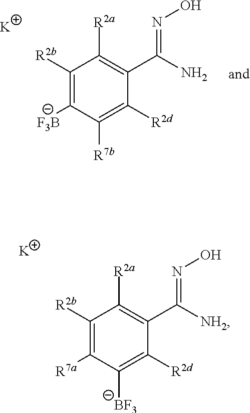

or a salt thereof.

In various aspects, the compound has a structure represented by a formula:

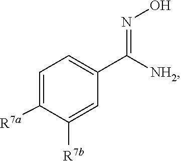

or a salt thereof.

In various aspects, the compound is selected from:

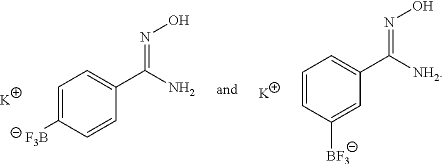

a. Q¹ and Q² Groups

In one aspect, each of Q¹ and Q² is independently selected from N and CR¹⁷, provided at least one of Q¹ and Q² is N. In a further aspect, Q¹ is N and Q² is CR¹⁷. In a still further aspect, Q¹ is CR¹⁷ and Q² is N. In yet a further aspect, each of Q¹ and Q² is N.

In various aspects, each of Q¹ and Q² is independently selected from N and CH. In a further aspect, Q¹ is N and Q² is CH. In a still further aspect, Q¹ is CH and Q² is N.

b. Q³ Groups

In one aspect, Q³ is selected from N and CR¹⁸. In a further aspect, Q³ is N. In a still further aspect, Q³ is CR¹⁸.

In various aspects, Q³ is selected from N and CH. In a further aspect, Q³ is CH.

c. Q⁴ Groups

In one aspect, Q⁴ is selected from O, S, and NR¹⁹. In a further aspect, Q⁴ is selected from O and S. In a still further aspect, Q⁴ is selected from O and NR¹⁹. In yet a further aspect, Q⁴ is selected from S and NR¹⁹. In an even further aspect, Q⁴ is O. In a still further aspect, Q⁴ is S. In yet a further aspect, Q⁴ is NR¹⁹.

In various aspects, Q⁴ is selected from O, S, and NH. In a further aspect, Q⁴ is selected from O and S. In a still further aspect, Q⁴ is selected from O and NH. In yet a further aspect, Q⁴ is selected from S and NH. In an even further aspect, Q⁴ is O. In a still further aspect, Q⁴ is S. In yet a further aspect, Q⁴ is NH.

d. X Groups

In one aspect, X is a counterion. Examples of counterions include, but are not limited to, lithium, sodium, tartrate, citrate, and potassium counterions. In a further aspect, the counterion is a lithium, sodium, or potassium counterion. In a still further aspect, X is a lithium counterion. In yet a further aspect, X is a sodium counterion. In an even further aspect, X is a potassium counterion.

e. R¹ Groups

In one aspect, R¹ is selected from —B(OR¹⁰)₂ and —B(R¹¹)₃X. In a further aspect, R¹ is —B(OR¹⁰)₂. In a still further aspect, R¹ is —B(R¹¹)₃X.

f. R^{2A}, R^{2B}, R^{2C}, and R^{2D} Groups

In one aspect, each of R^{2a}, R^{2b}, R^{2c}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, each of R², R^{2b}, R^{2c}, and R^{2d} is independently selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, each of R^{2a}, R^{2b}, R^{2c}, and R^{2d} is independently selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, each of R^{2a}, R^{2b}, R^{2c}, and R^{2d} is independently selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In one aspect, each of R^{2a}, R^{2b}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, each of R^{2a}, R^{2b}, and R^{2d} is independently selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, each of R^{2a}, R^{2b}, and R^{2d} is independently selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, each of R^{2a}, R^{2b}, and R^{2d} is independently selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In one aspect, each of R^{2b} and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, each of R^{2b} and R^{2d} is independently selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, each of R^{2b} and R^{2d} is independently selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, each of R^{2b} and R^{2d} is independently selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In various aspects, each of R^{2a}, R^{2b}, R^{2c}, and R^{2d} is independently selected from hydrogen, halogen, —CN, —NH₂, —OH, —NO₂, C1-C4 alkyl, and C2-C4 alkenyl. In a further aspect, each of R^{2a}, R^{2b}, R^{2c}, and R^{2d} is independently selected from hydrogen, —F, —Cl, —CN, —NH₂, —OH, —NO₂, methyl, ethyl, n-propyl, isopropyl, ethenyl, n-propenyl, and isopropenyl. In a still further aspect, each of R^{2a}, R^{2b}, R^{2c}, and R^{2d} is independently selected from hydrogen, —F, —Cl, —CN, —NH₂, —OH, —NO₂, methyl, ethyl, and ethenyl. In yet a further aspect, each of R^{2a}, R^{2b}, R^{2c}, and R^{2d} is independently selected from hydrogen, —F, —Cl, —CN, —NH₂, —OH, —NO₂, and methyl.

In various aspects, each of R^{2a}, R^{2b}, R^{2c}, and R^{2d} is independently selected from hydrogen, halogen, —CN, —NH₂, —OH, —NO₂, C1-C4 haloalkyl, and C1-C4 cyanoalkyl. In a further aspect, each of R^{2a}, R^{2b}, R^{2c}, and R^{2d} is independently selected from hydrogen, —F, —Cl, —CN, —NH₂, —OH, —NO₂, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, and —CH(CH₃)CH₂CN. In a still further aspect, each of R^{2a}, R^{2b}, R^{2c}, and R^{2d} is independently selected from hydrogen, —F, —Cl, —CN, —NH₂, —OH, —NO₂, —CH₂F, —CH₂Cl, —CH₂CH₂F, —CH₂CH₂Cl, —CH₂CN, and —CH₂CH₂CN. In yet a further aspect, each of R^{2a}, R^{2b}, R^{2c}, and R^{2d} is independently selected from hydrogen, —F, —Cl, —CN, —NH₂, —OH, —NO₂, —CH₂F, —CH₂Cl, and —CH₂CN.

In various aspects, each of R^{2a}, R^{2b}, R^{2c}, and R^{2d} is independently selected from hydrogen, halogen, —CN, —NH₂, —OH, —NO₂, C1-C4 hydroxyalkyl, C1-C4 haloalkoxy, and C1-C4 alkoxy. In a further aspect, each of R^{2a}, R^{2b}, R^{2c}, and R^{2d} is independently selected from hydrogen, —F, —Cl, —CN, —NH₂, —OH, —NO₂, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, and —OCH(CH₃)CH₃. In a still further aspect, each of R^{2a}, R^{2b}, R^{2c}, and R^{2d} is independently selected from hydrogen, —F, —Cl, —CN, —NH₂, —OH, —NO₂, —CH₂OH, —CH₂CH₂OH, —OCF₃, —OCH₂CF₃, —OCH₃, and —OCH₂CH₃. In yet a further aspect, each of R^{2a}, R^{2b}, R^{2c}, and R^{2d} is independently selected from hydrogen, —F, —Cl, —CN, —NH₂, —OH, —NO₂, —CH₂OH, —OCF₃, and —OCH₃.

In various aspects, each of R^{2a}, R^{2b}, R^{2c}, and R^{2d} is independently selected from hydrogen, halogen, —CN, —NH₂, —OH, —NO₂, C1-C4 alkylamino, (C1-C4)(C1-C4) dialkylamino, and C1-C4 aminoalkyl. In a further aspect, each of R^{2a}, R^{2b}, R^{2c}, and R^{2d} is independently selected from hydrogen, —F, —Cl, —CN, —NH₂, —OH, —NO₂, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, each of R^{2a}, R^{2b}, R^{2c}, and R^{2d} is independently selected from hydrogen, —F, —Cl, —CN, —NH₂, —OH, —NO₂, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, each of R^{2a}, R^{2b}, R^{2c}, and R^{2d} is independently selected from hydrogen, —F, —Cl, —CN, —NH₂, —OH, —NO₂, —NHCH₃, —N(CH₃)₂, and —CH₂NH₂.

In a further aspect, each of R^{2a}, R^{2b}, R^{2c}, and R^{2d} is independently selected from hydrogen and C1-C4 alkyl. In a still further aspect, each of R^{2a}, R^{2b}, R^{2c}, and R^{2d} is independently selected from hydrogen, methyl, ethyl, n-propyl, and isopropyl. In yet a further aspect, each of R^{2a}, R^{2b}, R^{2c}, and R^{2d} is independently selected from hydrogen, methyl, and ethyl. In an even further aspect, each of R^{2a}, R^{2b}, R^{2c}, and R^{2d} is independently selected from hydrogen and ethyl. In a still further aspect, each of R^{2a}, R^{2b}, R^{2c}, and R^{2d} is independently selected from hydrogen and methyl.

In a further aspect, each of R^{2a}, R^{2b}, R^{2c}, and R^{2d} is independently selected from hydrogen and halogen. In a still further aspect, each of R^{2a}, R^{2b}, R^{2c}, and R^{2d} is independently selected from hydrogen, —F, —Cl, and —Br. In yet a further aspect, each of R^{2a}, R^{2b}, R^{2c}, and R^{2d} is independently selected from hydrogen, —F, and —Cl. In an even further aspect, each of R^{2a}, R^{2b}, R^{2c}, and R²¹ is independently selected from hydrogen and —Cl. In a still further aspect, each of R^{2a}, R^{2b}, R^{2c}, and R^{2d} is independently selected from hydrogen and —F.

In a further aspect, each of R^{2a}, R^{2b}, R^{2c}, and R^{2d} is hydrogen.

g. R³ Groups

In one aspect, R³ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, and —B(OR¹²)₂.

In various aspects, R³ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, R³ is selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R³ is selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R³ is selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In various aspects, R³ is selected from hydrogen, halogen, —CN, —NH₂, —OH, —NO₂, C1-C4 alkyl, and C2-C4 alkenyl. In a further aspect, R³ is selected from hydrogen, —F, —Cl, —CN, —NH₂, —OH, —NO₂, methyl, ethyl, n-propyl, isopropyl, ethenyl, n-propenyl, and isopropenyl. In a still further aspect, R³ is selected from hydrogen, —F, —Cl, —CN, —NH₂, —OH, —NO₂, methyl, ethyl, and ethenyl. In yet a further aspect, R³ is selected from hydrogen, —F, —Cl, —CN, —NH₂, —OH, —NO₂, and methyl.

In various aspects, R³ is selected from hydrogen, halogen, —CN, —NH₂, —OH, —NO₂, C1-C4 haloalkyl, and C1-C4 cyanoalkyl. In a further aspect, R³ is selected from hydrogen, —F, —Cl, —CN, —NH₂, —OH, —NO₂, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, and —CH(CH₃)CH₂CN. In a still further aspect, R³ is selected from hydrogen, —F, —Cl, —CN, —NH₂, —OH, —NO₂, —CH₂F, —CH₂Cl, —CH₂CH₂F, —CH₂CH₂Cl, —CH₂CN, and —CH₂CH₂CN. In yet a further aspect, R³ is selected from hydrogen, —F, —Cl, —CN, —NH₂, —OH, —NO₂, —CH₂F, —CH₂Cl, and —CH₂CN.

In various aspects, R³ is selected from hydrogen, halogen, —CN, —NH₂, —OH, —NO₂, C1-C4 hydroxyalkyl, C1-C4 haloalkoxy, and C1-C4 alkoxy. In a further aspect, R³ is selected from hydrogen, —F, —Cl, —CN, —NH₂, —OH, —NO₂, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, and —OCH(CH₃)CH₃. In a still further aspect, R³ is selected from hydrogen, —F, —Cl, —CN, —NH₂, —OH, —NO₂, —CH₂OH, —CH₂CH₂OH, —OCF₃, —OCH₂CF₃, —OCH₃, and —OCH₂CH₃. In yet a further aspect, R³ is selected from hydrogen, —F, —Cl, —CN, —NH₂, —OH, —NO₂, —CH₂OH, —OCF₃, and —OCH₃.

In various aspects, R³ is selected from hydrogen, halogen, —CN, —NH₂, —OH, —NO₂, C1-C4 alkylamino, (C1-C4)(C1-C4) dialkylamino, and C1-C4 aminoalkyl. In a further aspect, R³ is selected from hydrogen, —F, —Cl, —CN, —NH₂, —OH, —NO₂, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R³ is selected from hydrogen, —F, —Cl, —CN, —NH₂, —OH, —NO₂, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R³ is selected from hydrogen, —F, —Cl, —CN, —NH₂, —OH, —NO₂, —NHCH₃, —N(CH₃)₂, and —CH₂NH₂.

In a further aspect, R³ is selected from hydrogen and C1-C4 alkyl. In a still further aspect, R³ is selected from hydrogen, methyl, ethyl, n-propyl, and isopropyl. In yet a further aspect, R³ is selected from hydrogen, methyl, and ethyl. In an even further aspect, R³ is selected from hydrogen and ethyl. In a still further aspect, R³ is selected from hydrogen and methyl.

In a further aspect, R³ is selected from hydrogen and halogen. In a still further aspect, R³ is selected from hydrogen, —F, —Cl, and —Br. In yet a further aspect, R³ is selected from hydrogen, —F, and —Cl. In an even further aspect, R³ is selected from hydrogen and —Cl. In a still further aspect, R³ is selected from hydrogen and —F.

In a further aspect, R³ is hydrogen.

In various aspects, R³ is —B(OR¹²)₂.

h. R⁴ Groups

In one aspect, R⁴ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, —B(OR¹³)₂, and —B(R¹⁴)₃X.

In various aspects, R⁴ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, R⁴ is selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R⁴ is selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R⁴ is selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In various aspects, R⁴ is selected from hydrogen, halogen, —CN, —NH₂, —OH, —NO₂, C1-C4 alkyl, and C2-C4 alkenyl. In a further aspect, R⁴ is selected from hydrogen, —F, —Cl, —CN, —NH₂, —OH, —NO₂, methyl, ethyl, n-propyl, isopropyl, ethenyl, n-propenyl, and isopropenyl. In a still further aspect, R⁴ is selected from hydrogen, —F, —Cl, —CN, —NH₂, —OH, —NO₂, methyl, ethyl, and ethenyl. In yet a further aspect, R⁴ is selected from hydrogen, —F, —Cl, —CN, —NH₂, —OH, —NO₂, and methyl.

In various aspects, R⁴ is selected from hydrogen, halogen, —CN, —NH₂, —OH, —NO₂, C1-C4 haloalkyl, and C1-C4 cyanoalkyl. In a further aspect, R⁴ is selected from hydrogen, —F, —Cl, —CN, —NH₂, —OH, —NO₂, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, and —CH(CH₃)CH₂CN. In a still further aspect, R⁴ is selected from hydrogen, —F, —Cl, —CN, —NH₂, —OH, —NO₂, —CH₂F, —CH₂Cl, —CH₂CH₂F, —CH₂CH₂Cl, —CH₂CN, and —CH₂CH₂CN. In yet a further aspect, R⁴ is selected from hydrogen, —F, —Cl, —CN, —NH₂, —OH, —NO₂, —CH₂F, —CH₂Cl, and —CH₂CN.

In various aspects, R⁴ is selected from hydrogen, halogen, —CN, —NH₂, —OH, —NO₂, C1-C4 hydroxyalkyl, C1-C4 haloalkoxy, and C1-C4 alkoxy. In a further aspect, R⁴ is selected from hydrogen, —F, —Cl, —CN, —NH₂, —OH, —NO₂, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, and —OCH(CH₃)CH₃. In a still further aspect, R⁴ is selected from hydrogen, —F, —Cl, —CN, —NH₂, —OH, —NO₂, —CH₂OH, —CH₂CH₂OH, —OCF₃, —OCH₂CF₃, —OCH₃, and —OCH₂CH₃. In yet a further aspect, R⁴ is selected from hydrogen, —F, —Cl, —CN, —NH₂, —OH, —NO₂, —CH₂OH, —OCF₃, and —OCH₃.

In various aspects, R⁴ is selected from hydrogen, halogen, —CN, —NH₂, —OH, —NO₂, C1-C4 alkylamino, (C1-C4)(C1-C4) dialkylamino, and C1-C4 aminoalkyl. In a further aspect, R⁴ is selected from hydrogen, —F, —Cl, —CN, —NH₂, —OH, —NO₂, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R⁴ is selected from hydrogen, —F, —Cl, —CN, —NH₂, —OH, —NO₂, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R⁴ is selected from hydrogen, —F, —Cl, —CN, —NH₂, —OH, —NO₂, —NHCH₃, —N(CH₃)₂, and —CH₂NH₂.

In a further aspect, R⁴ is selected from hydrogen and C1-C4 alkyl. In a still further aspect, R⁴ is selected from hydrogen, methyl, ethyl, n-propyl, and isopropyl. In yet a further aspect, R⁴ is selected from hydrogen, methyl, and ethyl. In an even further aspect, R⁴ is selected from hydrogen and ethyl. In a still further aspect, R⁴ is selected from hydrogen and methyl.

In a further aspect, R⁴ is selected from hydrogen and halogen. In a still further aspect, R⁴ is selected from hydrogen, —F, —Cl, and —Br. In yet a further aspect, R⁴ is selected from hydrogen, —F, and —Cl. In an even further aspect, R⁴ is selected from hydrogen and —Cl. In a still further aspect, R⁴ is selected from hydrogen and —F.

In a further aspect, R⁴ is hydrogen.

In various aspects, R⁴ is selected from —B(OR¹³)₂ and —B(R¹⁴)₃X. In a further aspect, R⁴ is —B(OR¹³)₂. In a still further aspect, R⁴ is —B(R¹⁴)₃X.

i. R⁵ Groups

In one aspect, R⁵ is selected from —B(OR¹⁵)₂ and —B(R¹⁶)₃. In a further aspect, R⁵ is —B(OR¹⁵)₂. In a still further aspect, R⁵ is —B(R¹⁶)₃.

j. R⁶ Groups

In one aspect, R⁶ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, R⁶ is selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R⁶ is selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R⁶ is selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In various aspects, R⁶ is selected from hydrogen, halogen, —CN, —NH₂, —OH, —NO₂, C1-C4 alkyl, and C2-C4 alkenyl. In a further aspect, R⁶ is selected from hydrogen, —F, —Cl, —CN, —NH₂, —OH, —NO₂, methyl, ethyl, n-propyl, isopropyl, ethenyl, n-propenyl, and isopropenyl. In a still further aspect, R⁶ is selected from hydrogen, —F, —Cl, —CN, —NH₂, —OH, —NO₂, methyl, ethyl, and ethenyl. In yet a further aspect, R⁶ is selected from hydrogen, —F, —Cl, —CN, —NH₂, —OH, —NO₂, and methyl.

In various aspects, R⁶ is selected from hydrogen, halogen, —CN, —NH₂, —OH, —NO₂, C1-C4 haloalkyl, and C1-C4 cyanoalkyl. In a further aspect, R⁶ is selected from hydrogen, —F, —Cl, —CN, —NH₂, —OH, —NO₂, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, and —CH(CH₃)CH₂CN. In a still further aspect, R⁶ is selected from hydrogen, —F, —Cl, —CN, —NH₂, —OH, —NO₂, —CH₂F, —CH₂Cl, —CH₂CH₂F, —CH₂CH₂Cl, —CH₂CN, and —CH₂CH₂CN. In yet a further aspect, R⁶ is selected from hydrogen, —F, —Cl, —CN, —NH₂, —OH, —NO₂, —CH₂F, —CH₂Cl, and —CH₂CN.

In various aspects, R⁶ is selected from hydrogen, halogen, —CN, —NH₂, —OH, —NO₂, C1-C4 hydroxyalkyl, C1-C4 haloalkoxy, and C1-C4 alkoxy. In a further aspect, R⁶ is selected from hydrogen, —F, —Cl, —CN, —NH₂, —OH, —NO₂, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, and —OCH(CH₃)CH₃. In a still further aspect, R⁶ is selected from hydrogen, —F, —Cl, —CN, —NH₂, —OH, —NO₂, —CH₂OH, —CH₂CH₂OH, —OCF₃, —OCH₂CF₃, —OCH₃, and —OCH₂CH₃. In yet a further aspect, R⁶ is selected from hydrogen, —F, —Cl, —CN, —NH₂, —OH, —NO₂, —CH₂OH, —OCF₃, and —OCH₃.

In various aspects, R⁶ is selected from hydrogen, halogen, —CN, —NH₂, —OH, —NO₂, C1-C4 alkylamino, (C1-C4)(C1-C4) dialkylamino, and C1-C4 aminoalkyl. In a further aspect, R⁶ is selected from hydrogen, —F, —Cl, —CN, —NH₂, —OH, —NO₂, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R⁶ is selected from hydrogen, —F, —Cl, —CN, —NH₂, —OH, —NO₂, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R⁶ is selected from hydrogen, —F, —Cl, —CN, —NH₂, —OH, —NO₂, —NHCH₃, —N(CH₃)₂, and —CH₂NH₂.

In a further aspect, R⁶ is selected from hydrogen and C1-C4 alkyl. In a still further aspect, R⁶ is selected from hydrogen, methyl, ethyl, n-propyl, and isopropyl. In yet a further aspect, R⁶ is selected from hydrogen, methyl, and ethyl. In an even further aspect, R⁶ is selected from hydrogen and ethyl. In a still further aspect, R⁶ is selected from hydrogen and methyl.

In a further aspect, R⁶ is selected from hydrogen and halogen. In a still further aspect, R⁶ is selected from hydrogen, —F, —Cl, and —Br. In yet a further aspect, R⁶ is selected from hydrogen, —F, and —Cl. In an even further aspect, R⁶ is selected from hydrogen and —Cl. In a still further aspect, R⁶ is selected from hydrogen and —F.

In a further aspect, R⁶ is hydrogen.

k. R^{7A} AND R^{7B} Groups

In one aspect, each of R^{7a} and R^{7b} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, and —B(R²⁰)₃X, provided that exactly one of R^{7a} and R^{7b} is —B(R²⁰)₃X.

In various aspects, R^{7a} is —B(R²⁰)₃X.

In various aspects, R^{7b} is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, R^{7b} is selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R^{7b} is selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R^{7b} is selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In various aspects, R^{7b} is selected from hydrogen, halogen, —CN, —NH₂, —OH, —NO₂, C1-C4 alkyl, and C2-C4 alkenyl. In a further aspect, R^{7b} is selected from hydrogen, —F, —Cl, —CN, —NH₂, —OH, —NO₂, methyl, ethyl, n-propyl, isopropyl, ethenyl, n-propenyl, and isopropenyl. In a still further aspect, R^{7b} is selected from hydrogen, —F, —Cl, —CN, —NH₂, —OH, —NO₂, methyl, ethyl, and ethenyl. In yet a further aspect, R^{7b} is selected from hydrogen, —F, —Cl, —CN, —NH₂, —OH, —NO₂, and methyl.

In various aspects, R^{7b} is selected from hydrogen, halogen, —CN, —NH₂, —OH, —NO₂, C1-C4 haloalkyl, and C1-C4 cyanoalkyl. In a further aspect, R^{7b} is selected from hydrogen, —F, —Cl, —CN, —NH₂, —OH, —NO₂, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, and —CH(CH₃)CH₂CN. In a still further aspect, R^{7b} is selected from hydrogen, —F, —Cl, —CN, —NH₂, —OH, —NO₂, —CH₂F, —CH₂Cl, —CH₂CH₂F, —CH₂CH₂Cl, —CH₂CN, and —CH₂CH₂CN. In yet a further aspect, R^{7b} is selected from hydrogen, —F, —Cl, —CN, —NH₂, —OH, —NO₂, —CH₂F, —CH₂Cl, and —CH₂CN.

In various aspects, R^{7b} is selected from hydrogen, halogen, —CN, —NH₂, —OH, —NO₂, C1-C4 hydroxyalkyl, C1-C4 haloalkoxy, and C1-C4 alkoxy. In a further aspect, R^{7b} is selected from hydrogen, —F, —Cl, —CN, —NH₂, —OH, —NO₂, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, and —OCH(CH₃)CH₃. In a still further aspect, R^{7b} is selected from hydrogen, —F, —Cl, —CN, —NH₂, —OH, —NO₂, —CH₂OH, —CH₂CH₂OH, —OCF₃, —OCH₂CF₃, —OCH₃, and —OCH₂CH₃. In yet a further aspect, R^{7b} is selected from hydrogen, —F, —Cl, —CN, —NH₂, —OH, —NO₂, —CH₂OH, —OCF₃, and —OCH₃.

In various aspects, R^{7b} is selected from hydrogen, halogen, —CN, —NH₂, —OH, —NO₂, C1-C4 alkylamino, (C1-C4)(C1-C4) dialkylamino, and C1-C4 aminoalkyl. In a further aspect, R^{7b} is selected from hydrogen, —F, —Cl, —CN, —NH₂, —OH, —NO₂, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R^{7b} is selected from hydrogen, —F, —Cl, —CN, —NH₂, —OH, —NO₂, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R^{7b} is selected from hydrogen, —F, —Cl, —CN, —NH₂, —OH, —NO₂, —NHCH₃, —N(CH₃)₂, and —CH₂NH₂.

In a further aspect, R^{7b} is selected from hydrogen and C1-C4 alkyl. In a still further aspect, R^{7b} is selected from hydrogen, methyl, ethyl, n-propyl, and isopropyl. In yet a further aspect, R^{7b} is selected from hydrogen, methyl, and ethyl. In an even further aspect, R^{7b} is selected from hydrogen and ethyl. In a still further aspect, R^{7b} is selected from hydrogen and methyl.

In a further aspect, R^{7b} is selected from hydrogen and halogen. In a still further aspect, R^{7b} is selected from hydrogen, —F, —Cl, and —Br. In yet a further aspect, R^{7b} is selected from hydrogen, —F, and —Cl. In an even further aspect, R^{7b} is selected from hydrogen and —Cl. In a still further aspect, R^{7b} is selected from hydrogen and —F.

In a further aspect, R^{7b} is hydrogen.

In various aspects, R^{7b} is —B(R²⁰)₃X.

In various aspects, R^{7a} is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, R^{7a} is selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R^{7a} is selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R^{7a} is selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In various aspects, R^{7a} is selected from hydrogen, halogen, —CN, —NH₂, —OH, —NO₂, C1-C4 alkyl, and C2-C4 alkenyl. In a further aspect, R^{7a} is selected from hydrogen, —F, —Cl, —CN, —NH₂, —OH, —NO₂, methyl, ethyl, n-propyl, isopropyl, ethenyl, n-propenyl, and isopropenyl. In a still further aspect, R^{7a} is selected from hydrogen, —F, —Cl, —CN, —NH₂, —OH, —NO₂, methyl, ethyl, and ethenyl. In yet a further aspect, R^{7a} is selected from hydrogen, —F, —Cl, —CN, —NH₂, —OH, —NO₂, and methyl.

In various aspects, R^{7a} is selected from hydrogen, halogen, —CN, —NH₂, —OH, —NO₂, C1-C4 haloalkyl, and C1-C4 cyanoalkyl. In a further aspect, R^{7a} is selected from hydrogen, —F, —Cl, —CN, —NH₂, —OH, —NO₂, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, and —CH(CH₃)CH₂CN. In a still further aspect, R^{7a} is selected from hydrogen, —F, —Cl, —CN, —NH₂, —OH, —NO₂, —CH₂F, —CH₂Cl, —CH₂CH₂F, —CH₂CH₂Cl, —CH₂CN, and —CH₂CH₂CN. In yet a further aspect, R^{7a} is selected from hydrogen, —F, —Cl, —CN, —NH₂, —OH, —NO₂, —CH₂F, —CH₂Cl, and —CH₂CN.

In various aspects, R^{7a} is selected from hydrogen, halogen, —CN, —NH₂, —OH, —NO₂, C1-C4 hydroxyalkyl, C1-C4 haloalkoxy, and C1-C4 alkoxy. In a further aspect, R^{7a} is selected from hydrogen, —F, —Cl, —CN, —NH₂, —OH, —NO₂, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, and —OCH(CH₃)CH₃. In a still further aspect, R^{7a} is selected from hydrogen, —F, —Cl, —CN, —NH₂, —OH, —NO₂, —CH₂OH, —CH₂CH₂OH, —OCF₃, —OCH₂CF₃, —OCH₃, and —OCH₂CH₃. In yet a further aspect, R^{7a} is selected from hydrogen, —F, —Cl, —CN, —NH₂, —OH, —NO₂, —CH₂OH, —OCF₃, and —OCH₃.

In various aspects, R^{7a} is selected from hydrogen, halogen, —CN, —NH₂, —OH, —NO₂, C1-C4 alkylamino, (C1-C4)(C1-C4) dialkylamino, and C1-C4 aminoalkyl. In a further aspect, R^{7a} is selected from hydrogen, —F, —Cl, —CN, —NH₂, —OH, —NO₂, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R^{7a} is selected from hydrogen, —F, —Cl, —CN, —NH₂, —OH, —NO₂, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R^{7a} is selected from hydrogen, —F, —Cl, —CN, —NH₂, —OH, —NO₂, —NHCH₃, —N(CH₃)₂, and —CH₂NH₂.

In a further aspect, R^{7a} is selected from hydrogen and C1-C4 alkyl. In a still further aspect, R^{7a} is selected from hydrogen, methyl, ethyl, n-propyl, and isopropyl. In yet a further aspect, R^{7a} is selected from hydrogen, methyl, and ethyl. In an even further aspect, R^{7a} is selected from hydrogen and ethyl. In a still further aspect, R^{7a} is selected from hydrogen and methyl.

In a further aspect, R^{7a} is selected from hydrogen and halogen. In a still further aspect, R^{7b} is selected from hydrogen, —F, —Cl, and —Br. In yet a further aspect, R^{7a} is selected from hydrogen, —F, and —Cl. In an even further aspect, R^{7a} is selected from hydrogen and —Cl. In a still further aspect, R^{7a} is selected from hydrogen and —F.

In a further aspect, R^{7a} is hydrogen.

l. R¹⁰ Groups

In one aspect, each occurrence of R¹⁰, when present, is independently selected from hydrogen and C1-C8 alkyl. In a further aspect, each occurrence of R¹⁰, when present, is independently selected from hydrogen and C1-C4 alkyl. In a still further aspect, each occurrence of R¹⁰, when present, is independently selected from hydrogen, methyl, ethyl, n-propyl, and isopropyl. In yet a further aspect, each occurrence of R¹⁰, when present, is independently selected from hydrogen, methyl, and ethyl. In an even further aspect, each occurrence of R¹⁰, when present, is independently selected from hydrogen and ethyl. In a still further aspect, each occurrence of R¹⁰, when present, is independently selected from hydrogen and methyl.

In various aspects, each occurrence of R¹⁰, when present, is C1-C8 alkyl. In a further aspect, each occurrence of R¹⁰, when present, is C1-C4 alkyl. In a still further aspect, each occurrence of R¹⁰, when present, is independently selected from methyl, ethyl, n-propyl, and isopropyl. In yet a further aspect, each occurrence of R¹⁰, when present, is independently selected from methyl and ethyl. In an even further aspect, each occurrence of R¹⁰, when present, is ethyl. In a still further aspect, each occurrence of R¹⁰, when present, is methyl.

In various aspects, each occurrence of R¹⁰, when present, is hydrogen.

m. R¹¹ Groups

In one aspect, each occurrence of R¹¹, when present, is independently halogen. In a further aspect, each occurrence of R¹¹, when present, is independently selected from —F, —Cl, and —Br. In a still further aspect, each occurrence of R¹¹, when present, is independently selected from —F and —Cl. In yet a further aspect, each occurrence of R¹¹, when present, is independently selected from —F and —Br. In an even further aspect, each occurrence of R¹¹, when present, is independently selected from —Cl and —Br. In a still further aspect, each occurrence of R^{D}, when present, is —I. In yet a further aspect, each occurrence of R^{D}, when present, is —Br. In an even further aspect, each occurrence of R¹¹, when present, is —Cl. In a still further aspect, each occurrence of R¹¹, when present, is —F.

n. R¹² Groups

In one aspect, each occurrence of R¹², when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups. In a further aspect, each occurrence of R¹², when present, is covalently bonded together, and, together with the intermediate atoms, comprise a C6 bicyclic heterocycle or a C2-C3 heterocycloalkyl, and is substituted with 0, 1, 2, or 3 C1-C4 alkyl groups. In yet a further aspect, each occurrence of R¹², when present, is covalently bonded together, and, together with the intermediate atoms, comprise a C6 bicyclic heterocycle or a C2-C3 heterocycloalkyl, and is substituted with 0, 1, or 2 C1-C4 alkyl groups. In an even further aspect, each occurrence of R¹², when present, is covalently bonded together, and, together with the intermediate atoms, comprise a C6 bicyclic heterocycle or a C2-C3 heterocycloalkyl, and is substituted with 0 or 1 C1-C4 alkyl groups. In a still further aspect, each occurrence of R¹², when present, is covalently bonded together, and, together with the intermediate atoms, comprise a C6 bicyclic heterocycle or a C2-C3 heterocycloalkyl, and is monosubstituted with a C1-C4 alkyl group. In yet a further aspect, each occurrence of R¹², when present, is covalently bonded together, and, together with the intermediate atoms, comprise a C6 bicyclic heterocycle or a C2-C3 heterocycloalkyl, and is unsubstituted.

In a further aspect, each occurrence of R¹², when present, is covalently bonded together, and, together with the intermediate atoms, comprise a C6 bicyclic heterocycle substituted with 0, 1, 2, 3, or 4 C1-C4 alkyl groups. In a still further aspect, each occurrence of R¹², when present, is covalently bonded together, and, together with the intermediate atoms, comprise a C6 bicyclic heterocycle substituted with 0, 1, 2, or 3 C1-C4 alkyl groups. In yet a further aspect, each occurrence of R¹², when present, is covalently bonded together, and, together with the intermediate atoms, comprise a C6 bicyclic heterocycle substituted with 0, 1, or 2 C1-C4 alkyl groups. In an even further aspect, each occurrence of R¹², when present, is covalently bonded together, and, together with the intermediate atoms, comprise a C6 bicyclic heterocycle substituted with 0 or 1 C1-C4 alkyl groups. In a still further aspect, each occurrence of R¹², when present, is covalently bonded together, and, together with the intermediate atoms, comprise a C6 bicyclic heterocycle monosubstituted with a C1-C4 alkyl group. In yet a further aspect, each occurrence of R¹², when present, is covalently bonded together, and, together with the intermediate atoms, comprise an unsubstituted C6 bicyclic heterocycle.

In a further aspect, each occurrence of R¹², when present, is covalently bonded together, and, together with the intermediate atoms, comprise a C6 bicyclic heterocycle substituted with 4 C1-C4 alkyl groups. In a still further aspect, each occurrence of R¹², when present, is covalently bonded together, and, together with the intermediate atoms, comprise a C6 bicyclic heterocycle substituted with 4 groups selected from methyl, ethyl, n-propyl, and isopropyl. In yet a further aspect, each occurrence of R¹², when present, is covalently bonded together, and, together with the intermediate atoms, comprise a C6 bicyclic heterocycle substituted with 4 groups selected from methyl and ethyl. In an even further aspect, each occurrence of R¹², when present, is covalently bonded together, and, together with the intermediate atoms, comprise a C6 bicyclic heterocycle substituted with 4 methyl groups.

In a further aspect, each occurrence of R¹², when present, is covalently bonded together, and, together with the intermediate atoms, comprise a C2-C3 heterocycloalkyl substituted with 0, 1, 2, 3, or 4 C1-C4 alkyl groups. In a still further aspect, each occurrence of R¹², when present, is covalently bonded together, and, together with the intermediate atoms, comprise a C2-C3 heterocycloalkyl substituted with 0, 1, 2, or 3 C1-C4 alkyl groups. In yet a further aspect, each occurrence of R¹², when present, is covalently bonded together, and, together with the intermediate atoms, comprise a C2-C3 heterocycloalkyl substituted with 0, 1, or 2 C1-C4 alkyl groups. In an even further aspect, each occurrence of R¹², when present, is covalently bonded together, and, together with the intermediate atoms, comprise a C2-C3 heterocycloalkyl substituted with 0 or 1 C1-C4 alkyl groups. In a still further aspect, each occurrence of R¹², when present, is covalently bonded together, and, together with the intermediate atoms, comprise a C2-C3 heterocycloalkyl monosubstituted with a C1-C4 alkyl group. In yet a further aspect, each occurrence of R¹², when present, is covalently bonded together, and, together with the intermediate atoms, comprise an unsubstituted C2-C3 heterocycloalkyl.

In a further aspect, each occurrence of R¹², when present, is covalently bonded together, and, together with the intermediate atoms, comprise a C2-C3 heterocycloalkyl substituted with 4 C1-C4 alkyl groups. In a still further aspect, each occurrence of R¹², when present, is covalently bonded together, and, together with the intermediate atoms, comprise a C2-C3 heterocycloalkyl substituted with 4 groups selected from methyl, ethyl, n-propyl, and isopropyl. In yet a further aspect, each occurrence of R¹², when present, is covalently bonded together, and, together with the intermediate atoms, comprise a C2-C3 heterocycloalkyl substituted with 4 groups selected from methyl and ethyl. In an even further aspect, each occurrence of R¹², when present, is covalently bonded together, and, together with the intermediate atoms, comprise a C2-C3 heterocycloalkyl substituted with 4 methyl groups.

o. R¹³ Groups

In one aspect, each occurrence of R¹³, when present, is independently selected from hydrogen and C1-C8 alkyl. In a further aspect, each occurrence of R¹³, when present, is independently selected from hydrogen and C1-C4 alkyl. In a still further aspect, each occurrence of R¹³, when present, is independently selected from hydrogen, methyl, ethyl, n-propyl, and isopropyl. In yet a further aspect, each occurrence of R¹³, when present, is independently selected from hydrogen, methyl, and ethyl. In an even further aspect, each occurrence of R¹³, when present, is independently selected from hydrogen and ethyl. In a still further aspect, each occurrence of R¹³, when present, is independently selected from hydrogen and methyl.

In various aspects, each occurrence of R¹³, when present, is C1-C8 alkyl. In a further aspect, each occurrence of R¹³, when present, is C1-C4 alkyl. In a still further aspect, each occurrence of R¹³, when present, is independently selected from methyl, ethyl, n-propyl, and isopropyl. In yet a further aspect, each occurrence of R¹³, when present, is independently selected from methyl and ethyl. In an even further aspect, each occurrence of R¹³, when present, is ethyl. In a still further aspect, each occurrence of R¹³, when present, is methyl.

In various aspects, each occurrence of R¹³, when present, is hydrogen.

p. R⁴ Groups

In one aspect, each occurrence of R¹⁴, when present, is independently halogen. In a further aspect, each occurrence of R¹⁴, when present, is independently selected from —F, —Cl, and —Br. In a still further aspect, each occurrence of R¹⁴, when present, is independently selected from —F and —Cl. In yet a further aspect, each occurrence of R¹⁴, when present, is independently selected from —F and —Br. In an even further aspect, each occurrence of R¹⁴, when present, is independently selected from —Cl and —Br. In a still further aspect, each occurrence of R¹⁴, when present, is —I. In yet a further aspect, each occurrence of R¹⁴, when present, is —Br. In an even further aspect, each occurrence of R¹⁴, when present, is —Cl. In a still further aspect, each occurrence of R¹⁴, when present, is —F.

q. R¹⁵ Groups

In one aspect, each occurrence of R¹⁵, when present, is independently selected from hydrogen and C1-C8 alkyl, or each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups.

In various aspects, each occurrence of R¹⁵, when present, is independently selected from hydrogen and C1-C8 alkyl. In a further aspect, each occurrence of R¹⁵, when present, is independently selected from hydrogen and C1-C4 alkyl. In a still further aspect, each occurrence of R¹⁵, when present, is independently selected from hydrogen, methyl, ethyl, n-propyl, and isopropyl. In yet a further aspect, each occurrence of R¹⁵, when present, is independently selected from hydrogen, methyl, and ethyl. In an even further aspect, each occurrence of R¹⁵, when present, is independently selected from hydrogen and ethyl. In a still further aspect, each occurrence of R¹⁵, when present, is independently selected from hydrogen and methyl.

In various aspects, each occurrence of R¹⁵, when present, is C1-C8 alkyl. In a further aspect, each occurrence of R¹⁵, when present, is C1-C4 alkyl. In a still further aspect, each occurrence of R¹⁵, when present, is independently selected from methyl, ethyl, n-propyl, and isopropyl. In yet a further aspect, each occurrence of R¹⁵, when present, is independently selected from methyl and ethyl. In an even further aspect, each occurrence of R¹⁵, when present, is ethyl. In a still further aspect, each occurrence of R¹⁵, when present, is methyl.

In various aspects, each occurrence of R, when present, is hydrogen.

In various aspects, each occurrence of R, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups. In a further aspect, each occurrence of R¹⁵, when present, is covalently bonded together, and, together with the intermediate atoms, comprise a C6 bicyclic heterocycle or a C2-C3 heterocycloalkyl, and is substituted with 0, 1, 2, or 3 C1-C4 alkyl groups. In yet a further aspect, each occurrence of R¹⁵, when present, is covalently bonded together, and, together with the intermediate atoms, comprise a C6 bicyclic heterocycle or a C2-C3 heterocycloalkyl, and is substituted with 0, 1, or 2 C1-C4 alkyl groups. In an even further aspect, each occurrence of v when present, is covalently bonded together, and, together with the intermediate atoms, comprise a C6 bicyclic heterocycle or a C2-C3 heterocycloalkyl, and is substituted with 0 or 1 C1-C4 alkyl groups. In a still further aspect, each occurrence of R¹⁵, when present, is covalently bonded together, and, together with the intermediate atoms, comprise a C6 bicyclic heterocycle or a C2-C3 heterocycloalkyl, and is monosubstituted with a C1-C4 alkyl group. In yet a further aspect, each occurrence of R¹⁵, when present, is covalently bonded together, and, together with the intermediate atoms, comprise a C6 bicyclic heterocycle or a C2-C3 heterocycloalkyl, and is unsubstituted.

In a further aspect, each occurrence of R¹⁵, when present, is covalently bonded together, and, together with the intermediate atoms, comprise a C6 bicyclic heterocycle substituted with 0, 1, 2, 3, or 4 C1-C4 alkyl groups. In a still further aspect, each occurrence of R¹⁵, when present, is covalently bonded together, and, together with the intermediate atoms, comprise a C6 bicyclic heterocycle substituted with 0, 1, 2, or 3 C1-C4 alkyl groups. In yet a further aspect, each occurrence of R¹⁵, when present, is covalently bonded together, and, together with the intermediate atoms, comprise a C6 bicyclic heterocycle substituted with 0, 1, or 2 C1-C4 alkyl groups. In an even further aspect, each occurrence of R¹⁵, when present, is covalently bonded together, and, together with the intermediate atoms, comprise a C6 bicyclic heterocycle substituted with 0 or 1 C1-C4 alkyl groups. In a still further aspect, each occurrence of R¹⁵, when present, is covalently bonded together, and, together with the intermediate atoms, comprise a C6 bicyclic heterocycle monosubstituted with a C1-C4 alkyl group. In yet a further aspect, each occurrence of R¹⁵, when present, is covalently bonded together, and, together with the intermediate atoms, comprise an unsubstituted C6 bicyclic heterocycle.

In a further aspect, each occurrence of R¹⁵, when present, is covalently bonded together, and, together with the intermediate atoms, comprise a C6 bicyclic heterocycle substituted with 4 C1-C4 alkyl groups. In a still further aspect, each occurrence of R¹⁵, when present, is covalently bonded together, and, together with the intermediate atoms, comprise a C6 bicyclic heterocycle substituted with 4 groups selected from methyl, ethyl, n-propyl, and isopropyl. In yet a further aspect, each occurrence of R¹⁵, when present, is covalently bonded together, and, together with the intermediate atoms, comprise a C6 bicyclic heterocycle substituted with 4 groups selected from methyl and ethyl. In an even further aspect, each occurrence of R¹⁵, when present, is covalently bonded together, and, together with the intermediate atoms, comprise a C6 bicyclic heterocycle substituted with 4 methyl groups.

In a further aspect, each occurrence of R¹⁵, when present, is covalently bonded together, and, together with the intermediate atoms, comprise a C2-C3 heterocycloalkyl substituted with 0, 1, 2, 3, or 4 C1-C4 alkyl groups. In a still further aspect, each occurrence of R¹⁵, when present, is covalently bonded together, and, together with the intermediate atoms, comprise a C2-C3 heterocycloalkyl substituted with 0, 1, 2, or 3 C1-C4 alkyl groups. In yet a further aspect, each occurrence of R¹⁵, when present, is covalently bonded together, and, together with the intermediate atoms, comprise a C2-C3 heterocycloalkyl substituted with 0, 1, or 2 C1-C4 alkyl groups. In an even further aspect, each occurrence of R¹⁵, when present, is covalently bonded together, and, together with the intermediate atoms, comprise a C2-C3 heterocycloalkyl substituted with 0 or 1 C1-C4 alkyl groups. In a still further aspect, each occurrence of R¹⁵, when present, is covalently bonded together, and, together with the intermediate atoms, comprise a C2-C3 heterocycloalkyl monosubstituted with a C1-C4 alkyl group. In yet a further aspect, each occurrence of R¹⁵, when present, is covalently bonded together, and, together with the intermediate atoms, comprise an unsubstituted C2-C3 heterocycloalkyl.

In a further aspect, each occurrence of R¹⁵, when present, is covalently bonded together, and, together with the intermediate atoms, comprise a C2-C3 heterocycloalkyl substituted with 4 C1-C4 alkyl groups. In a still further aspect, each occurrence of R¹⁵, when present, is covalently bonded together, and, together with the intermediate atoms, comprise a C2-C3 heterocycloalkyl substituted with 4 groups selected from methyl, ethyl, n-propyl, and isopropyl. In yet a further aspect, each occurrence of R¹⁵, when present, is covalently bonded together, and, together with the intermediate atoms, comprise a C2-C3 heterocycloalkyl substituted with 4 groups selected from methyl and ethyl. In an even further aspect, each occurrence of R¹⁵, when present, is covalently bonded together, and, together with the intermediate atoms, comprise a C2-C3 heterocycloalkyl substituted with 4 methyl groups.

r. R¹⁶ Groups

In one aspect, each occurrence of R¹⁶, when present, is independently halogen. In a further aspect, each occurrence of R¹⁶, when present, is independently selected from —F, —Cl, and —Br. In a still further aspect, each occurrence of R¹⁶, when present, is independently selected from —F and —Cl. In yet a further aspect, each occurrence of R¹⁶, when present, is independently selected from —F and —Br. In an even further aspect, each occurrence of R¹⁶, when present, is independently selected from —Cl and —Br. In a still further aspect, each occurrence of R¹⁶, when present, is —I. In yet a further aspect, each occurrence of R¹⁶, when present, is —Br. In an even further aspect, each occurrence of R¹⁶, when present, is —Cl. In a still further aspect, each occurrence of R¹⁶, when present, is —F.

s. R¹⁷ Groups

In one aspect, R¹⁷, when present, is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, R¹⁷, when present, is selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R¹⁷, when present, is selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R¹⁷, when present, is selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In various aspects, R¹⁷, when present, is selected from hydrogen, halogen, —CN, —NH₂, —OH, —NO₂, C1-C4 alkyl, and C2-C4 alkenyl. In a further aspect, R¹⁷, when present, is selected from hydrogen, —F, —Cl, —CN, —NH₂, —OH, —NO₂, methyl, ethyl, n-propyl, isopropyl, ethenyl, n-propenyl, and isopropenyl. In a still further aspect, R¹⁷, when present, is selected from hydrogen, —F, —Cl, —CN, —NH₂, —OH, —NO₂, methyl, ethyl, and ethenyl. In yet a further aspect, R¹⁷, when present, is selected from hydrogen, —F, —Cl, —CN, —NH₂, —OH, —NO₂, and methyl.

In various aspects, R¹⁷, when present, is selected from hydrogen, halogen, —CN, —NH₂, —OH, —NO₂, C1-C4 haloalkyl, and C1-C4 cyanoalkyl. In a further aspect, R¹⁷, when present, is selected from hydrogen, —F, —Cl, —CN, —NH₂, —OH, —NO₂, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, and —CH(CH₃)CH₂CN. In a still further aspect, R¹⁷, when present, is selected from hydrogen, —F, —Cl, —CN, —NH₂, —OH, —NO₂, —CH₂F, —CH₂Cl, —CH₂CH₂F, —CH₂CH₂Cl, —CH₂CN, and —CH₂CH₂CN. In yet a further aspect, R¹⁷, when present, is selected from hydrogen, —F, —Cl, —CN, —NH₂, —OH, —NO₂, —CH₂F, —CH₂Cl, and —CH₂CN.

In various aspects, R¹⁷, when present, is selected from hydrogen, halogen, —CN, —NH₂, —OH, —NO₂, C1-C4 hydroxyalkyl, C1-C4 haloalkoxy, and C1-C4 alkoxy. In a further aspect, R¹⁷, when present, is selected from hydrogen, —F, —Cl, —CN, —NH₂, —OH, —NO₂, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, and —OCH(CH₃)CH₃. In a still further aspect, R¹⁷, when present, is selected from hydrogen, —F, —Cl, —CN, —NH₂, —OH, —NO₂, —CH₂OH, —CH₂CH₂OH, —OCF₃, —OCH₂CF₃, —OCH₃, and —OCH₂CH₃. In yet a further aspect, R¹⁷, when present, is selected from hydrogen, —F, —Cl, —CN, —NH₂, —OH, —NO₂, —CH₂OH, —OCF₃, and —OCH₃.

In various aspects, R¹⁷, when present, is selected from hydrogen, halogen, —CN, —NH₂, —OH, —NO₂, C1-C4 alkylamino, (C1-C4)(C1-C4) dialkylamino, and C1-C4 aminoalkyl. In a further aspect, R¹⁷, when present, is selected from hydrogen, —F, —Cl, —CN, —NH₂, —OH, —NO₂, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R¹⁷, when present, is selected from hydrogen, —F, —Cl, —CN, —NH₂, —OH, —NO₂, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R¹⁷, when present, is selected from hydrogen, —F, —Cl, —CN, —NH₂, —OH, —NO₂, —NHCH₃, —N(CH₃)₂, and —CH₂NH₂.

In a further aspect, R¹⁷, when present, is selected from hydrogen and C1-C4 alkyl. In a still further aspect, R¹⁷, when present, is selected from hydrogen, methyl, ethyl, n-propyl, and isopropyl. In yet a further aspect, R¹⁷, when present, is selected from hydrogen, methyl, and ethyl. In an even further aspect, R¹⁷, when present, is selected from hydrogen and ethyl. In a still further aspect, R¹⁷, when present, is selected from hydrogen and methyl.

In a further aspect, R¹⁷, when present, is selected from hydrogen and halogen. In a still further aspect, R¹⁷, when present, is selected from hydrogen, —F, —Cl, and —Br. In yet a further aspect, R¹⁷, when present, is selected from hydrogen, —F, and —Cl. In an even further aspect, R¹⁷, when present, is selected from hydrogen and —Cl. In a still further aspect, R¹⁷, when present, is selected from hydrogen and —F.

In a further aspect, R¹⁷, when present, is hydrogen.

t. R¹⁸ Groups

In one aspect, R¹⁸, when present, is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, R¹⁸, when present, is selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R¹⁸, when present, is selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R¹⁸, when present, is selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In various aspects, R¹⁸, when present, is selected from hydrogen, halogen, —CN, —NH₂, —OH, —NO₂, C1-C4 alkyl, and C2-C4 alkenyl. In a further aspect, R¹⁸, when present, is selected from hydrogen, —F, —Cl, —CN, —NH₂, —OH, —NO₂, methyl, ethyl, n-propyl, isopropyl, ethenyl, n-propenyl, and isopropenyl. In a still further aspect, R¹⁸, when present, is selected from hydrogen, —F, —Cl, —CN, —NH₂, —OH, —NO₂, methyl, ethyl, and ethenyl. In yet a further aspect, R¹⁸, when present, is selected from hydrogen, —F, —Cl, —CN, —NH₂, —OH, —NO₂, and methyl.

In various aspects, R¹⁸, when present, is selected from hydrogen, halogen, —CN, —NH₂, —OH, —NO₂, C1-C4 haloalkyl, and C1-C4 cyanoalkyl. In a further aspect, R R¹⁸, when present, is selected from hydrogen, —F, —Cl, —CN, —NH₂, —OH, —NO₂, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, and —CH(CH₃)CH₂CN. In a still further aspect, R¹⁸, when present, is selected from hydrogen, —F, —Cl, —CN, —NH₂, —OH, —NO₂, —CH₂F, —CH₂Cl, —CH₂CH₂F, —CH₂CH₂Cl, —CH₂CN, and —CH₂CH₂CN. In yet a further aspect, R¹⁸, when present, is selected from hydrogen, —F, —Cl, —CN, —NH₂, —OH, —NO₂, —CH₂F, —CH₂Cl, and —CH₂CN.

In various aspects, R¹⁸, when present, is selected from hydrogen, halogen, —CN, —NH₂, —OH, —NO₂, C1-C4 hydroxyalkyl, C1-C4 haloalkoxy, and C1-C4 alkoxy. In a further aspect, R¹⁸, when present, is selected from hydrogen, —F, —Cl, —CN, —NH₂, —OH, —NO₂, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, and —OCH(CH₃)CH₃. In a still further aspect, R¹⁸, when present, is selected from hydrogen, —F, —Cl, —CN, —NH₂, —OH, —NO₂, —CH₂OH, —CH₂CH₂OH, —OCF₃, —OCH₂CF₃, —OCH₃, and —OCH₂CH₃. In yet a further aspect, R¹⁸, when present, is selected from hydrogen, —F, —Cl, —CN, —NH₂, —OH, —NO₂, —CH₂OH, —OCF₃, and —OCH₃.

In various aspects, R¹⁸, when present, is selected from hydrogen, halogen, —CN, —NH₂, —OH, —NO₂, C1-C4 alkylamino, (C1-C4)(C1-C4) dialkylamino, and C1-C4 aminoalkyl. In a further aspect, R¹⁸, when present, is selected from hydrogen, —F, —Cl, —CN, —NH₂, —OH, —NO₂, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, R¹⁸, when present, is selected from hydrogen, —F, —Cl, —CN, —NH₂, —OH, —NO₂, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, R¹⁸, when present, is selected from hydrogen, —F, —Cl, —CN, —NH₂, —OH, —NO₂, —NHCH₃, —N(CH₃)₂, and —CH₂NH₂.

In a further aspect, R¹⁸, when present, is selected from hydrogen and C1-C4 alkyl. In a still further aspect, R¹⁸, when present, is selected from hydrogen, methyl, ethyl, n-propyl, and isopropyl. In yet a further aspect, R¹⁸, when present, is selected from hydrogen, methyl, and ethyl. In an even further aspect, R¹⁸, when present, is selected from hydrogen and ethyl. In a still further aspect, R¹⁸, when present, is selected from hydrogen and methyl.

In a further aspect, R¹⁸, when present, is selected from hydrogen and halogen. In a still further aspect, R¹⁸, when present, is selected from hydrogen, —F, —Cl, and —Br. In yet a further aspect, R¹⁸, when present, is selected from hydrogen, —F, and —Cl. In an even further aspect, R¹⁸, when present, is selected from hydrogen and —Cl. In a still further aspect, R¹⁸, when present, is selected from hydrogen and —F.

In a further aspect, R¹⁸, when present, is hydrogen.

u. R¹⁹ Groups

In one aspect, R¹⁹, when present, is selected from hydrogen and C1-C4 alkyl. In a further aspect, R¹⁹, when present, is selected from hydrogen, methyl, ethyl, n-propyl, and isopropyl. In a still further aspect, R¹⁹, when present, is selected from hydrogen, methyl, and ethyl. In yet a further aspect, R¹⁹, when preset, is selected from hydrogen and ethyl. In an even further aspect, R¹⁹, when preset, is selected from hydrogen and methyl.

In various aspects, R¹⁹, when present, is C1-C4 alkyl. In a further aspect, R¹⁹, when present, is selected from methyl, ethyl, n-propyl, and isopropyl. In a still further aspect, R¹⁹, when present, is selected from methyl and ethyl. In yet a further aspect, R¹⁹, when preset, is ethyl. In an even further aspect, R¹⁹, when preset, is methyl.

In various aspects, R¹⁹, when present, is hydrogen.

v. R²⁰ Groups

In one aspect, each occurrence of R²⁰, when present, is independently halogen. In a further aspect, each occurrence of R²⁰, when present, is independently selected from —F, —Cl, and —Br. In a still further aspect, each occurrence of R²⁰, when present, is independently selected from —F and —Cl. In yet a further aspect, each occurrence of R²⁰, when present, is independently selected from —F and —Br. In an even further aspect, each occurrence of R²⁰, when present, is independently selected from —Cl and —Br. In a still further aspect, each occurrence of R²⁰, when present, is —I. In yet a further aspect, each occurrence of R²⁰, when present, is —Br. In an even further aspect, each occurrence of R²⁰, when present, is —Cl. In a still further aspect, each occurrence of R²⁰, when present, is —F.

w. AR¹ Groups

In one aspect, Ar¹ is a C2-C10 heteroaryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, Ar¹ is a C2-C10 heteroaryl substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar¹ is a C2-C10 heteroaryl substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1—C4 haloalkoxy, C1-C4 alkoxy, C1-C4 alkylamino, (C1-C4)(C1-C4) dialkylamino, and C1-C4 alkylamino. In yet a further aspect, Ar¹ is a C2-C10 heteroaryl monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar¹ is an unsubstituted C2-C10 heteroaryl.

In various aspects, Ar¹ is not a 6-membered heteroaryl.

In various aspects, Ar¹ is selected from furanyl, thiophenyl, pyrrolyl, benzo[d]thiazole, pyrazolyl, imidazolyl, triazolyl, oxazolyl, thiazolyl, pyridinyl, pyrimidinyl, imidazolyl, purinyl, indolyl, and quinolinyl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, Ar¹ is selected from furanyl, thiophenyl, pyrrolyl, benzo[d]thiazole, pyrazolyl, imidazolyl, triazolyl, oxazolyl, thiazolyl, pyridinyl, pyrimidinyl, imidazolyl, purinyl, indolyl, and quinolinyl, and is substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar¹ is selected from furanyl, thiophenyl, pyrrolyl, benzo[d]thiazole, pyrazolyl, imidazolyl, triazolyl, oxazolyl, thiazolyl, pyridinyl, pyrimidinyl, imidazolyl, purinyl, indolyl, and quinolinyl, and is substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar¹ is selected from furanyl, thiophenyl, pyrrolyl, benzo[d]thiazole, pyrazolyl, imidazolyl, triazolyl, oxazolyl, thiazolyl, pyridinyl, pyrimidinyl, imidazolyl, purinyl, indolyl, and quinolinyl, and is monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar¹ is selected from furanyl, thiophenyl, pyrrolyl, benzo[d]thiazole, pyrazolyl, imidazolyl, triazolyl, oxazolyl, thiazolyl, pyridinyl, pyrimidinyl, imidazolyl, purinyl, indolyl, and quinolinyl, and is unsubstituted.

In various aspects, Ar¹ is selected from furanyl, thiophenyl, pyrrolyl, benzo[d]thiazole, pyrazolyl, imidazolyl, triazolyl, oxazolyl, thiazolyl, pyrimidinyl, imidazolyl, purinyl, indolyl, and quinolinyl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, Ar¹ is selected from furanyl, thiophenyl, pyrrolyl, benzo[d]thiazole, pyrazolyl, imidazolyl, triazolyl, oxazolyl, thiazolyl, pyrimidinyl, imidazolyl, purinyl, indolyl, and quinolinyl, and is substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar¹ is selected from furanyl, thiophenyl, pyrrolyl, benzo[d]thiazole, pyrazolyl, imidazolyl, triazolyl, oxazolyl, thiazolyl, pyrimidinyl, imidazolyl, purinyl, indolyl, and quinolinyl, and is substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar¹ is selected from furanyl, thiophenyl, pyrrolyl, benzo[d]thiazole, pyrazolyl, imidazolyl, triazolyl, oxazolyl, thiazolyl, pyrimidinyl, imidazolyl, purinyl, indolyl, and quinolinyl, and is monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar¹ is selected from furanyl, thiophenyl, pyrrolyl, benzo[d]thiazole, pyrazolyl, imidazolyl, triazolyl, oxazolyl, thiazolyl, pyrimidinyl, imidazolyl, purinyl, indolyl, and quinolinyl, and is unsubstituted.

In various aspects, Ar¹ is selected from furanyl, thiophenyl, pyrrolyl, and thiazolyl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, Ar¹ is selected from furanyl, thiophenyl, pyrrolyl, and thiazolyl, and is substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar¹ is selected from furanyl, thiophenyl, pyrrolyl, and thiazolyl, and is substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar¹ is selected from furanyl, thiophenyl, pyrrolyl, and thiazolyl, and is monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar¹ is selected from furanyl, thiophenyl, pyrrolyl, and thiazolyl, and is unsubstituted.

### 2. Borylated Amidoxime Examples

In one aspect, a compound can be present as:

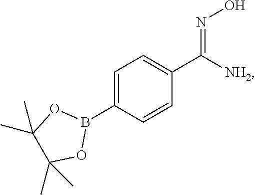 [SMILES: CC1(C)OB(c2ccc(/C(N)=N/O)cc2)OC1(C)C]

or a salt thereof.

In one aspect, a compound can be present as:

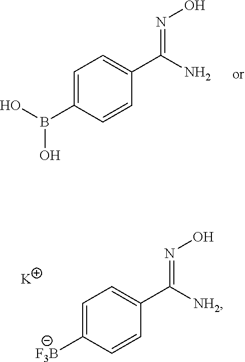

or a salt thereof.

In one aspect, a compound can be present as:

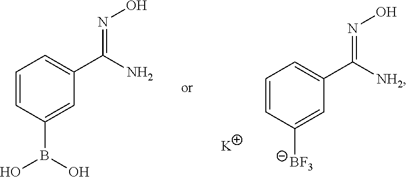

or a salt thereof.

In one aspect, a compound can be present as:

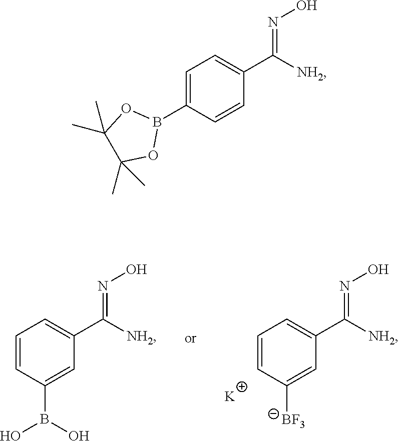

or a salt thereof

### 3. Prophetic Borylated Amidoximes

The following compound examples are prophetic, and can be prepared using the synthesis methods described herein above and other general methods as needed as would be known to one skilled in the art. It is anticipated that the prophetic compounds would be useful in the generation of boron-containing pharmacaphores, and such utility can be determined using the synthetic methods described herein below.

In one aspect, a compound can be selected from:

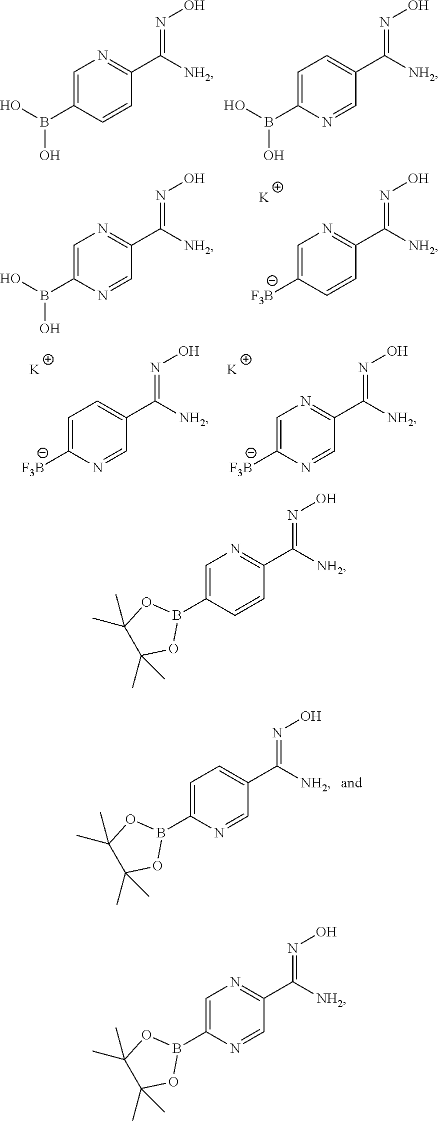

or a salt thereof.

In one aspect, a compound can be selected from:

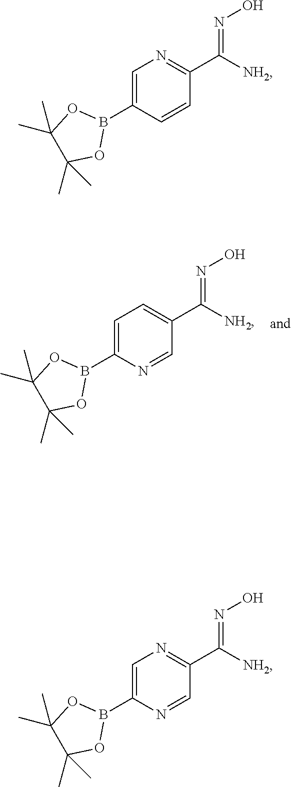 [SMILES: CC1(C)OB(c2ccc(/C(N)=N/O)nc2)OC1(C)C ; CC1(C)OB(c2ccc(/C(N)=N/O)cn2)OC1(C)C ; CC1(C)OB(c2cnc(/C(N)=N/O)cn2)OC1(C)C]

or a salt thereof.

In one aspect, a compound can be selected from:

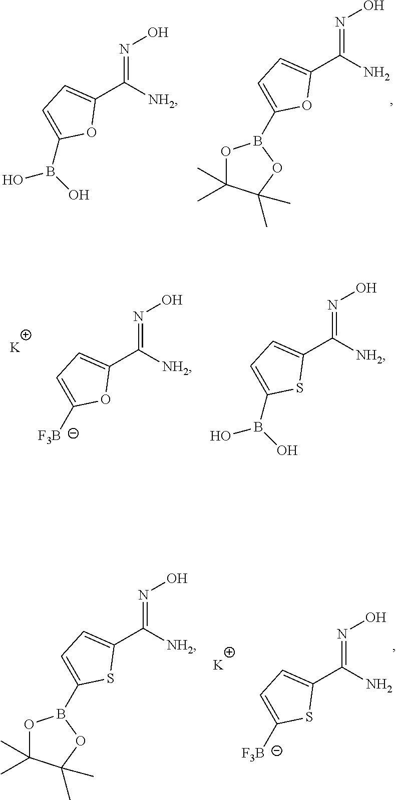

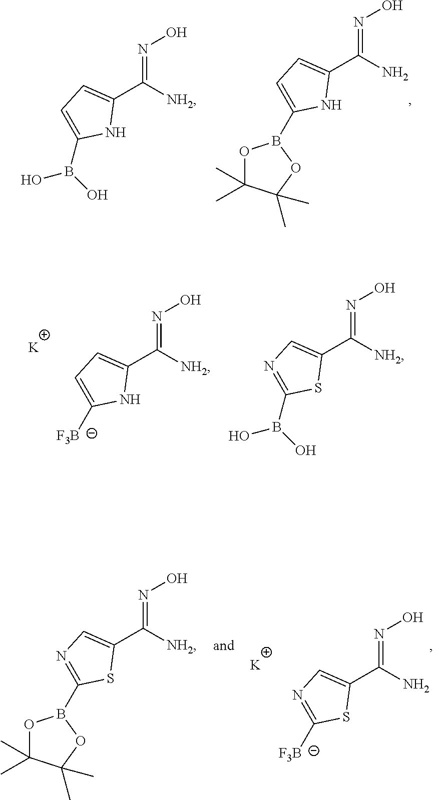

or a salt thereof.

In one aspect, a compound can be selected from:

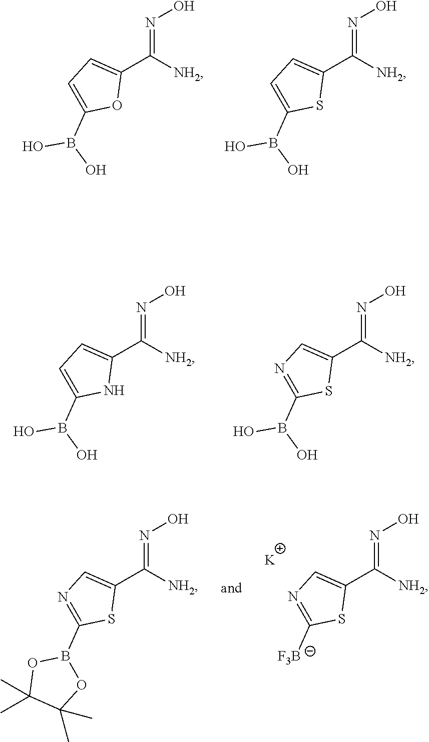

or a salt thereof.

### C. METHODS OF MAKING BORYLATED AMIDOXIMES

In one aspect, disclosed are methods of making a compound having a structure represented by a formula:

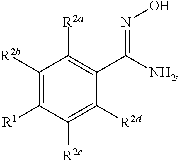

wherein R¹ is selected from —B(OR¹⁰)₂ and —B(R¹¹)₃X; wherein each occurrence of R¹⁰, when present, is independently selected from hydrogen and C1-C8 alkyl; wherein each occurrence of R^{D}, when present, is independently halogen; wherein X, when present, is a counterion; and wherein each of R^{2a}, R^{2b}, R^{2c}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof, the method comprising reacting an aryl cyanide having a structure represented by a formula:

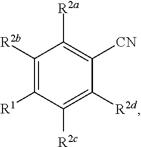

and a hydroxylamine, thereby making the compound.

Also disclosed are methods of making a compound having a structure represented by a formula:

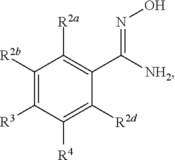

wherein R³ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, and —B(OR¹²)₂; wherein each occurrence of R¹², when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein R⁴ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, —B(OR¹³)₂, and —B(R¹⁴)₃X; wherein each occurrence of R¹³, when present, is independently selected from hydrogen and C1-C8 alkyl; wherein each occurrence of R¹⁴, when present, is independently halogen; wherein X, when present, is a counterion; and wherein each of R^{2a}, R^{2b}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, provided that either R³ is —B(OR¹²)₂ or R⁴ is selected from —B(OR¹³)₂ and —B(R¹⁴)₃, and provided that when R³ is —B(OR¹²)₂, then R⁴ is not —B(OR¹³)₂ or —B(R¹⁴)₃, or a salt thereof, the method comprising reacting an aryl cyanide having a structure represented by a formula:

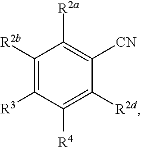

and a hydroxylamine, thereby making the compound.

Also disclosed are methods of making a compound having a structure represented by a formula:

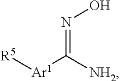

wherein R⁵ is selected from —B(OR¹⁵)₂ and —B(R¹⁶)₃X; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein X, when present, is a counterion; and wherein Ar¹ is a C2-C10 heteroaryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof, the method comprising reacting an aryl cyanide having a structure represented by a formula:

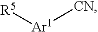

and a hydroxylamine, thereby making the compound.

In various aspects, the compound has a structure represented by a formula:

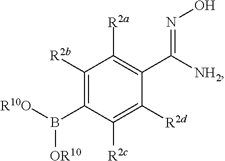

or a salt thereof.

In various aspects, the compound has a structure represented by a formula:

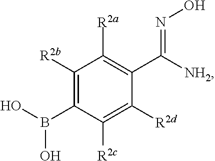

or a salt thereof.

In various aspects, the compound has a structure represented by a formula:

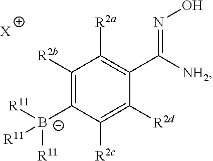

or a salt thereof.

In various aspects, the compound has a structure represented by a formula:

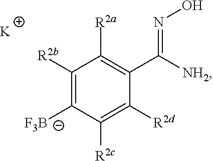

or a salt thereof.

In various aspects, the compound has a structure represented by a formula:

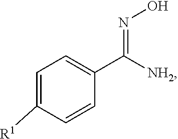

or a salt thereof.

In various aspects, the compound has a structure represented by a formula:

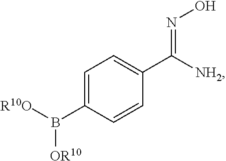

or a salt thereof.

In various aspects, the compound is:

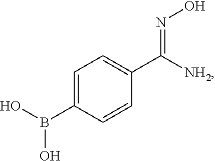 [SMILES: N/C(=N\O)c1ccc(B(O)O)cc1]

or a salt thereof.

In various aspects, the compound has a structure represented by a formula:

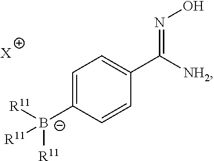

or a salt thereof.

In various aspects, the compound is:

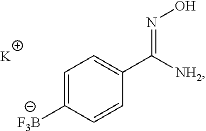

or a salt thereof.

In various aspects, the compound has a structure represented by a formula:

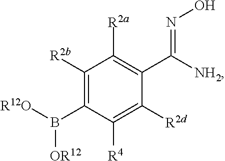

or a salt thereof.

In various aspects, the compound has a structure represented by a formula:

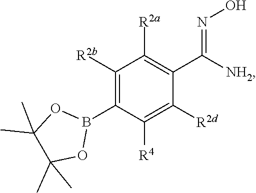

or a salt thereof.

In various aspects, the compound has a structure represented by a formula selected from:

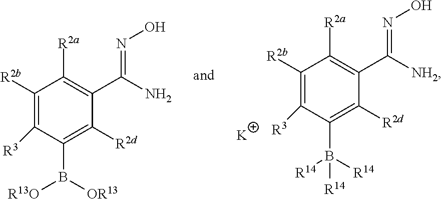

or a salt thereof.

In various aspects, the compound has a structure represented by a formula selected from:

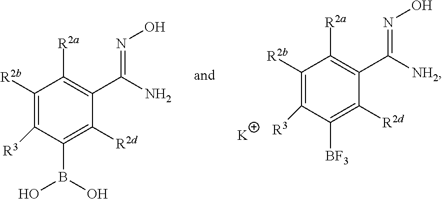

or a salt thereof.

In various aspects, the compound has a structure represented by a formula:

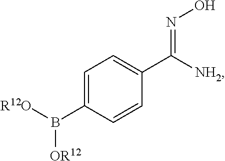

or a salt thereof.

In various aspects, the compound is:

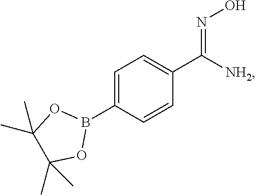 [SMILES: CC1(C)OB(c2ccc(/C(N)=N/O)cc2)OC1(C)C]

or a salt thereof.

In various aspects, the compound has a structure represented by a formula selected from:

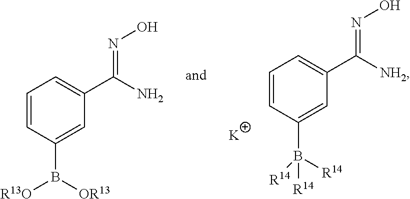

or a salt thereof.

In various aspects, the compound has a structure represented by a formula selected from:

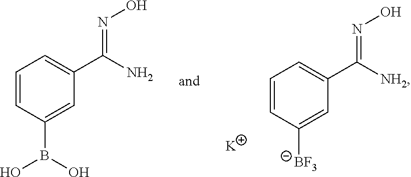

or a salt thereof.

In various aspects, Ar¹ is an unsubstituted C2-C10 heteroaryl.

In various aspects, Ar¹ is not a 6-membered heteroaryl.

In various aspects, Ar¹ is selected from furanyl, thiophenyl, pyrrolyl, benzo[d]thiazole, pyrazolyl, imidazolyl, triazolyl, oxazolyl, thiazolyl, pyridinyl, pyrimidinyl, imidazolyl, purinyl, indolyl, and quinolinyl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino.

In various aspects, Ar¹ is selected from furanyl, thiophenyl, pyrrolyl, benzo[d]thiazole, pyrazolyl, imidazolyl, triazolyl, oxazolyl, thiazolyl, pyridinyl, pyrimidinyl, imidazolyl, purinyl, indolyl, and quinolinyl, and is unsubstituted.

In various aspects, Ar¹ is selected from furanyl, thiophenyl, pyrrolyl, benzo[d]thiazole, pyrazolyl, imidazolyl, triazolyl, oxazolyl, thiazolyl, pyrimidinyl, imidazolyl, purinyl, indolyl, and quinolinyl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino.

In various aspects, Ar¹ is selected from furanyl, thiophenyl, pyrrolyl, benzo[d]thiazole, pyrazolyl, imidazolyl, triazolyl, oxazolyl, thiazolyl, pyrimidinyl, imidazolyl, purinyl, indolyl, and quinolinyl, and is unsubstituted.

In various aspects, Ar¹ is selected from furanyl, thiophenyl, pyrrolyl, and thiazolyl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino.

In various aspects, Ar¹ is selected from furanyl, thiophenyl, pyrrolyl, and thiazolyl, and is unsubstituted.

In various aspects, the compound has a structure represented by a formula selected from:

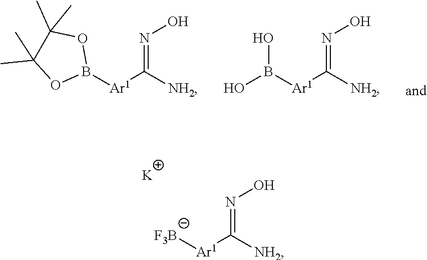

or a salt thereof.

In various aspects, the compound has a structure represented by a formula:

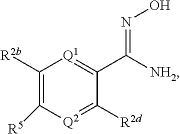

wherein each of Q¹ and Q² is independently selected from N and CR¹⁷, provided at least one of Q¹ and Q² is N; wherein R¹⁷, when present, is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; and wherein each of R^{2b} and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof.

In various aspects, the compound has a structure represented by a formula:

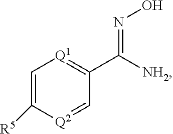

wherein each of Q¹ and Q² is independently selected from N and CH, or a salt thereof.

In various aspects, the compound has a structure represented by a formula selected from:

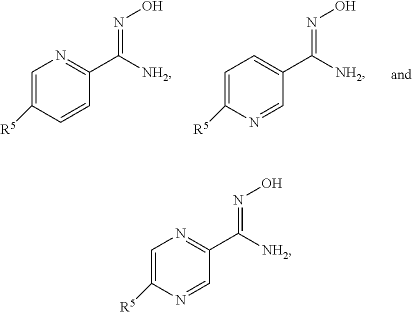

or a salt thereof.

In various aspects, the compound has a structure represented by a formula

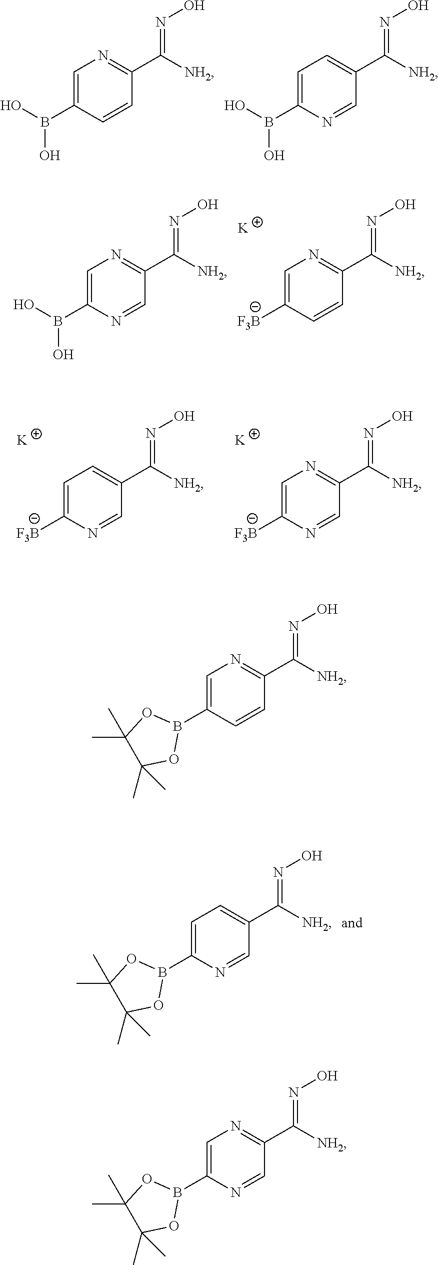

or a salt thereof.

In various aspects, the compound has a structure represented by a formula selected from:

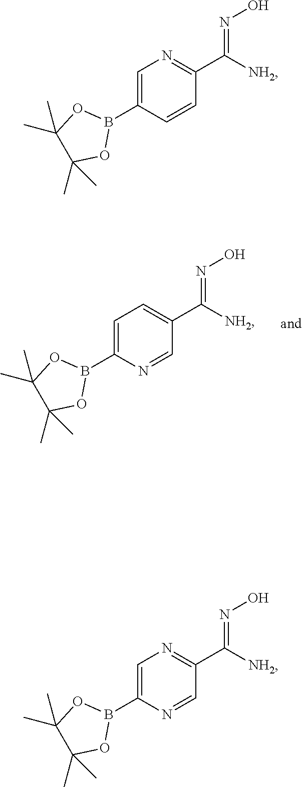 [SMILES: CC1(C)OB(c2ccc(/C(N)=N/O)nc2)OC1(C)C ; CC1(C)OB(c2ccc(/C(N)=N/O)cn2)OC1(C)C ; CC1(C)OB(c2cnc(/C(N)=N/O)cn2)OC1(C)C]

or a salt thereof.

In various aspects, the compound has a structure represented by a formula:

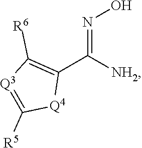

wherein Q³ is selected from N and CR¹⁸; wherein R¹⁸, when present, is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; wherein Q⁴ is selected from O, S, and NR¹⁹; wherein R¹⁹, when present, is selected from hydrogen and C1-C4 alkyl; and wherein R⁶ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a salt thereof.

In various aspects, the compound has a structure represented by a formula:

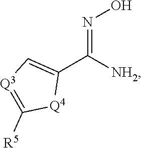

wherein Q³ is selected from N and CH, or a pharmaceutically acceptable salt thereof.

In various aspects, the compound has a structure represented by a formula selected from:

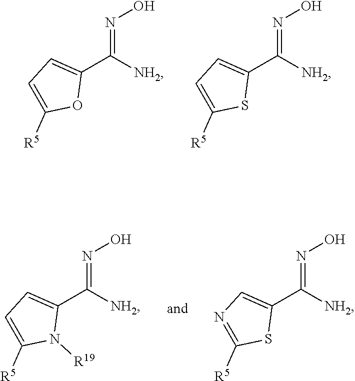

or a pharmaceutically acceptable salt thereof.

In various aspects, the compound has a structure represented by a formula selected from:

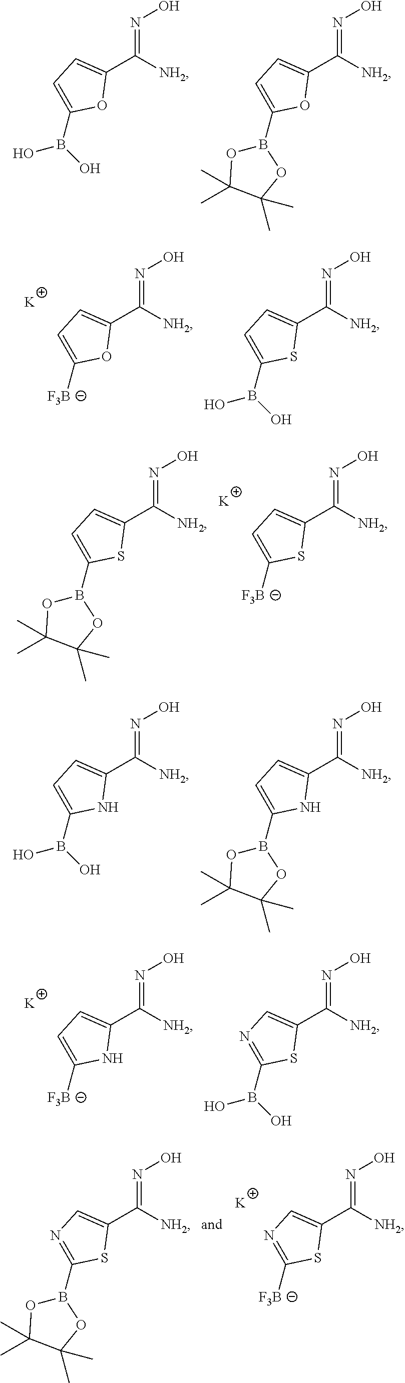

or a salt thereof.

In various aspects, the compound has a structure represented by a formula selected from:

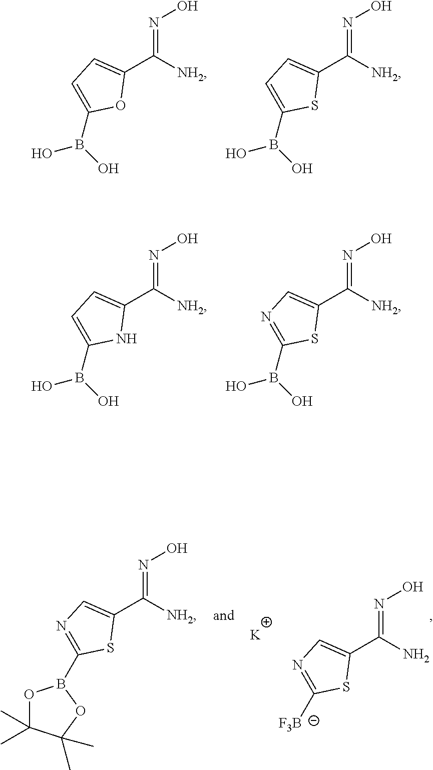

or a salt thereof.

In various aspects, the compound is selected from:

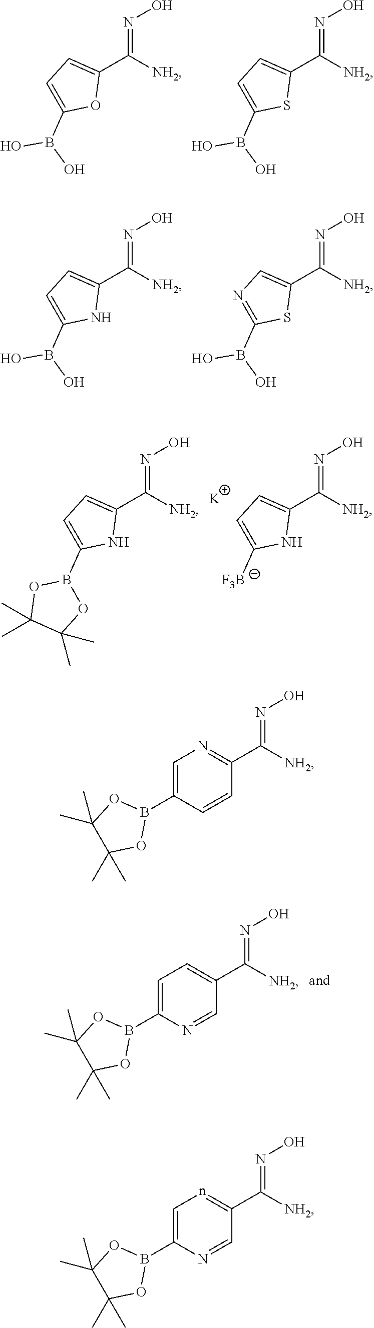

In various aspects, the hydroxylamine is present as a salt. Exemplary salts include, but are not limited to, halides, acetates, alginates, ascorbates, benzoates, carbonates, cinnamates, citrates, diphosphates, fumarates, gluconates, lactates, laurates, malates, maleates, mesylates, myristates, nitrates, palmitates, phosphates, propionates, sorbates, succinates, sulfates, tartrates, and conjugate bases of a phenolic acid. In a further aspect, the hydroxylamine is hydroxylamine hydrochloride or hydroxylamine sulfate. In a still further aspect, the hydroxylamine is hydroxylamine hydrochloride.

In various aspects, reacting is in the presence of a base. Exemplary bases include, but are not limited to, pyridine, alkanamines (e.g., methylamine, ethylamine, N,N-diisopropylethylamine), imidazole, benzimidazole, histidine, guandinine, and organic cations. In a further aspect, the base is an amine base. In a still further aspect, the amine base is selected from methylamine, dimethylamine, trimethylamine, ethylamine, aniline, 4-methoxyaniline, N,N-dimethylaniline, 3-nitroaniline, 4-nitroaniline, 4-trifluoromethylaniline, and N,N-diisopropylethylamine. In yet a further aspect, the base is N,N-diisopropylethylamine.

In various aspects, reacting is in the presence of a solvent such as, for example, a polar protic solvent. In a further aspect, the solvent is an alcohol. In a still further aspect, the solvent is methanol or ethanol. In yet a further aspect, the solvent is ethanol.

In various aspects, reacting is at an elevated temperature. In a further aspect, reacting is under reflux conditions. In a still further aspect, reacting is at room temperature.

In various aspects, reacting is for a time period of at least 5 hours, at least 10 hours, or at least 15 hours. In a further aspect, reacting is for a time period of about 5 hours, about 10 hours, about 15 hours, or about 20 hours. In a still further aspect, reacting is for a time period of about 20 hours.

In various aspects, the method further comprises purifying the compound. Exemplary purification methods include, but are not limited to, crystallization (e.g., fractional crystallization), recrystallization, sublimation, distillation (e.g., fractional distillation, distillation under reduced pressure, steam distillation, azeotropic distillation), and chromatography. In a further aspect, the method further comprises recrystallizing the compound. In a still further aspect, recrystallizing is in a solvent system comprising ethyl acetate. In yet a further aspect, recrystallizing is in a solvent system comprising petroleum ether. In an even further aspect, recrystallizing is in a solvent system comprising ethyl acetate and petroleum ether. In a still further aspect, recrystallizing is in a solvent system comprising ethyl acetate and petroleum ether in a ratio of from about 1:2 to about 1:6. In yet a further aspect, recrystallizing is in a solvent system comprising ethyl acetate and petroleum ether in a ratio of about 1:2, about 1:3, about 1:4, about 1:5, or about 1:6. In an even further aspect, recrystallizing is in a solvent system comprising ethyl acetate and petroleum ether in a ratio of about 1:4.

In various aspects, the hydroxylamine is hydroxylamine hydrochloride, wherein reacting is in ethanol and in the presence of N,N-diisopropylethylamine under refluxing conditions. In a further aspect, the compound is selected from:

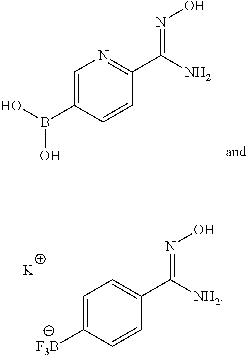

In a still further aspect, reacting is for a time period of about 20 hours. In yet a further aspect, the method further comprises recrystallizing the compound in a solvent system comprising ethyl acetate and petroleum ether in a ratio of about 1:4.

In various aspects, the hydroxylamine is hydroxylamine hydrochloride, wherein reacting is in ethanol and in the presence of N,N-diisopropylethylamine under refluxing conditions. In a further aspect, the compound is selected from:

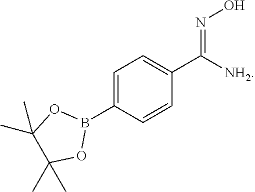 [SMILES: CC1(C)OB(c2ccc(/C(N)=N/O)cc2)OC1(C)C]

In a still further aspect, reacting is for a time period of about 20 hours. In yet a further aspect, the method further comprises recrystallizing the compound in a solvent system comprising ethyl acetate and petroleum ether in a ratio of about 1:4.

In various aspects, the hydroxylamine is hydroxylamine hydrochloride, wherein reacting is in ethanol and in the presence of N,N-diisopropylethylamine under refluxing conditions. In a further aspect, the compound is selected from:

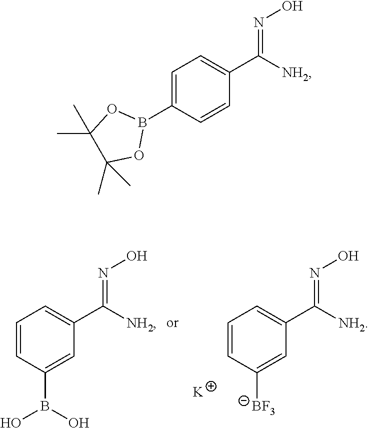

In a still further aspect, reacting is for a time period of about 20 hours. In yet a further aspect, the method further comprises recrystallizing the compound in a solvent system comprising ethyl acetate and petroleum ether in a ratio of about 1:4.

In various aspects, the hydroxylamine is hydroxylamine hydrochloride, wherein reacting is in ethanol and in the presence of N,N-diisopropylethylamine under refluxing conditions. In a further aspect, the compound is selected from:

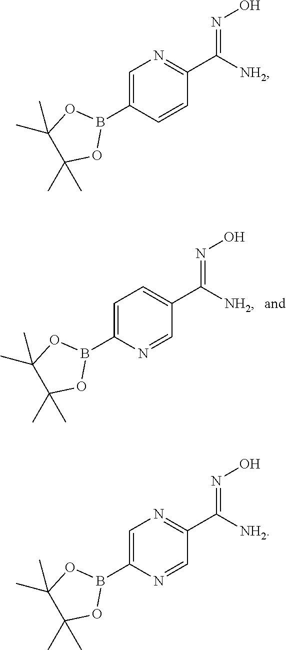 [SMILES: CC1(C)OB(c2ccc(/C(N)=N/O)nc2)OC1(C)C ; CC1(C)OB(c2ccc(/C(N)=N/O)cn2)OC1(C)C ; CC1(C)OB(c2cnc(/C(N)=N/O)cn2)OC1(C)C]

In a still further aspect, reacting is for a time period of about 20 hours. In yet a further aspect, the method further comprises recrystallizing the compound in a solvent system comprising ethyl acetate and petroleum ether in a ratio of about 1:4.

In various aspects, the hydroxylamine is hydroxylamine hydrochloride, wherein reacting is in ethanol and in the presence of N,N-diisopropylethylamine under refluxing conditions. In a further aspect, the compound is selected from:

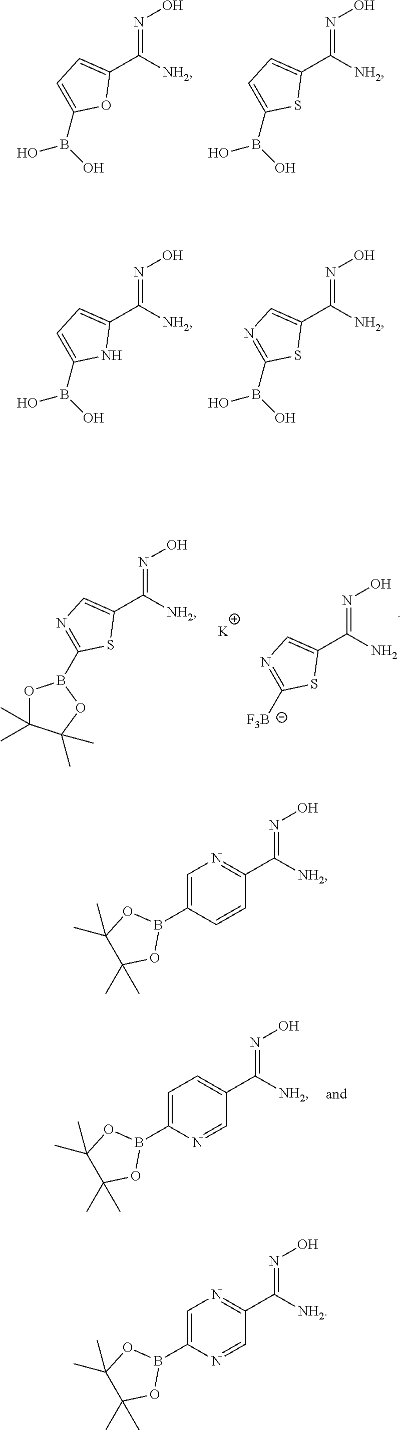

In a still further aspect, reacting is for a time period of about 20 hours. In yet a further aspect, the method further comprises recrystallizing the compound in a solvent system comprising ethyl acetate and petroleum ether in a ratio of about 1:4.

The compounds of this invention can be prepared by employing reactions as shown in the following schemes, in addition to other standard manipulations that are known in the literature, exemplified in the experimental sections or clear to one skilled in the art. For clarity, examples having a single substituent are shown where multiple substituents are allowed under the definitions disclosed herein.

Reactions used to generate the compounds of this invention are prepared by employing reactions as shown in the following Reaction Schemes, as described and exemplified below. In certain specific examples, the disclosed compounds can be prepared by Route I, as described and exemplified below. The following examples are provided so that the invention might be more fully understood, are illustrative only, and should not be construed as limiting.

### 1. Route I

In one aspect, borylated amidoximes can be prepared as shown below.

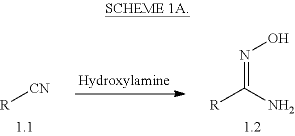

Compounds are represented in generic form, wherein R is:

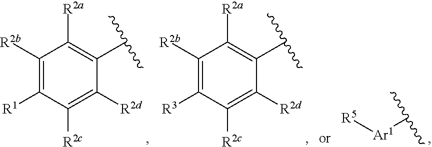

and with other substituents as noted in compound descriptions elsewhere herein. A more specific example is set forth below.

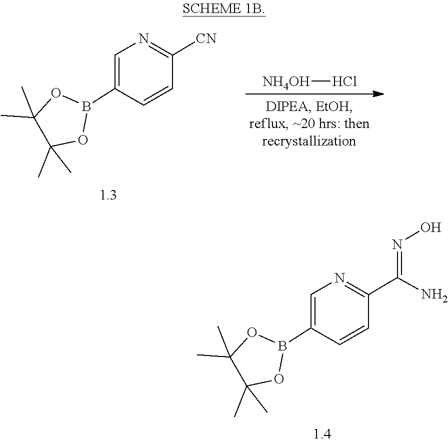

In one aspect, compounds of type 1.4 and similar compounds can be prepared according to reaction Scheme 1B above. Thus, compounds of type 1.4 can be prepared by reacting an aryl cyanide, e.g., 1.3 as shown above, with an appropriate hydroxylamine, e.g., hydroxylamine hydrochloride as shown above. Appropriate aryl cyanides and appropriate hydroxylamines are commercially available or prepared by methods known to one skilled in the art. The reaction is carried out in the presence of an appropriate base, e.g., N,N-diispropylethylamine (DIPEA), in an appropriate solvent, e.g., ethanol, at an appropriate temperature, e.g., refluxing conditions, for an appropriate period of time, e.g., about 20 hours, followed by purification, e.g., via recrystallization, in an appropriate solvent system. As can be appreciated by one skilled in the art, the above reaction provides an example of a generalized approach wherein compounds similar in structure to the specific reactants above (compounds similar to compounds of type 1.1) can be substituted in the reaction to provide borylated amidoxime analogs similar to Formula 1.2 above.

### D. BORON-CONTAINING FUNCTIONALIZED OXADIAZOLES

In one aspect, the invention relates to boron-containing functionalized oxadiazoles. Boron-containing functionalized oxadiazoles are highly important pharmacologically, and are well-studied core structural units of various muscarinic agonists, benzodiazepine receptor partial agonists, dopamine transporters, antirhinovirals, a growth hormone secretagogue, and 5-HT agonists, as well as a urea bioisostere in β3-adrenergic receptor agonists. Without wishing to be bound by theory, it is believed that the instantly disclosed boron-containing functionalized oxadiazoles can be useful as pharmaceutically active agents, and in the development of alternative pharmaceutically active agents.

It is contemplated that each disclosed derivative can be optionally further substituted. It is also contemplated that any one or more derivative can be optionally omitted from the invention. It is understood that a disclosed compound can be provided by the disclosed methods. It is also understood that the disclosed compounds can be employed in the disclosed methods of using.

### 1. Structure

In one aspect, disclosed are compounds having a structure represented by a formula:

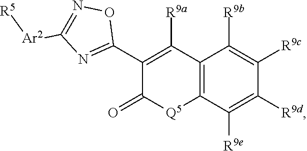

wherein Q⁵ is selected from O and NR²¹; wherein R²¹, when present, is selected from hydrogen and C1-C4 alkyl; wherein R⁵ is selected from —B(OR¹⁵)₂ and —B(R¹⁶)₃X; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein X, when present, is a counterion; wherein each of R^{9a}, R^{9b}, R^{9c}, R^{9d}, and R^{9e}, when present, is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; and wherein Ar² is selected from a C6-C10 aryl and a C2-C10 heteroaryl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino.

In various aspects, the compound has a structure represented by a formula:

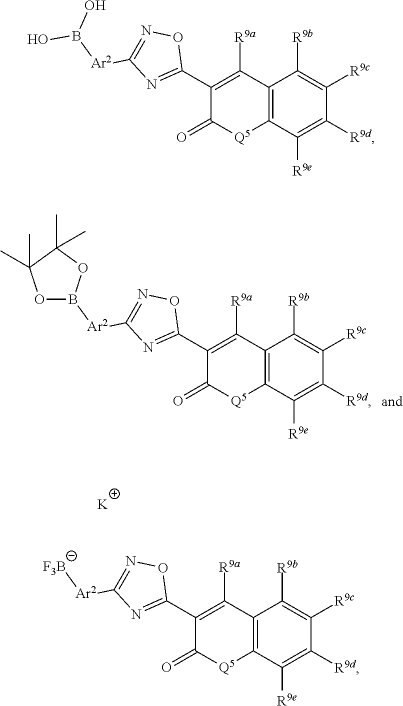

or a pharmaceutically acceptable salt thereof.

In various aspects, the compound has a structure represented by a formula:

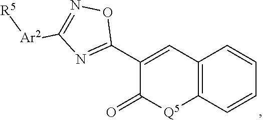

or a pharmaceutically acceptable salt thereof.

In various aspects, the compound has a structure represented by a formula:

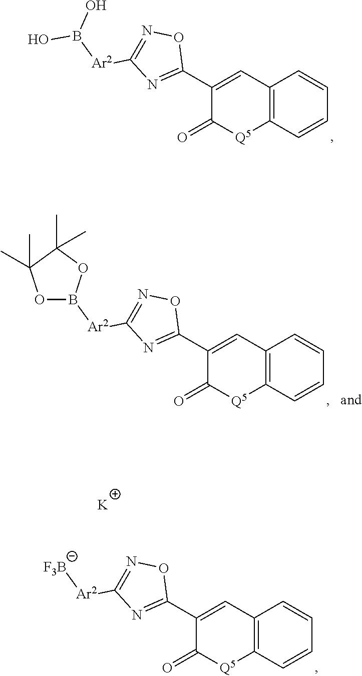

or a pharmaceutically acceptable salt thereof.

In various aspects, the compound has a structure represented by a formula selected from:

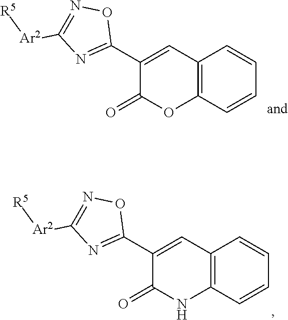

or a pharmaceutically acceptable salt thereof.

In various aspects, the compound is selected from:

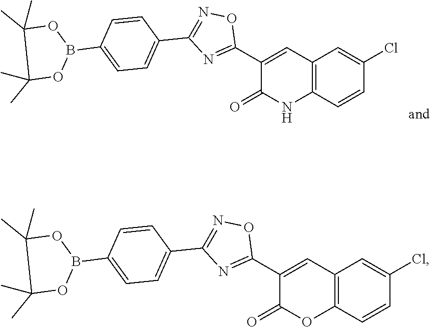 [SMILES: CC1(C)OB(c2ccc(-c3noc(-c4cc5cc(Cl)ccc5[nH]c4=O)n3)cc2)OC1(C)C ; CC1(C)OB(c2ccc(-c3noc(-c4cc5cc(Cl)ccc5oc4=O)n3)cc2)OC1(C)C]

or a pharmaceutically acceptable salt thereof.
a. Q⁵ Groups

In one aspect, Q⁵ is selected from O and NR²¹. In a further aspect, Q⁵ is O. In a still further aspect, Q⁵ is NR²¹.

In various aspects, Q⁵ is selected from O and NH. In a further aspect, Q⁵ is NH.

b. R⁵ Groups

In one aspect, R⁵ is selected from —B(OR¹⁵)₂ and —B(R¹⁶)₃. In a further aspect, R⁵ is —B(OR¹⁵)₂. In a still further aspect, R⁵ is —B(R¹⁶)₃.

c. R^{9A}, R^{9B}, R^{9C}, R^{9D}, AND R^{9E} Groups

In one aspect, each of R^{9a}, R^{9b}, R^{9c}, R^{9d}, and R^{9e}, when present, is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, each of R^{9a}, R^{9b}, R^{9c}, R^{9d}, and R^{9e}, when present, is independently selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, each of R^{9a}, R^{9b}, R^{9c}, R^{9d}, and R^{9e}, when present, is independently selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, each of R^{9a}, R^{9b}, R^{9c}, R^{9d}, and R^{9e}, when present, is independently selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In various aspects, each of R^{9a}, R^{9b}, R^{9c}, R^{9d}, and R^{9e}, when present, is independently selected from hydrogen, halogen, —CN, —NH₂, —OH, —NO₂, C1-C4 alkyl, and C2-C4 alkenyl. In a further aspect, each of R^{9a}, R^{9b}, R^{9c}, R^{9d}, and R^{9e}, when present, is independently selected from hydrogen, —F, —Cl, —CN, —NH₂, —OH, —NO₂, methyl, ethyl, n-propyl, isopropyl, ethenyl, n-propenyl, and isopropenyl. In a still further aspect, each of R^{9a}, R^{9b}, R^{9c}, R^{9d}, and R^{9e}, when present, is independently selected from hydrogen, —F, —Cl, —CN, —NH₂, —OH, —NO₂, methyl, ethyl, and ethenyl. In yet a further aspect, each of R^{9a}, R^{9b}, R^{9c}, R^{9d}, and R^{9e}, when present, is independently selected from hydrogen, —F, —Cl, —CN, —NH₂, —OH, —NO₂, and methyl.

In various aspects, each of R^{9a}, R^{9b}, R^{9c}, R^{9d}, and R^{9e}, when present, is independently selected from hydrogen, halogen, —CN, —NH₂, —OH, —NO₂, C1-C4 haloalkyl, and C1-C4 cyanoalkyl. In a further aspect, each of R^{9a}, R^{9b}, R^{9c}, R^{9d}, and R^{9e}, when present, is independently selected from hydrogen, —F, —Cl, —CN, —NH₂, —OH, —NO₂, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, and —CH(CH₃)CH₂CN. In a still further aspect, each of R^{9a}, R^{9b}, R^{9c}, R^{9d}, and R^{9e}, when present, is independently selected from hydrogen, —F, —Cl, —CN, —NH₂, —OH, —NO₂, —CH₂F, —CH₂Cl, —CH₂CH₂F, —CH₂CH₂Cl, —CH₂CN, and —CH₂CH₂CN. In yet a further aspect, each of R^{9a}, R^{9b}, R^{9c}, R^{9d}, and R^{9e}, when present, is independently selected from hydrogen, —F, —Cl, —CN, —NH₂, —OH, —NO₂, —CH₂F, —CH₂Cl, and —CH₂CN.

In various aspects, each of R^{9a}, R^{9b}, R^{9c}, R^{9d}, and R^{9e}, when present, is independently selected from hydrogen, halogen, —CN, —NH₂, —OH, —NO₂, C1-C4 hydroxyalkyl, C1-C4 haloalkoxy, and C1-C4 alkoxy. In a further aspect, each of R^{9a}, R^{9b}, R^{9c}, R^{9d}, and R^{9e}, when present, is independently selected from hydrogen, —F, —Cl, —CN, —NH₂, —OH, —NO₂, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, and —OCH(CH₃)CH₃. In a still further aspect, each of R^{9a}, R^{9b}, R^{9c}, R^{9d}, and R^{9e}, when present, is independently selected from hydrogen, —F, —Cl, —CN, —NH₂, —OH, —NO₂, —CH₂OH, —CH₂CH₂OH, —OCF₃, —OCH₂CF₃, —OCH₃, and —OCH₂CH₃. In yet a further aspect, each of R^{9a}, R^{9b}, R^{9c}, R^{9d}, and R^{9e}, when present, is independently selected from hydrogen, —F, —Cl, —CN, —NH₂, —OH, —NO₂, —CH₂OH, —OCF₃, and —OCH₃.

In various aspects, each of R^{9a}, R^{9b}, R^{9c}, R^{9d}, and R^{9e}, when present, is independently selected from hydrogen, halogen, —CN, —NH₂, —OH, —NO₂, C1-C4 alkylamino, (C1-C4)(C1-C4) dialkylamino, and C1-C4 aminoalkyl. In a further aspect, each of R^{9a}, R^{9b}, R^{9c}, R^{9d}, and R^{9e}, when present, is independently selected from hydrogen, —F, —Cl, —CN, —NH₂, —OH, —NO₂, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, each of R^{9a}, R^{9b}, R^{9c}, R^{9d}, and R^{9e}, when present, is independently selected from hydrogen, —F, —Cl, —CN, —NH₂, —OH, —NO₂, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, e each of R^{9a}, R^{9b}, R^{9c}, R^{9d}, and R^{9e}, when present, is independently selected from hydrogen, —F, —Cl, —CN, —NH₂, —OH, —NO₂, —NHCH₃, —N(CH₃)₂, and —CH₂NH₂.

In a further aspect, each of R^{9a}, R^{9b}, R^{9c}, R^{9d}, and R^{9e}, when present, is independently selected from hydrogen and C1-C4 alkyl. In a still further aspect, each of R^{9a}, R^{9b}, R^{9c}, R^{9d}, and R^{9e}, when present, is independently selected from hydrogen, methyl, ethyl, n-propyl, and isopropyl. In yet a further aspect, each of R^{9a}, R^{9b}, R^{9c}, R^{9d}, and R^{9e}, when present, is independently selected from hydrogen, methyl, and ethyl. In an even further aspect, each of R^{9a}, R^{9b}, R^{9c}, R^{9d}, and R^{9e}, when present, is independently selected from hydrogen and ethyl. In a still further aspect, each of R^{9a}, R^{9b}, R^{9c}, R^{9d}, and R^{9e}, when present, is independently selected from hydrogen and methyl.

In a further aspect, each of R^{9a}, R^{9b}, R^{9c}, R^{9d}, and R^{9e}, when present, is independently selected from hydrogen and halogen. In a still further aspect, each of R^{9a}, R^{9b}, R^{9c}, R^{9d}, and R^{9e}, when present, is independently selected from hydrogen, —F, —Cl, and —Br. In yet a further aspect, each of R^{9a}, R^{9b}, R^{9c}, R^{9d}, and R^{9e}, when present, is independently selected from hydrogen, —F, and —Cl. In an even further aspect, each of R^{9a}, R^{9b}, R^{9c}, R^{9d}, and R^{9e}, when present, is independently selected from hydrogen and —Cl. In a still further aspect, each of R^{9a}, R^{9b}, R^{9c}, R^{9d}, and R^{9e}, when present, is independently selected from hydrogen and —F.

In a further aspect, each of R^{9a}, R^{9b}, R^{9c}, R^{9d}, and R^{9e}, when present, is hydrogen.

d. R¹⁵ Groups

In one aspect, each occurrence of R¹¹, when present, is independently selected from hydrogen and C1-C8 alkyl, or each occurrence of R¹¹, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups.

In various aspects, each occurrence of R¹⁵, when present, is independently selected from hydrogen and C1-C8 alkyl. In a further aspect, each occurrence of R¹⁵, when present, is independently selected from hydrogen and C1-C4 alkyl. In a still further aspect, each occurrence of R¹⁵, when present, is independently selected from hydrogen, methyl, ethyl, n-propyl, and isopropyl. In yet a further aspect, each occurrence of R¹⁵, when present, is independently selected from hydrogen, methyl, and ethyl. In an even further aspect, each occurrence of R¹⁵, when present, is independently selected from hydrogen and ethyl. In a still further aspect, each occurrence of R¹⁵, when present, is independently selected from hydrogen and methyl.

In various aspects, each occurrence of R¹⁵, when present, is C1-C8 alkyl. In a further aspect, each occurrence of R¹⁵, when present, is C1-C4 alkyl. In a still further aspect, each occurrence of R¹⁵, when present, is independently selected from methyl, ethyl, n-propyl, and isopropyl. In yet a further aspect, each occurrence of R¹⁵, when present, is independently selected from methyl and ethyl. In an even further aspect, each occurrence of R¹⁵, when present, is ethyl. In a still further aspect, each occurrence of R¹⁵, when present, is methyl.

In various aspects, each occurrence of R¹⁵, when present, is hydrogen.

In various aspects, each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups. In a further aspect, each occurrence of R¹⁵, when present, is covalently bonded together, and, together with the intermediate atoms, comprise a C6 bicyclic heterocycle or a C2-C3 heterocycloalkyl, and is substituted with 0, 1, 2, or 3 C1-C4 alkyl groups. In yet a further aspect, each occurrence of R¹⁵, when present, is covalently bonded together, and, together with the intermediate atoms, comprise a C6 bicyclic heterocycle or a C2-C3 heterocycloalkyl, and is substituted with 0, 1, or 2 C1-C4 alkyl groups. In an even further aspect, each occurrence of v when present, is covalently bonded together, and, together with the intermediate atoms, comprise a C6 bicyclic heterocycle or a C2-C3 heterocycloalkyl, and is substituted with 0 or 1 C1-C4 alkyl groups. In a still further aspect, each occurrence of R¹⁵, when present, is covalently bonded together, and, together with the intermediate atoms, comprise a C6 bicyclic heterocycle or a C2-C3 heterocycloalkyl, and is monosubstituted with a C1-C4 alkyl group. In yet a further aspect, each occurrence of R¹⁵, when present, is covalently bonded together, and, together with the intermediate atoms, comprise a C6 bicyclic heterocycle or a C2-C3 heterocycloalkyl, and is unsubstituted.

In a further aspect, each occurrence of R¹⁵, when present, is covalently bonded together, and, together with the intermediate atoms, comprise a C6 bicyclic heterocycle substituted with 0, 1, 2, 3, or 4 C1-C4 alkyl groups. In a still further aspect, each occurrence of R¹⁵, when present, is covalently bonded together, and, together with the intermediate atoms, comprise a C6 bicyclic heterocycle substituted with 0, 1, 2, or 3 C1-C4 alkyl groups. In yet a further aspect, each occurrence of R¹⁵, when present, is covalently bonded together, and, together with the intermediate atoms, comprise a C6 bicyclic heterocycle substituted with 0, 1, or 2 C1-C4 alkyl groups. In an even further aspect, each occurrence of R¹⁵, when present, is covalently bonded together, and, together with the intermediate atoms, comprise a C6 bicyclic heterocycle substituted with 0 or 1 C1-C4 alkyl groups. In a still further aspect, each occurrence of R¹⁵, when present, is covalently bonded together, and, together with the intermediate atoms, comprise a C6 bicyclic heterocycle monosubstituted with a C1-C4 alkyl group. In yet a further aspect, each occurrence of R¹⁵, when present, is covalently bonded together, and, together with the intermediate atoms, comprise an unsubstituted C6 bicyclic heterocycle.

In a further aspect, each occurrence of R¹⁵, when present, is covalently bonded together, and, together with the intermediate atoms, comprise a C6 bicyclic heterocycle substituted with 4 C1-C4 alkyl groups. In a still further aspect, each occurrence of R¹⁵, when present, is covalently bonded together, and, together with the intermediate atoms, comprise a C6 bicyclic heterocycle substituted with 4 groups selected from methyl, ethyl, n-propyl, and isopropyl. In yet a further aspect, each occurrence of R¹⁵, when present, is covalently bonded together, and, together with the intermediate atoms, comprise a C6 bicyclic heterocycle substituted with 4 groups selected from methyl and ethyl. In an even further aspect, each occurrence of R¹⁵, when present, is covalently bonded together, and, together with the intermediate atoms, comprise a C6 bicyclic heterocycle substituted with 4 methyl groups.

In a further aspect, each occurrence of R¹⁵, when present, is covalently bonded together, and, together with the intermediate atoms, comprise a C2-C3 heterocycloalkyl substituted with 0, 1, 2, 3, or 4 C1-C4 alkyl groups. In a still further aspect, each occurrence of R¹⁵, when present, is covalently bonded together, and, together with the intermediate atoms, comprise a C2-C3 heterocycloalkyl substituted with 0, 1, 2, or 3 C1-C4 alkyl groups. In yet a further aspect, each occurrence of R¹⁵, when present, is covalently bonded together, and, together with the intermediate atoms, comprise a C2-C3 heterocycloalkyl substituted with 0, 1, or 2 C1-C4 alkyl groups. In an even further aspect, each occurrence of R¹⁵, when present, is covalently bonded together, and, together with the intermediate atoms, comprise a C2-C3 heterocycloalkyl substituted with 0 or 1 C1-C4 alkyl groups. In a still further aspect, each occurrence of R¹⁵, when present, is covalently bonded together, and, together with the intermediate atoms, comprise a C2-C3 heterocycloalkyl monosubstituted with a C1-C4 alkyl group. In yet a further aspect, each occurrence of R¹⁵, when present, is covalently bonded together, and, together with the intermediate atoms, comprise an unsubstituted C2-C3 heterocycloalkyl.

In a further aspect, each occurrence of R¹⁵, when present, is covalently bonded together, and, together with the intermediate atoms, comprise a C2-C3 heterocycloalkyl substituted with 4 C1-C4 alkyl groups. In a still further aspect, each occurrence of R¹⁵, when present, is covalently bonded together, and, together with the intermediate atoms, comprise a C2-C3 heterocycloalkyl substituted with 4 groups selected from methyl, ethyl, n-propyl, and isopropyl. In yet a further aspect, each occurrence of R¹⁵, when present, is covalently bonded together, and, together with the intermediate atoms, comprise a C2-C3 heterocycloalkyl substituted with 4 groups selected from methyl and ethyl. In an even further aspect, each occurrence of R¹⁵, when present, is covalently bonded together, and, together with the intermediate atoms, comprise a C2-C3 heterocycloalkyl substituted with 4 methyl groups.

e. R¹⁶ Groups

In one aspect, each occurrence of R¹⁶, when present, is independently halogen. In a further aspect, each occurrence of R¹⁶, when present, is independently selected from —F, —Cl, and —Br. In a still further aspect, each occurrence of R¹⁶, when present, is independently selected from —F and —Cl. In yet a further aspect, each occurrence of R¹⁶, when present, is independently selected from —F and —Br. In an even further aspect, each occurrence of R¹⁶, when present, is independently selected from —Cl and —Br. In a still further aspect, each occurrence of R¹⁶, when present, is —I. In yet a further aspect, each occurrence of R¹⁶, when present, is —Br. In an even further aspect, each occurrence of R¹⁶, when present, is —Cl. In a still further aspect, each occurrence of R¹⁶, when present, is —F.

f. R²¹ Groups

In one aspect, R²¹, when present, is selected from hydrogen and C1-C4 alkyl. In a further aspect, R²¹, when present, is selected from hydrogen, methyl, ethyl, n-propyl, and isopropyl. In a still further aspect, R²¹, when present, is selected from hydrogen, methyl, and ethyl. In yet a further aspect, R²¹, when preset, is selected from hydrogen and ethyl. In an even further aspect, R²¹, when preset, is selected from hydrogen and methyl.

In various aspects, R²¹, when present, is C1-C4 alkyl. In a further aspect, R²¹, when present, is selected from methyl, ethyl, n-propyl, and isopropyl. In a still further aspect, R²¹, when present, is selected from methyl and ethyl. In yet a further aspect, R²¹, when preset, is ethyl. In an even further aspect, R²¹, when preset, is methyl.

In various aspects, R²¹, when present, is hydrogen.

g. Ar² Groups

In one aspect, Ar² is selected from a C6-C10 aryl and a C2-C10 heteroaryl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, Ar² is selected from a C6-C10 aryl and a C2-C10 heteroaryl, and is substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar² is selected from a C6-C10 aryl and a C2-C10 heteroaryl, and is substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar² is selected from a C6-C10 aryl and a C2-C10 heteroaryl, and is monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar² is selected from a C6-C10 aryl and a C2-C10 heteroaryl, and is unsubstituted.

In various aspects, Ar² is a C6-C10 aryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. Examples of C6-C10 aryls include, but are not limited to, phenyl, naphthyl, and anthracenyl. In a further aspect, Ar² is a C6-C10 aryl substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar² is a C6-C10 aryl substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar² is a C6-C10 aryl monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar² is unsubstituted C6-C10 aryl.

In various aspects, Ar² is phenyl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, Ar² is phenyl substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar² is phenyl substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar² is phenyl monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar² is unsubstituted phenyl.

In various aspects, Ar² is a C2-C10 heteroaryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. Examples of C2-C10 heteroaryls include, but are not limited to, furanyl, thiophenyl, pyrrolyl, benzo[d]thiazole, pyrazolyl, imidazolyl, triazolyl, oxazolyl, thiazolyl, pyridinyl, pyrimidinyl, imidazolyl, purinyl, indolyl, and quinolinyl. In a further aspect, Ar² is a C2-C10 heteroaryl substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar² is a C2-C10 heteroaryl substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar² is a C2-C10 heteroaryl monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar² is an unsubstituted C2-C10 heteroaryl.

In various aspects, Ar² is selected from furanyl, thiophenyl, pyrrolyl, benzo[d]thiazole, pyrazolyl, imidazolyl, triazolyl, oxazolyl, thiazolyl, pyrimidinyl, imidazolyl, purinyl, indolyl, and quinolinyl.

In various aspects, Ar² is selected from furanyl, thiophenyl, pyrrolyl, and thiazolyl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, Ar² is selected from furanyl, thiophenyl, pyrrolyl, and thiazolyl, and is substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar² is selected from furanyl, thiophenyl, pyrrolyl, and thiazolyl, and is substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar² is selected from furanyl, thiophenyl, pyrrolyl, and thiazolyl, and is monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar² is selected from furanyl, thiophenyl, pyrrolyl, and thiazolyl, and is unsubstituted.

### 2. Boron-Containing Functionalized Oxadiazole Examples

In one aspect, a compound can be present as:

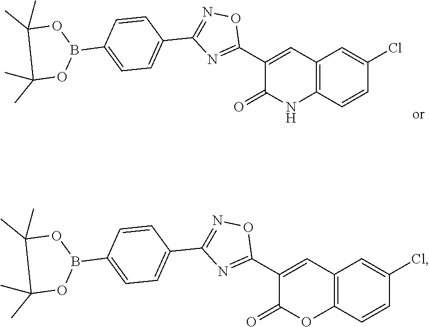 [SMILES: CC1(C)OB(c2ccc(-c3noc(-c4cc5cc(Cl)ccc5[nH]c4=O)n3)cc2)OC1(C)C ; CC1(C)OB(c2ccc(-c3noc(-c4cc5cc(Cl)ccc5oc4=O)n3)cc2)OC1(C)C]

or a pharmaceutically acceptable salt thereof.

### 3. Prophetic Boron-Containing Functionalized Oxadiazoles

The following compound examples are prophetic, and can be prepared using the synthesis methods described herein above and other general methods as needed as would be known to one skilled in the art. It is anticipated that the prophetic compounds would be useful as pharmaceutically active agents, and in the generation of alternative pharmaceutically active agents, and such utility can be determined using the synthetic methods described herein below.

In one aspect, a compound can be selected from:

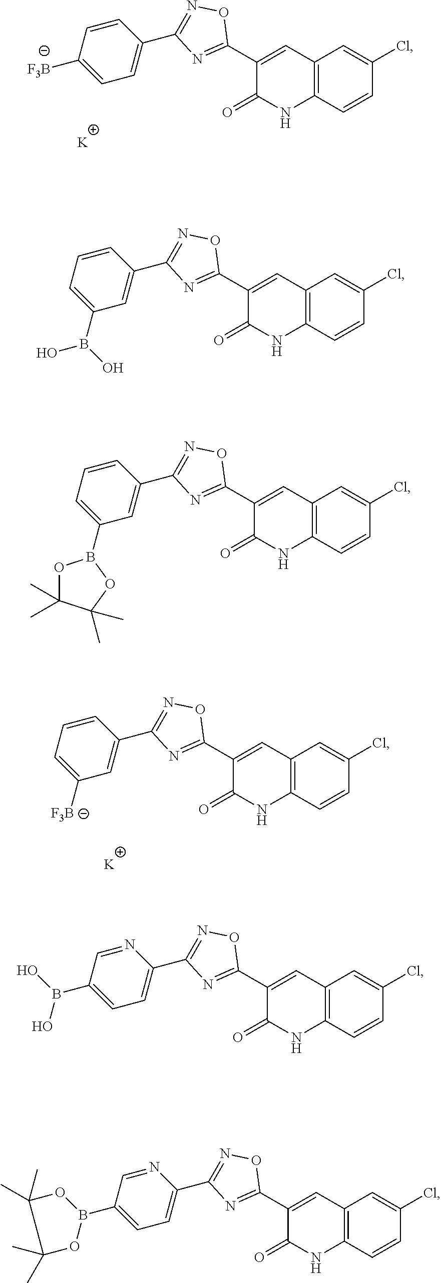

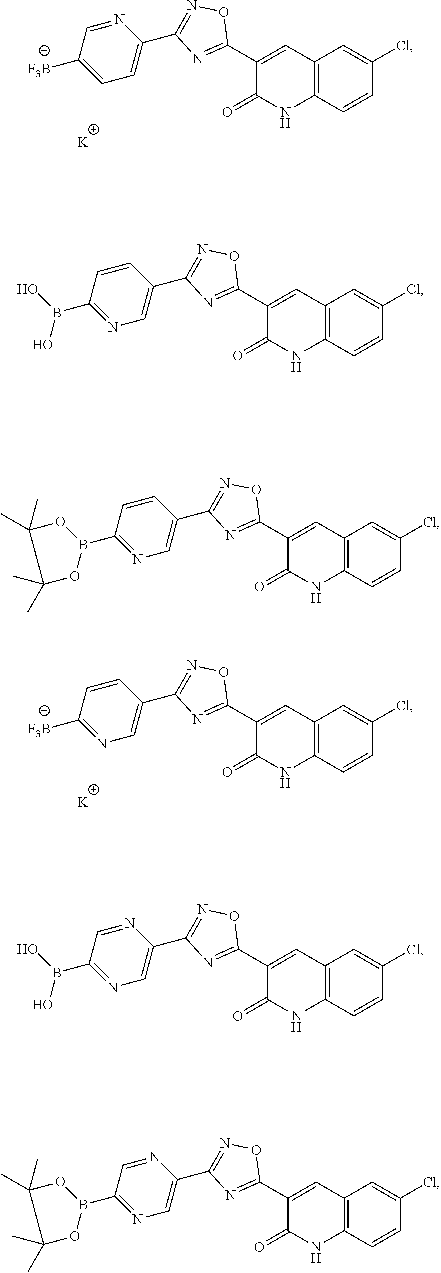

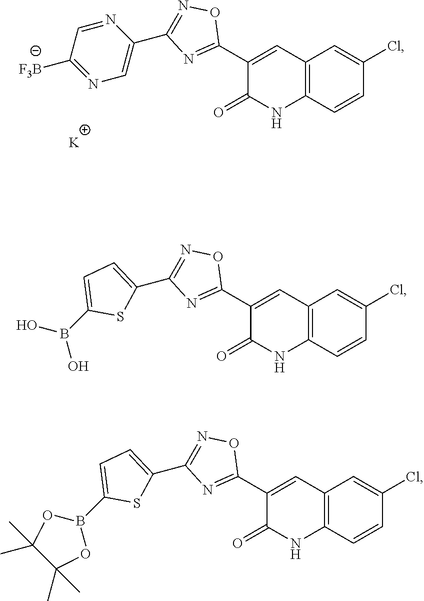

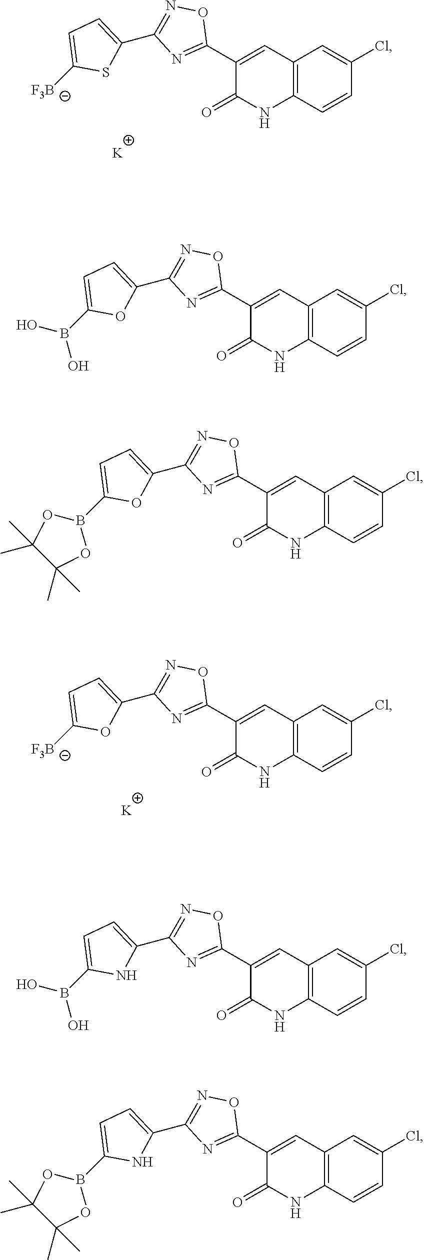

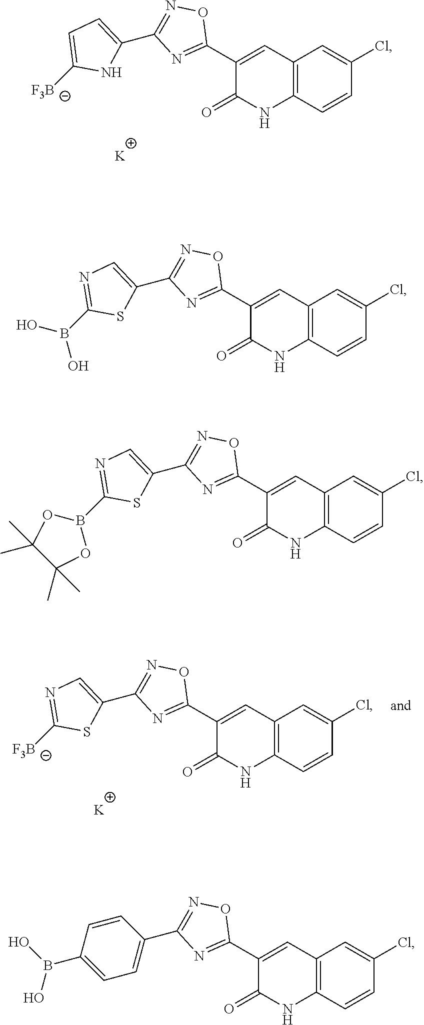

or a pharmaceutically acceptable salt thereof.

In one aspect, a compound can be selected as:

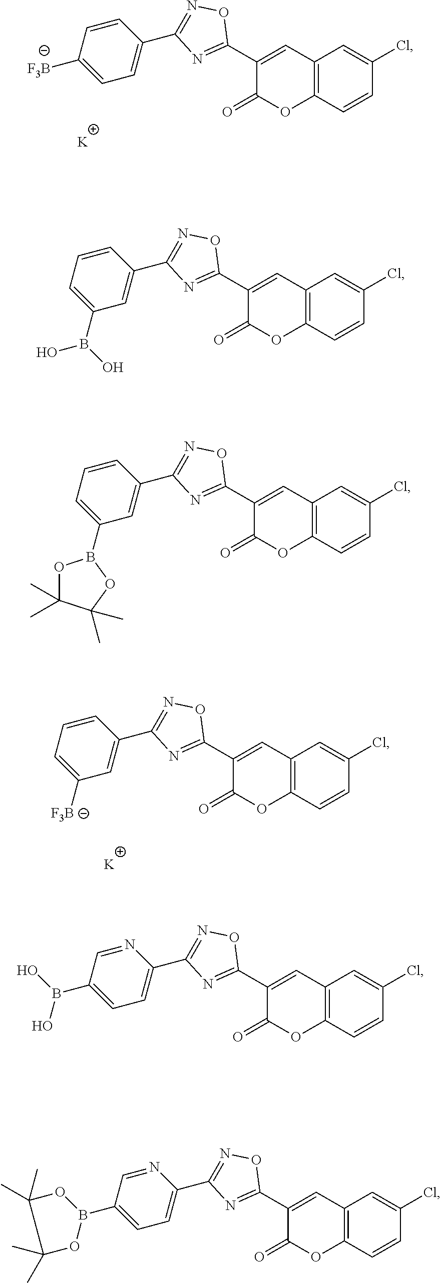

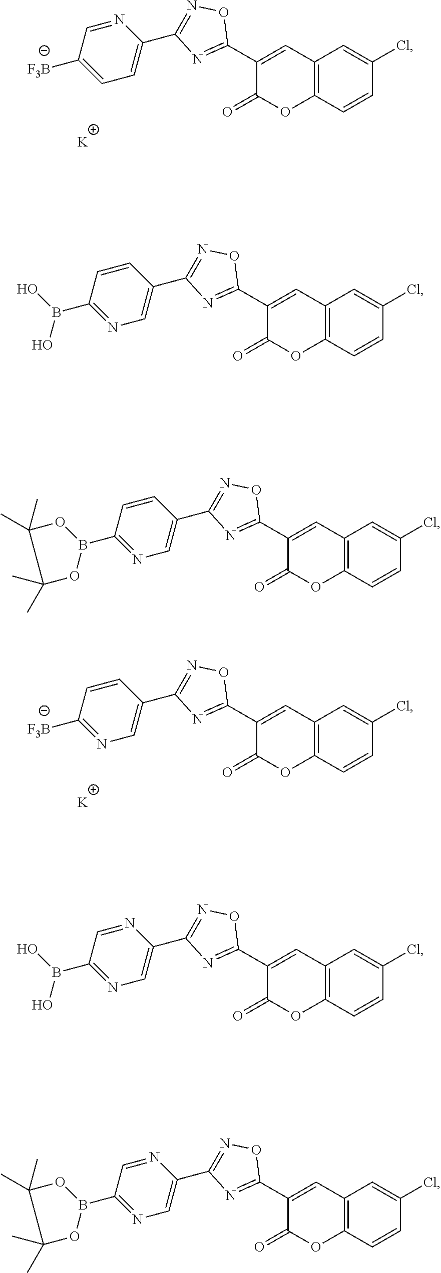

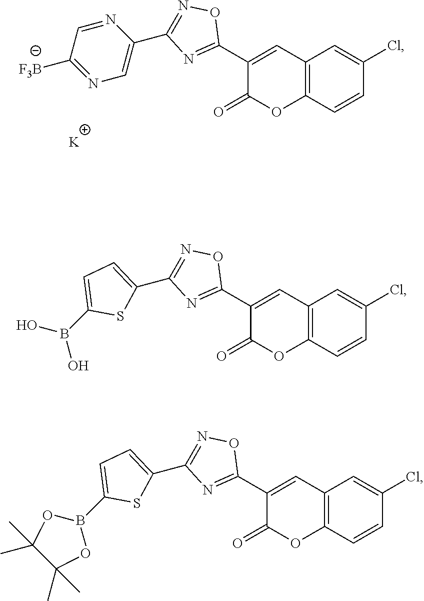

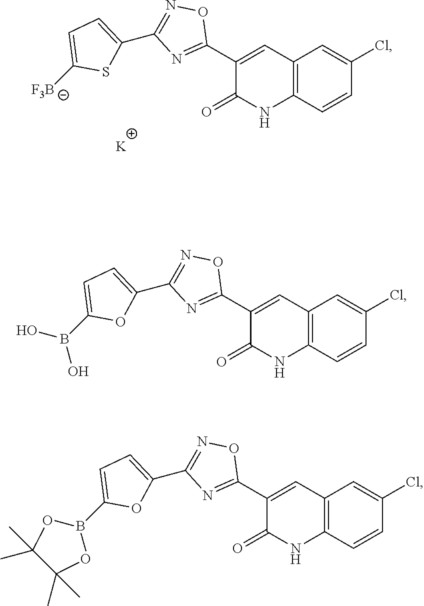

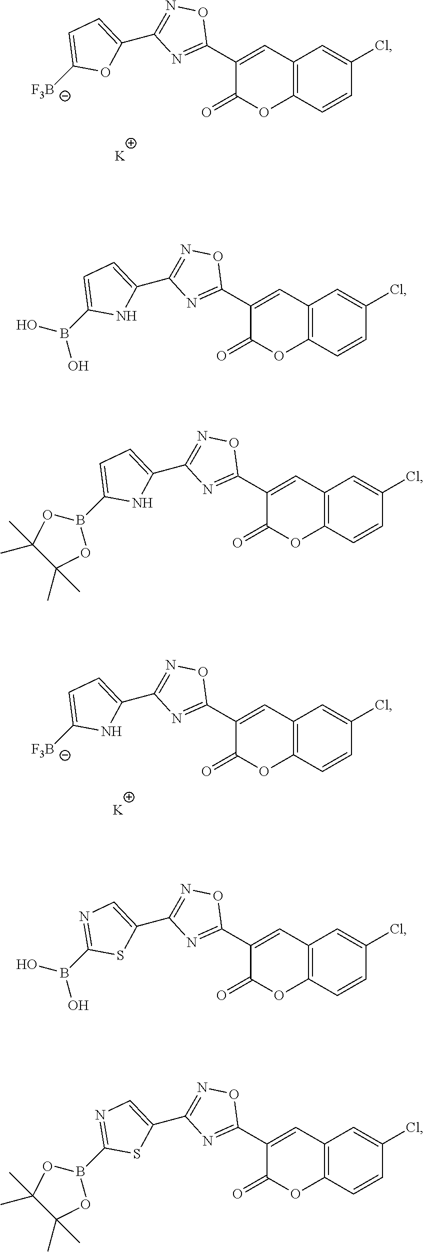

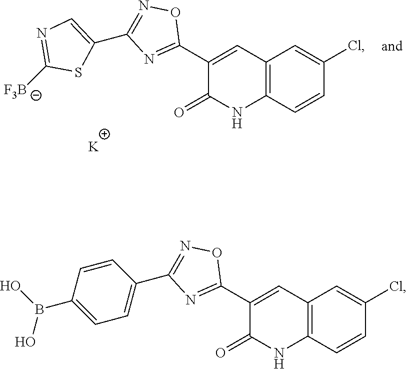

or a pharmaceutically acceptable salt thereof.

### E. BORON-CONTAINING QUINAZOLINONES

In one aspect, the invention relates to boron-containing quinazolinones. Quinazolinones have received significant attention in medicinal chemistry due to their wide range of biological applications such as antibacterial, anticonvulsant, antifungal, anticancer, anti-inflammatory, anti-HIV, and analgesic activities. Without wishing to be bound by theory, it is believed that the instantly disclosed boron-containing quinazolinones can be useful as pharmaceutically active agents, and in the development of alternative pharmaceutically active agents.

It is contemplated that each disclosed derivative can be optionally further substituted. It is also contemplated that any one or more derivative can be optionally omitted from the invention. It is understood that a disclosed compound can be provided by the disclosed methods. It is also understood that the disclosed compounds can be employed in the disclosed methods of using.

### 1. Structure

In one aspect, disclosed are compounds having a structure represented by a formula:

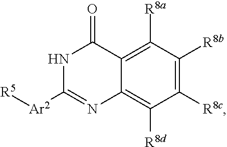

wherein R⁵ is selected from —B(OR¹⁵)₂ and —B(R¹⁶)₃X; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein X, when present, is a counterion; wherein each of R^{8a}, R^{8b}, R^{8c}, and R^{8d}, when present, is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; and wherein Ar² is selected from a C6-C10 aryl and a C2-C10 heteroaryl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a pharmaceutically acceptable salt thereof.

In various aspects, the compound has a structure represented by a formula selected from:

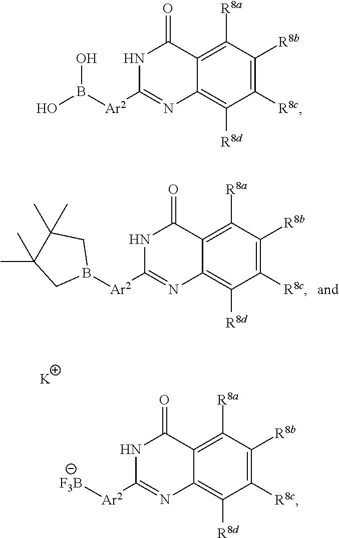

or a pharmaceutically acceptable salt thereof.

In various aspects, the compound has a structure represented by a formula:

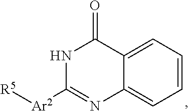

or a pharmaceutically acceptable salt thereof.

In various aspects, the compound has a structure represented by a formula selected from:

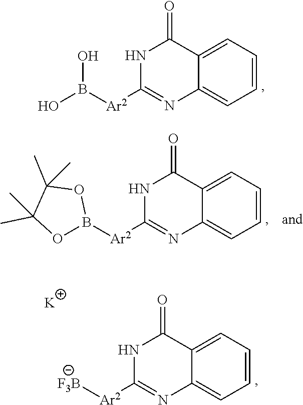

or a pharmaceutically acceptable salt thereof.

In various aspects, the compound is:

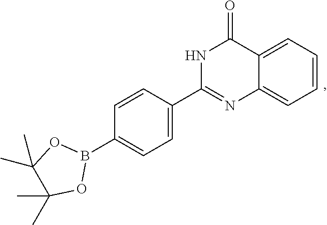 [SMILES: CC1(C)OB(c2ccc(-c3nc4ccccc4c(=O)[nH]3)cc2)OC1(C)C]

or a pharmaceutically acceptable salt thereof.

In various aspects, the compound is selected from:

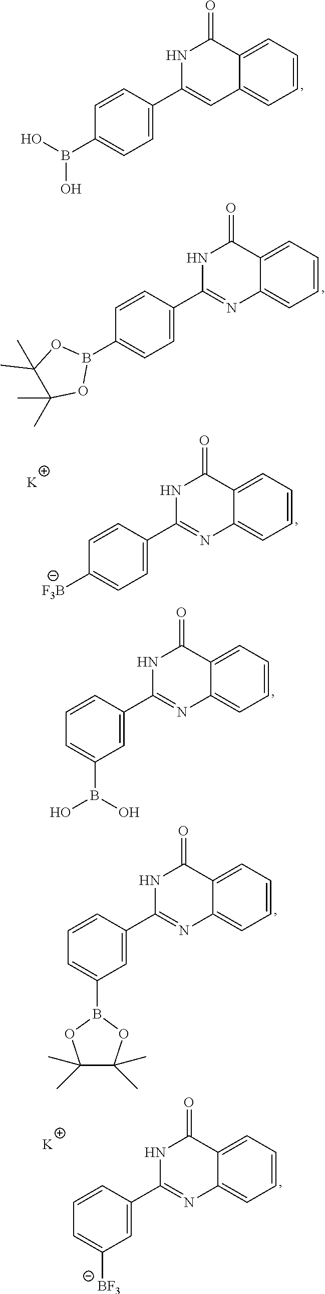

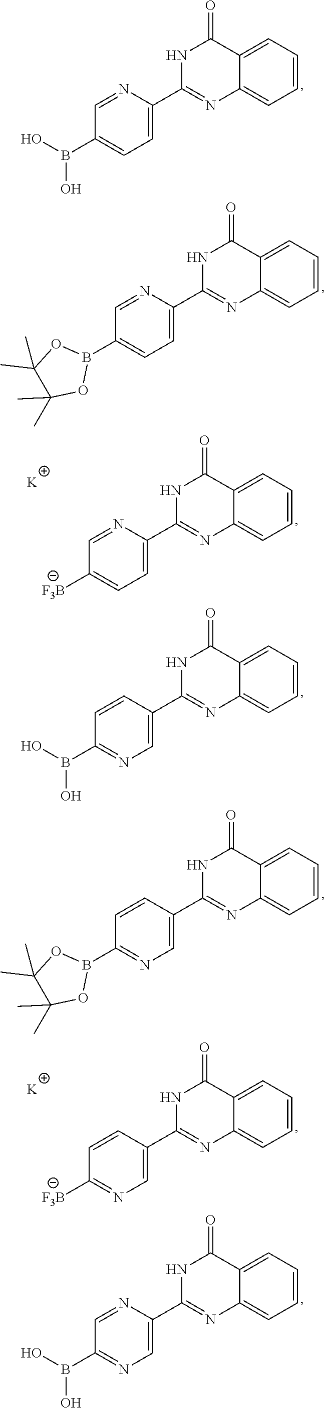

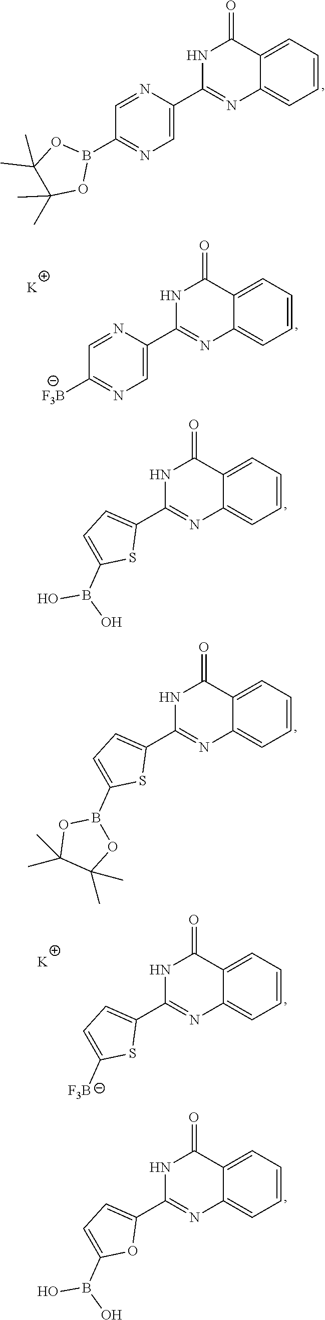

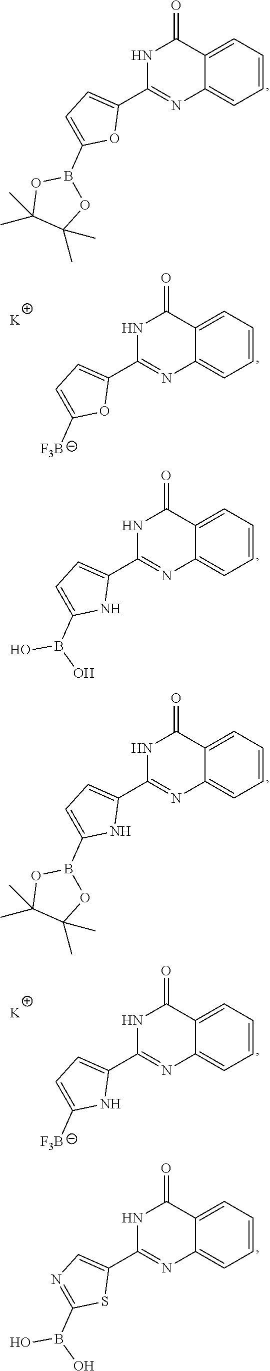

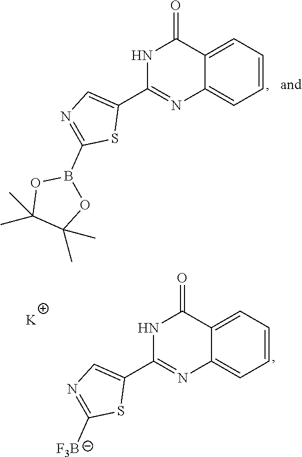

or a pharmaceutically acceptable salt thereof.

In various aspects, the compound is:

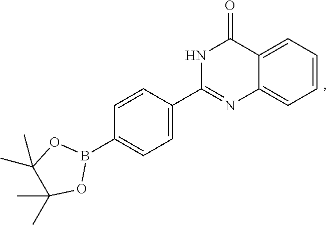 [SMILES: CC1(C)OB(c2ccc(-c3nc4ccccc4c(=O)[nH]3)cc2)OC1(C)C]

or a pharmaceutically acceptable salt thereof.
a. R⁵ Groups

In one aspect, R⁵ is selected from —B(OR¹⁵)₂ and —B(R¹⁶)₃. In a further aspect, R⁵ is —B(OR¹⁵)₂. In a still further aspect, R⁵ is —B(R¹⁶)₃.

b. R^{8A}, R^{8B}, R^{8C}, AND R^{8D} Groups

In one aspect, each of R^{8a}, R^{8b}, R^{8c}, and R^{8d}, when present, is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, each of R^{8a}, R^{8b}, R^{8c}, and R^{8d}, when present, is independently selected from hydrogen, —F, —Cl, —CN, —NH₂, —OH, —NO₂, methyl, ethyl, n-propyl, isopropyl, ethenyl, n-propenyl, isopropenyl, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, —CH(CH₃)CH₂CN, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, —OCH(CH₃)CH₃, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, each of R^{8a}, R^{8b}, R^{8c}, and R^{8d}, when present, is independently selected from hydrogen, —F, —Cl, —CN, —NH₂, —OH, —NO₂, methyl, ethyl, ethenyl, —CH₂F, —CH₂Cl, —CH₂CH₂F, —CH₂CH₂Cl, —CH₂CN, —CH₂CH₂CN, —CH₂OH, —CH₂CH₂OH, —OCF₃, —OCH₂CF₃, —OCH₃, —OCH₂CH₃, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, each of R^{8a}, R^{8b}, R^{8c}, and R^{8d}, when present, is independently selected from hydrogen, —F, —Cl, —CN, —NH₂, —OH, —NO₂, methyl, —CH₂F, —CH₂Cl, —CH₂CN, —CH₂OH, —OCF₃, —OCH₃, —NHCH₃, —N(CH₃)₂, and —CH₂NH₂.

In various aspects, each of R^{8a}, R^{8b}, R^{8c}, and R^{8d}, when present, is independently selected from hydrogen, halogen, —CN, —NH₂, —OH, —NO₂, C1-C4 alkyl, and C2-C4 alkenyl. In a further aspect, each of R^{8a}, R^{8b}, R^{8c}, and R^{8d}, when present, is independently selected from hydrogen, —F, —Cl, —CN, —NH₂, —OH, —NO₂, methyl, ethyl, n-propyl, isopropyl, ethenyl, n-propenyl, and isopropenyl. In a still further aspect, each of R^{8a}, R^{8b}, R^{8c}, and R^{8d}, when present, is independently selected from hydrogen, —F, —Cl, —CN, —NH₂, —OH, —NO₂, methyl, ethyl, and ethenyl. In yet a further aspect, each of R^{8a}, R^{8b}, R^{8c}, and R^{8d}, when present, is independently selected from hydrogen, —F, —Cl, —CN, —NH₂, —OH, —NO₂, and methyl.

In various aspects, each of R^{8a}, R^{8b}, R^{8c}, and R^{8d}, when present, is independently selected from hydrogen, halogen, —CN, —NH₂, —OH, —NO₂, C1-C4 haloalkyl, and C1-C4 cyanoalkyl. In a further aspect, each of R^{8a}, R^{8b}, R^{8c}, and R^{8d}, when present, is independently selected from hydrogen, —F, —Cl, —CN, —NH₂, —OH, —NO₂, —CH₂F, —CH₂Cl, —CH₂CH₂F, —CH₂CH₂Cl, —CH₂CH₂CH₂F, —CH₂CH₂CH₂Cl, —CH(CH₃)CH₂F, —CH(CH₃)CH₂Cl, —CH₂CN, —CH₂CH₂CN, —CH₂CH₂CH₂CN, and —CH(CH₃)CH₂CN. In a still further aspect, each of R^{8a}, R^{8b}, R^{8c}, and R^{8d}, when present, is independently selected from hydrogen, —F, —Cl, —CN, —NH₂, —OH, —NO₂, —CH₂F, —CH₂Cl, —CH₂CH₂F, —CH₂CH₂Cl, —CH₂CN, and —CH₂CH₂CN. In yet a further aspect, each of R^{8a}, R^{8b}, R^{8c}, and R^{8d}, when present, is independently selected from hydrogen, —F, —Cl, —CN, —NH₂, —OH, —NO₂, —CH₂F, —CH₂Cl, and —CH₂CN.

In various aspects, each of R^{8a}, R^{8b}, R^{8c}, and R^{8d}, when present, is independently selected from hydrogen, halogen, —CN, —NH₂, —OH, —NO₂, C1-C4 hydroxyalkyl, C1-C4 haloalkoxy, and C1-C4 alkoxy. In a further aspect, each of R^{8a}, R^{8b}, R^{8c}, and R^{8d}, when present, is independently selected from hydrogen, —F, —Cl, —CN, —NH₂, —OH, —NO₂, —CH₂OH, —CH₂CH₂OH, —CH₂CH₂CH₂OH, —CH(CH₃)CH₂OH, —OCF₃, —OCH₂CF₃, —OCH₂CH₂CF₃, —OCH(CH₃)CF₃, —OCH₃, —OCH₂CH₃, —OCH₂CH₂CH₃, and —OCH(CH₃)CH₃. In a still further aspect, each of R^{8a}, R^{8b}, R^{8c}, and R^{8d}, when present, is independently selected from hydrogen, —F, —Cl, —CN, —NH₂, —OH, —NO₂, —CH₂OH, —CH₂CH₂OH, —OCF₃, —OCH₂CF₃, —OCH₃, and —OCH₂CH₃. In yet a further aspect, each of R^{8a}, R^{8b}, R^{8c}, and R^{8d}, when present, is independently selected from hydrogen, —F, —Cl, —CN, —NH₂, —OH, —NO₂, —CH₂OH, —OCF₃, and —OCH₃.

In various aspects, each of R^{8a}, R^{8b}, R^{8c}, and R^{8d}, when present, is independently selected from hydrogen, halogen, —CN, —NH₂, —OH, —NO₂, C1-C4 alkylamino, (C1-C4)(C1-C4) dialkylamino, and C1-C4 aminoalkyl. In a further aspect, each of R^{8a}, R^{8b}, R^{8c}, and R^{8d}, when present, is independently selected from hydrogen, —F, —Cl, —CN, —NH₂, —OH, —NO₂, —NHCH₃, —NHCH₂CH₃, —NHCH₂CH₂CH₃, —NHCH(CH₃)CH₃, —N(CH₃)₂, —N(CH₂CH₃)₂, —N(CH₂CH₂CH₃)₂, —N(CH(CH₃)CH₃)₂, —N(CH₃)(CH₂CH₃), —CH₂NH₂, —CH₂CH₂NH₂, —CH₂CH₂CH₂NH₂, and —CH(CH₃)CH₂NH₂. In a still further aspect, each of R^{8a}, R^{8b}, R^{8c}, and R^{8d}, when present, is independently selected from hydrogen, —F, —Cl, —CN, —NH₂, —OH, —NO₂, —NHCH₃, —NHCH₂CH₃, —N(CH₃)₂, —N(CH₂CH₃)₂, —N(CH₃)(CH₂CH₃), —CH₂NH₂, and —CH₂CH₂NH₂. In yet a further aspect, each of R^{8a}, R^{8b}, R^{8c}, and R^{8d}, when present, is independently selected from hydrogen, —F, —Cl, —CN, —NH₂, —OH, —NO₂, —NHCH₃, —N(CH₃)₂, and —CH₂NH₂.

In a further aspect, each of R^{8a}, R^{8b}, R^{8c}, and R^{8d}, when present, is independently selected from hydrogen and C1-C4 alkyl. In a still further aspect, each of R^{8a}, R^{8b}, R^{8c}, and R^{8d}, when present, is independently selected from hydrogen, methyl, ethyl, n-propyl, and isopropyl. In yet a further aspect, each of R^{8a}, R^{8b}, R^{8c}, and R^{8d}, when present, is independently selected from hydrogen, methyl, and ethyl. In an even further aspect, each of R^{8a}, R^{8b}, R^{8c}, and R^{8d}, when present, is independently selected from hydrogen and ethyl. In a still further aspect, each of R^{8a}, R^{8b}, R^{8c}, and R^{8d}, when present, is independently selected from hydrogen and methyl.

In a further aspect, each of R^{8a}, R^{8b}, R^{8c}, and R^{8d}, when present, is independently selected from hydrogen and halogen. In a still further aspect, each of R^{8a}, R^{8b}, R^{8c}, and R^{8d}, when present, is independently selected from hydrogen, —F, —Cl, and —Br. In yet a further aspect, each of R^{8a}, R^{8b}, R^{8c}, and R^{8d}, when present, is independently selected from hydrogen, —F, and —Cl. In an even further aspect, each of R^{8a}, R^{8b}, R^{8c}, and R^{8d}, when present, is independently selected from hydrogen and —Cl. In a still further aspect, each of R^{8a}, R^{8b}, R^{8c}, and R^{8d}, when present, is independently selected from hydrogen and —F.

In a further aspect, each of R^{8a}, R^{8b}, R^{8c}, and R^{8d}, when present, is hydrogen.

c. R¹⁵ Groups

In one aspect, each occurrence of R¹⁵, when present, is independently selected from hydrogen and C1-C8 alkyl, or each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups.

In various aspects, each occurrence of R¹⁵, when present, is independently selected from hydrogen and C1-C8 alkyl. In a further aspect, each occurrence of R¹⁵, when present, is independently selected from hydrogen and C1-C4 alkyl. In a still further aspect, each occurrence of R¹⁵, when present, is independently selected from hydrogen, methyl, ethyl, n-propyl, and isopropyl. In yet a further aspect, each occurrence of R¹⁵, when present, is independently selected from hydrogen, methyl, and ethyl. In an even further aspect, each occurrence of R¹⁵, when present, is independently selected from hydrogen and ethyl. In a still further aspect, each occurrence of R¹⁵, when present, is independently selected from hydrogen and methyl.

In various aspects, each occurrence of R¹⁵, when present, is C1-C8 alkyl. In a further aspect, each occurrence of R¹⁵, when present, is C1-C4 alkyl. In a still further aspect, each occurrence of R¹⁵, when present, is independently selected from methyl, ethyl, n-propyl, and isopropyl. In yet a further aspect, each occurrence of R¹⁵, when present, is independently selected from methyl and ethyl. In an even further aspect, each occurrence of R¹⁵, when present, is ethyl. In a still further aspect, each occurrence of R¹⁵, when present, is methyl.

In various aspects, each occurrence of R¹⁵, when present, is hydrogen.

In various aspects, each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups. In a further aspect, each occurrence of R¹⁵, when present, is covalently bonded together, and, together with the intermediate atoms, comprise a C6 bicyclic heterocycle or a C2-C3 heterocycloalkyl, and is substituted with 0, 1, 2, or 3 C1-C4 alkyl groups. In yet a further aspect, each occurrence of R¹⁵, when present, is covalently bonded together, and, together with the intermediate atoms, comprise a C6 bicyclic heterocycle or a C2-C3 heterocycloalkyl, and is substituted with 0, 1, or 2 C1-C4 alkyl groups. In an even further aspect, each occurrence of v when present, is covalently bonded together, and, together with the intermediate atoms, comprise a C6 bicyclic heterocycle or a C2-C3 heterocycloalkyl, and is substituted with 0 or 1 C1-C4 alkyl groups. In a still further aspect, each occurrence of R¹⁵, when present, is covalently bonded together, and, together with the intermediate atoms, comprise a C6 bicyclic heterocycle or a C2-C3 heterocycloalkyl, and is monosubstituted with a C1-C4 alkyl group. In yet a further aspect, each occurrence of R¹⁵, when present, is covalently bonded together, and, together with the intermediate atoms, comprise a C6 bicyclic heterocycle or a C2-C3 heterocycloalkyl, and is unsubstituted.

In a further aspect, each occurrence of R¹⁵, when present, is covalently bonded together, and, together with the intermediate atoms, comprise a C6 bicyclic heterocycle substituted with 0, 1, 2, 3, or 4 C1-C4 alkyl groups. In a still further aspect, each occurrence of R¹⁵, when present, is covalently bonded together, and, together with the intermediate atoms, comprise a C6 bicyclic heterocycle substituted with 0, 1, 2, or 3 C1-C4 alkyl groups. In yet a further aspect, each occurrence of R¹⁵, when present, is covalently bonded together, and, together with the intermediate atoms, comprise a C6 bicyclic heterocycle substituted with 0, 1, or 2 C1-C4 alkyl groups. In an even further aspect, each occurrence of R¹⁵, when present, is covalently bonded together, and, together with the intermediate atoms, comprise a C6 bicyclic heterocycle substituted with 0 or 1 C1-C4 alkyl groups. In a still further aspect, each occurrence of R¹⁵, when present, is covalently bonded together, and, together with the intermediate atoms, comprise a C6 bicyclic heterocycle monosubstituted with a C1-C4 alkyl group. In yet a further aspect, each occurrence of R¹⁵, when present, is covalently bonded together, and, together with the intermediate atoms, comprise an unsubstituted C6 bicyclic heterocycle.

In a further aspect, each occurrence of R¹⁵, when present, is covalently bonded together, and, together with the intermediate atoms, comprise a C6 bicyclic heterocycle substituted with 4 C1-C4 alkyl groups. In a still further aspect, each occurrence of R¹⁵, when present, is covalently bonded together, and, together with the intermediate atoms, comprise a C6 bicyclic heterocycle substituted with 4 groups selected from methyl, ethyl, n-propyl, and isopropyl. In yet a further aspect, each occurrence of R¹⁵, when present, is covalently bonded together, and, together with the intermediate atoms, comprise a C6 bicyclic heterocycle substituted with 4 groups selected from methyl and ethyl. In an even further aspect, each occurrence of R¹⁵, when present, is covalently bonded together, and, together with the intermediate atoms, comprise a C6 bicyclic heterocycle substituted with 4 methyl groups.

In a further aspect, each occurrence of R¹⁵, when present, is covalently bonded together, and, together with the intermediate atoms, comprise a C2-C3 heterocycloalkyl substituted with 0, 1, 2, 3, or 4 C1-C4 alkyl groups. In a still further aspect, each occurrence of R¹⁵, when present, is covalently bonded together, and, together with the intermediate atoms, comprise a C2-C3 heterocycloalkyl substituted with 0, 1, 2, or 3 C1-C4 alkyl groups. In yet a further aspect, each occurrence of R¹⁵, when present, is covalently bonded together, and, together with the intermediate atoms, comprise a C2-C3 heterocycloalkyl substituted with 0, 1, or 2 C1-C4 alkyl groups. In an even further aspect, each occurrence of R¹⁵, when present, is covalently bonded together, and, together with the intermediate atoms, comprise a C2-C3 heterocycloalkyl substituted with 0 or 1 C1-C4 alkyl groups. In a still further aspect, each occurrence of R¹⁵, when present, is covalently bonded together, and, together with the intermediate atoms, comprise a C2-C3 heterocycloalkyl monosubstituted with a C1-C4 alkyl group. In yet a further aspect, each occurrence of R¹⁵, when present, is covalently bonded together, and, together with the intermediate atoms, comprise an unsubstituted C2-C3 heterocycloalkyl.

In a further aspect, each occurrence of R¹⁵, when present, is covalently bonded together, and, together with the intermediate atoms, comprise a C2-C3 heterocycloalkyl substituted with 4 C1-C4 alkyl groups. In a still further aspect, each occurrence of R¹⁵, when present, is covalently bonded together, and, together with the intermediate atoms, comprise a C2-C3 heterocycloalkyl substituted with 4 groups selected from methyl, ethyl, n-propyl, and isopropyl. In yet a further aspect, each occurrence of R¹⁵, when present, is covalently bonded together, and, together with the intermediate atoms, comprise a C2-C3 heterocycloalkyl substituted with 4 groups selected from methyl and ethyl. In an even further aspect, each occurrence of R¹⁵, when present, is covalently bonded together, and, together with the intermediate atoms, comprise a C2-C3 heterocycloalkyl substituted with 4 methyl groups.

d. R¹⁶ Groups

In one aspect, each occurrence of R¹⁶, when present, is independently halogen. In a further aspect, each occurrence of R¹⁶, when present, is independently selected from —F, —Cl, and —Br. In a still further aspect, each occurrence of R¹⁶, when present, is independently selected from —F and —Cl. In yet a further aspect, each occurrence of R¹⁶, when present, is independently selected from —F and —Br. In an even further aspect, each occurrence of R¹⁶, when present, is independently selected from —Cl and —Br. In a still further aspect, each occurrence of R¹⁶, when present, is —I. In yet a further aspect, each occurrence of R¹⁶, when present, is —Br. In an even further aspect, each occurrence of R¹⁶, when present, is —Cl. In a still further aspect, each occurrence of R¹⁶, when present, is —F.

e. AR² Groups

In one aspect, Ar² is selected from a C6-C10 aryl and a C2-C10 heteroaryl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, Ar² is selected from a C6-C10 aryl and a C2-C10 heteroaryl, and is substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar² is selected from a C6-C10 aryl and a C2-C10 heteroaryl, and is substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar² is selected from a C6-C10 aryl and a C2-C10 heteroaryl, and is monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar² is selected from a C6-C10 aryl and a C2-C10 heteroaryl, and is unsubstituted.

In various aspects, Ar² is a C6-C10 aryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. Examples of C6-C10 aryls include, but are not limited to, phenyl, naphthyl, and anthracenyl. In a further aspect, Ar² is a C6-C10 aryl substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar² is a C6-C10 aryl substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar² is a C6-C10 aryl monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar² is unsubstituted C6-C10 aryl.

In various aspects, Ar² is phenyl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, Ar² is phenyl substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar² is phenyl substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar² is phenyl monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar² is unsubstituted phenyl.

In various aspects, Ar² is a C2-C10 heteroaryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. Examples of C2-C10 heteroaryls include, but are not limited to, furanyl, thiophenyl, pyrrolyl, benzo[d]thiazole, pyrazolyl, imidazolyl, triazolyl, oxazolyl, thiazolyl, pyridinyl, pyrimidinyl, imidazolyl, purinyl, indolyl, and quinolinyl. In a further aspect, Ar² is a C2-C10 heteroaryl substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar² is a C2-C10 heteroaryl substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar² is a C2-C10 heteroaryl monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar² is an unsubstituted C2-C10 heteroaryl.

In various aspects, Ar² is selected from furanyl, thiophenyl, pyrrolyl, benzo[d]thiazole, pyrazolyl, imidazolyl, triazolyl, oxazolyl, thiazolyl, pyrimidinyl, imidazolyl, purinyl, indolyl, and quinolinyl.

In various aspects, Ar² is selected from furanyl, thiophenyl, pyrrolyl, and thiazolyl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a further aspect, Ar² is selected from furanyl, thiophenyl, pyrrolyl, and thiazolyl, and is substituted with 0, 1, or 2 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In a still further aspect, Ar² is selected from furanyl, thiophenyl, pyrrolyl, and thiazolyl, and is substituted with 0 or 1 group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In yet a further aspect, Ar² is selected from furanyl, thiophenyl, pyrrolyl, and thiazolyl, and is monosubstituted with a group selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino. In an even further aspect, Ar² is selected from furanyl, thiophenyl, pyrrolyl, and thiazolyl, and is unsubstituted.

### 2. Boron-Containing Quinazolinone Examples

In one aspect, a compound can be present as:

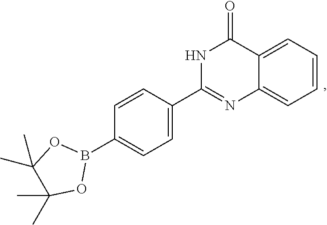 [SMILES: CC1(C)OB(c2ccc(-c3nc4ccccc4c(=O)[nH]3)cc2)OC1(C)C]

or a pharmaceutically acceptable salt thereof.

### 3. Prophetic Boron-Containing Quinazolinones

The following compound examples are prophetic, and can be prepared using the synthesis methods described herein above and other general methods as needed as would be known to one skilled in the art. It is anticipated that the prophetic compounds would be useful as pharmaceutically active agents, and in the generation of alternative pharmaceutically active agents, and such utility can be determined using the synthetic methods described herein below.

In one aspect, a compound can be selected from:

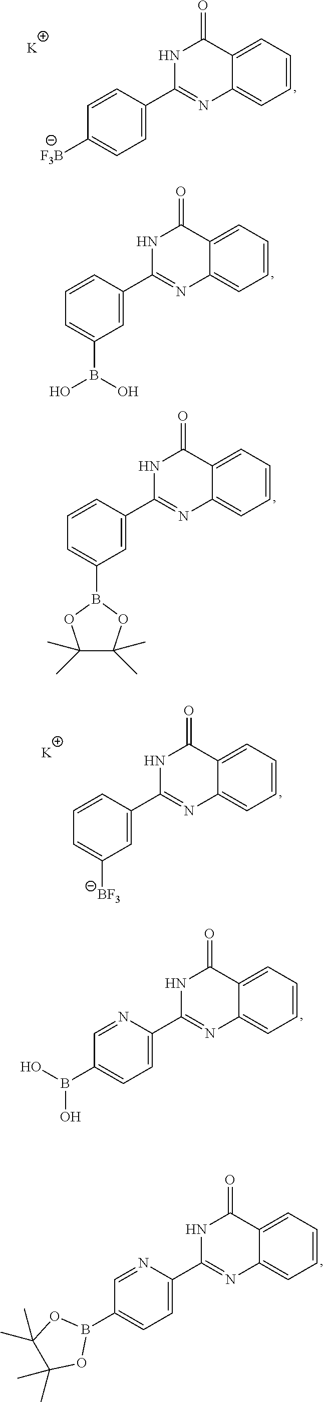

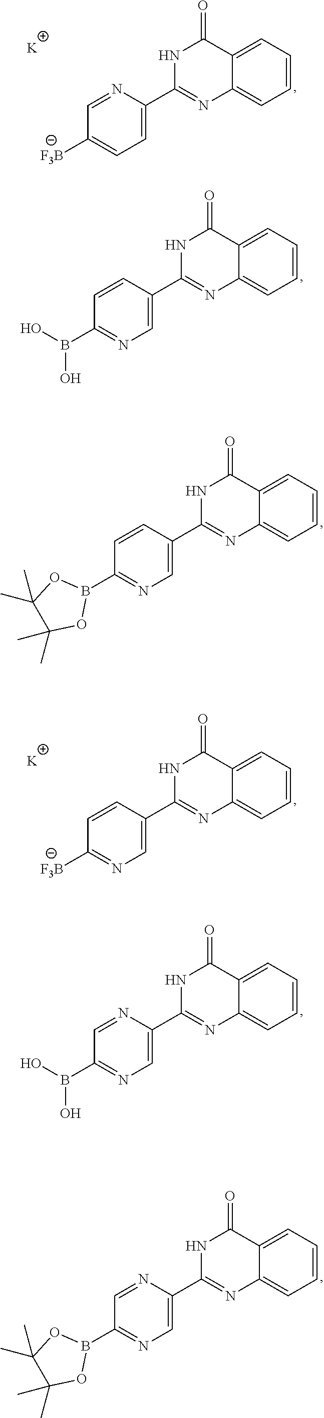

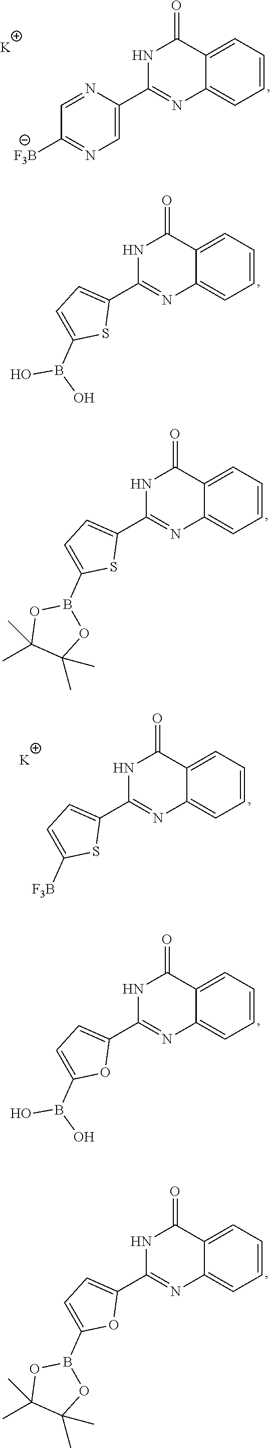

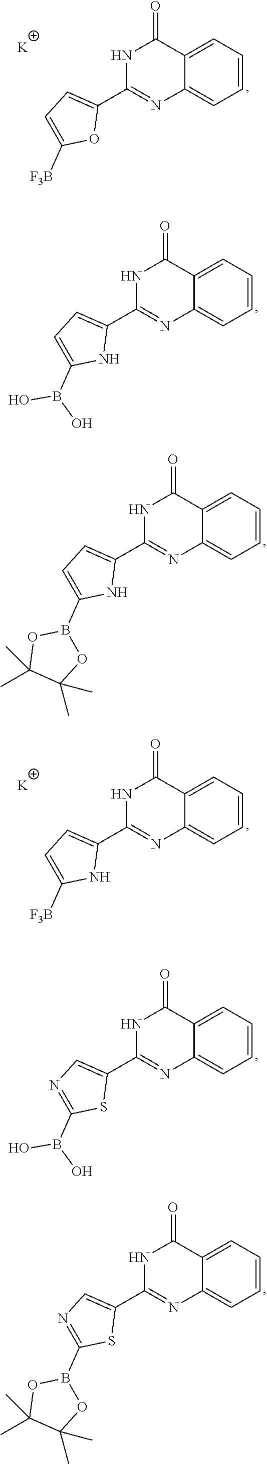

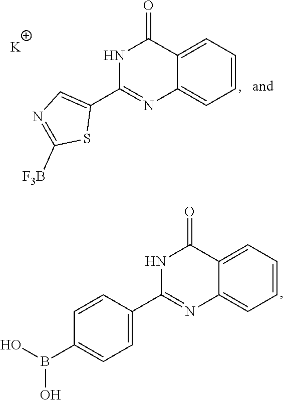

or a pharmaceutically acceptable salt thereof.

### F. EXEMPLARY METHODS OF USING BORYLATED AMIDOXIMES

Without wishing to be bound by theory, the disclosed borylated amidoximes are useful in the synthesis of a variety of pharmaceuticals and biologically significant small molecules. Thus, in various aspects, the disclosed borylated amidoximes offer a variety of advantages overall alternative synthetic reagents and routes to access such small molecules including, but not limited to, a metal-free route to boronated oxadiazole and quinazolinone derivatives, and restriction of multistep sequences.

In one aspect, disclosed are methods of making a compound having a structure represented by a formula:

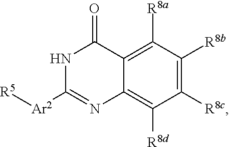

wherein R⁵ is selected from —B(OR¹⁵)₂ and —B(R¹⁶)₃; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein each of R^{8a}, R^{8b}, R^{8c}, and R^{8d}, when present, is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; and wherein Ar² is selected from a C6-C10 aryl and a C2-C10 heteroaryl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a pharmaceutically acceptable salt thereof, the method comprising reacting an amidoxime having a structure represented by a formula:

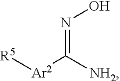

and a carboxylic acid having a structure represented by a formula:

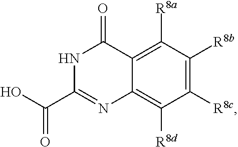

thereby making the compound.

In one aspect, disclosed are methods of making a compound having a structure represented by a formula:

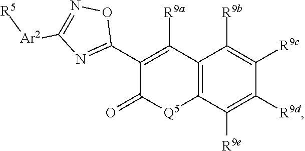

wherein Q⁵ is selected from O and NR²¹; wherein R²¹, when present, is selected from hydrogen and C1-C4 alkyl; wherein R⁵ is selected from —B(OR¹⁵)₂ and —B(R¹⁶)₃X; wherein each occurrence of R¹⁵, when present, is independently selected from hydrogen and C1-C8 alkyl, or wherein each occurrence of R¹⁵, when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups; wherein each occurrence of R¹⁶, when present, is independently halogen; wherein X, when present, is a counterion; wherein each of R^{9a}, R^{9b}, R^{9c}, R^{9d}, and R^{9e}, when present, is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino; and wherein Ar² is selected from a C6-C10 aryl and a C2-C10 heteroaryl, and is substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino, or a pharmaceutically acceptable salt thereof, the method comprising reacting an amidoxime having a structure represented by a formula:

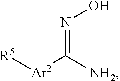

and a carboxylic acid having a structure represented by a formula:

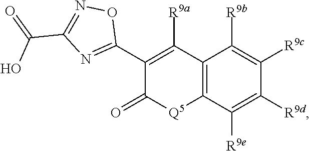

in the presence of a coupling agent, thereby making the compound.

In various aspects, Ar² is a C6-C10 aryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino.

In various aspects, Ar² is a C2-C10 heteroaryl substituted with 0, 1, 2, or 3 groups independently selected from halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino.

In various aspects, Ar² is selected from furanyl, thiophenyl, pyrrolyl, benzo[d]thiazole, pyrazolyl, imidazolyl, triazolyl, oxazolyl, thiazolyl, pyrimidinyl, imidazolyl, purinyl, indolyl, and quinolinyl.

In various aspects, the compound has a structure represented by a formula selected from:

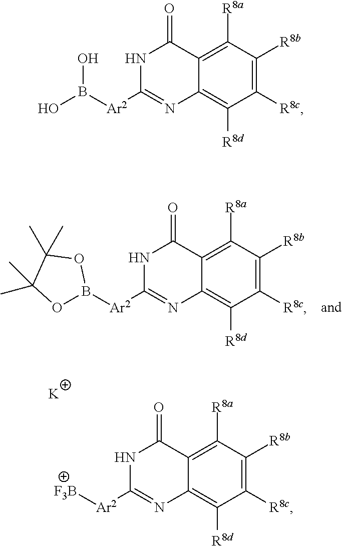

or a pharmaceutically acceptable salt thereof.

In various aspects, the compound has a structure represented by a formula:

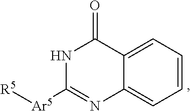

or a pharmaceutically acceptable salt thereof.

In various aspects, the compound has a structure represented by a formula selected from:

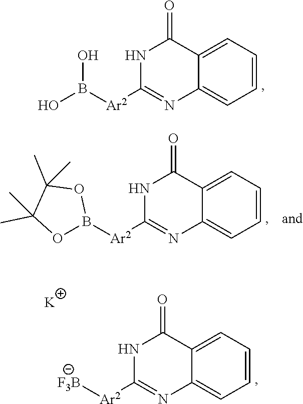

or a pharmaceutically acceptable salt thereof.

In various aspects, the compound is:

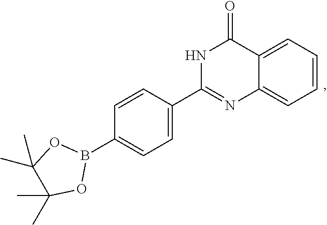 [SMILES: CC1(C)OB(c2ccc(-c3nc4ccccc4c(=O)[nH]3)cc2)OC1(C)C]

or a pharmaceutically acceptable salt thereof.

In various aspects, the compound has a structure represented by a formula:

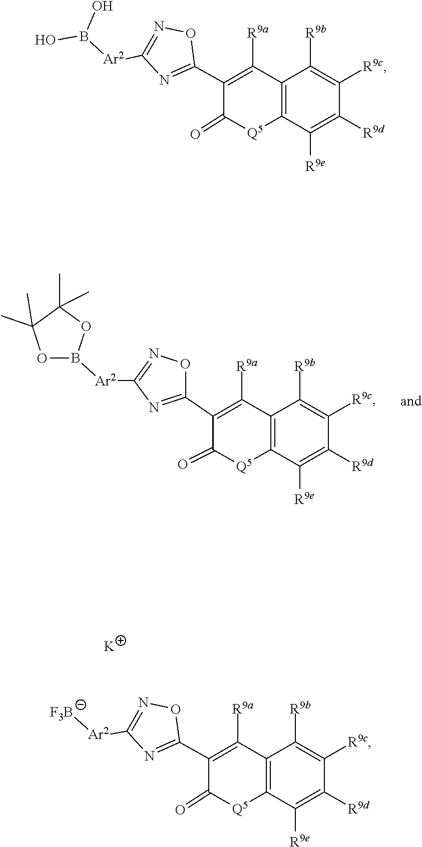

or a pharmaceutically acceptable salt thereof.

In various aspects, the compound has a structure represented by a formula:

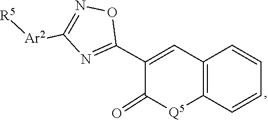

or a pharmaceutically acceptable salt thereof.

In various aspects, the compound has a structure represented by a formula:

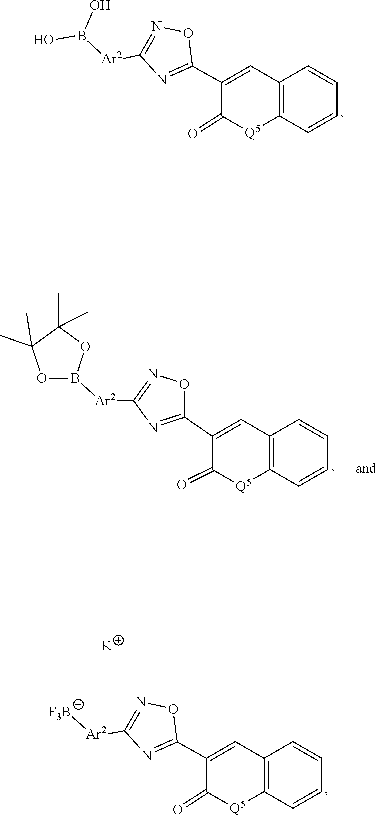

or a pharmaceutically acceptable salt thereof.

In various aspects, the compound has a structure represented by a formula selected from:

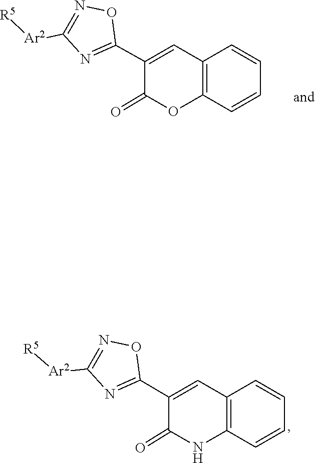

or a pharmaceutically acceptable salt thereof.

In various aspects, the compound is selected from:

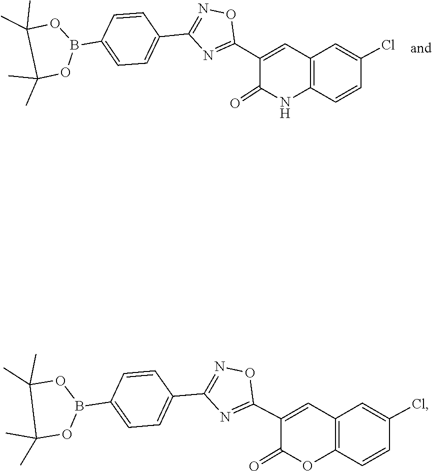 [SMILES: CC1(C)OB(c2ccc(-c3noc(-c4cc5cc(Cl)ccc5[nH]c4=O)n3)cc2)OC1(C)C ; CC1(C)OB(c2ccc(-c3noc(-c4cc5cc(Cl)ccc5oc4=O)n3)cc2)OC1(C)C]

or a pharmaceutically acceptable salt thereof.

In various aspects, reacting is in the presence of a coupling agent. In a further aspect, the coupling agent is a carbodiimide coupling agent. Examples of carbodiimide coupling agents include, but are not limited to, dicyclohexylcarbodiimide (DCC), diisopropylcarbodiimide (DIC), and 1-ethyl-3-(3-dimethylaminopropyl)carbodiimide (EDC). In a further aspect, the carbodiimide coupling agent is diisopropylcarbodiimide (DIC).

In various aspects, reacting is in the presence of an activating agent. In a further aspect, the activating agent is an iron salt or an aluminum salt. In a still further aspect, the activating agent is selected from sodium aluminate, ferric sulfate, aluminum chloride, and ferric chloride (iron (III) chloride). In yet a further aspect, the activating agent is iron (III) chloride.

In various aspects, reacting is in a polar solvent. Examples of polar solvents include, but are not limited to, acetone, acetonitrile, dichloromethane, dimethylsulfoxide, 1,4-dioxane, and ethyl acetate. In a further aspect, the polar solvent is 1,4-dioxane.

In various aspects, reacting is in a polar aprotic solvent. Examples of polar aprotic solvents include, but are not limited to, acetone, acetonitrile, dichloromethane, dimethylsulfoixde, and ethyl acetate. In a further aspect, the polar aprotic solvent is dimethylformamide (DMF).

In various aspects, reacting is at an elevated temperature. In a further aspect, the temperature is at least about 40° C., at least about 50° C., at least about 60° C., at least about 70° C., or at least about 80° C. In a still further aspect, the temperature is about 40° C., about 45° C., about 50° C., about 55° C., about 60° C., about 65° C., about 70° C., about 75° C., about 80° C., about 85° C., or about 90° C.

In various aspects, the method further comprises reacting an aryl cyanide having a structure represented by a formula:

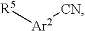

and a hydroxylamine, thereby making the amidoxime. In a further aspect, the method of making the amidoxime is as detailed further elsewhere herein.

The compounds of this invention can be prepared by employing reactions as shown in the following schemes, in addition to other standard manipulations that are known in the literature, exemplified in the experimental sections or clear to one skilled in the art. For clarity, examples having a single substituent are shown where multiple substituents are allowed under the definitions disclosed herein.

Reactions used to generate the compounds of this invention are prepared by employing reactions as shown in the following Reaction Schemes, as described and exemplified below. In certain specific examples, the disclosed compounds can be prepared by Routes I-II, as described and exemplified below. The following examples are provided so that the invention might be more fully understood, are illustrative only, and should not be construed as limiting.

### 1. Route I

In one aspect, boron-containing functionalized oxadiazoles can be prepared as shown below.

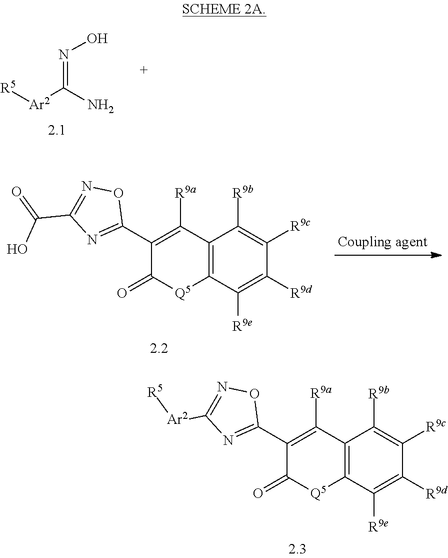

Compounds are represented in generic form, with substituents as noted in compound descriptions elsewhere herein. A more specific example is set forth below.

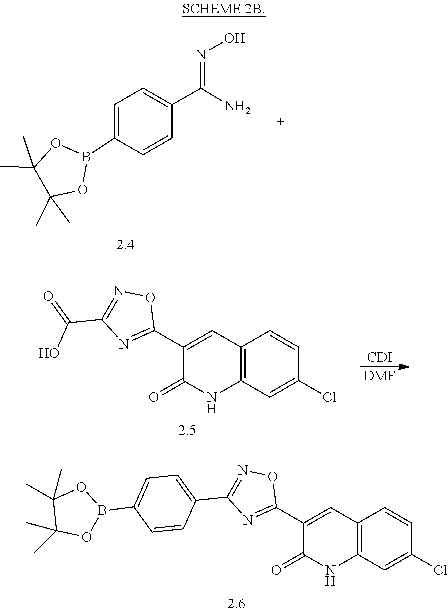

In one aspect, compounds of type 1.6 and similar compounds can be prepared according to reaction Scheme 2B above. Thus, compounds of type 2.6 can be prepared by reacting an appropriate borylate amidoxime, e.g., 2.4 as shown above, and an appropriate carboxylic acid, e.g., 2.5 as shown above. Appropriate borylated amidoximes can be prepared by, for example, the methods described elsewhere herein. Appropriate carboxylic acids are commercially available or prepared by methods known to one skilled in the art. The reaction is carried out in the presence of an appropriate coupling agent, e.g., 1,1′-carbonyldiimidazole (CDI) as shown above, in the presence of an appropriate solvent, e.g., dimethylformamide (DMF) as shown above. As can be appreciated by one skilled in the art, the above reaction provides an example of a generalized approach wherein compounds similar in structure to the specific reactants above (compounds similar to compounds of type 2.1 and 2.2) can be substituted in the reaction to provide boron-containing functionalized oxadiazoles similar to Formula 2.3 as shown above.

### 2. Route II

In one aspect, boron-containing quinazolinones can be prepared as shown below.

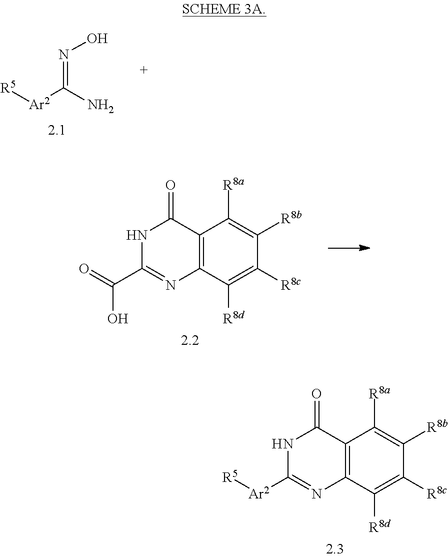

Compounds are represented in generic form, with substituents as noted in compound descriptions elsewhere herein. A more specific example is set forth below.

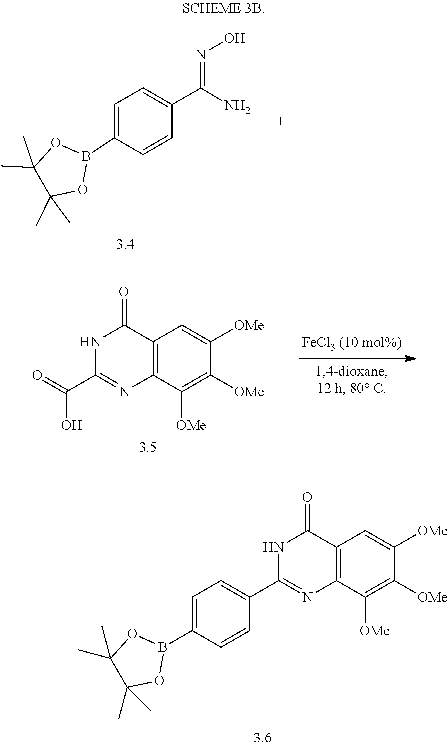 [SMILES: CC1(C)OB(c2ccc(/C(N)=N/O)cc2)OC1(C)C ; COc1cc2c(=O)[nH]c(C(=O)O)nc2c(OC)c1OC ; COc1cc2c(=O)[nH]c(-c3ccc(B4OC(C)(C)C(C)(C)O4)cc3)nc2c(OC)c1OC]

In one aspect, compounds of type 3.6 and similar compounds can be prepared according to reaction Scheme 3B above. Thus, compounds of type 3.6 can be prepared by reacting an appropriate borylated amidoxime, e.g., 3.4 as shown above, and an appropriate carboxylic acid, e.g., 3.5 as shown above. Appropriate borylated amidoximes can be prepared by, for example, the methods described elsewhere herein. Appropriate carboxylic acids are commercially available or prepared by methods known to one skilled in the art. The reaction is carried out in the presence of an appropriate activating agent, e.g., 10 mol % iron (III) chloride, in an appropriate solvent, e.g., 1.4-dioxane, at an appropriate temperature, e.g., 80° C., for an appropriate period of time, e.g., 12 hours. As can be appreciated by one skilled in the art, the above reaction provides an example of a generalized approach wherein compounds similar in structure to the specific reactants above (compounds similar to compounds of type 3.1 and 3.2) can be substituted in the reaction to provide boron-containing quinazolinones similar to Formula 3.3 as shown above.

### G. EXAMPLES

Without wishing to be bound by theory, the following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The Examples are provided herein to illustrate the invention, and should not be construed as limiting the invention in any way. Examples are provided herein to illustrate the invention and should not be construed as limiting the invention in any way.

### 1. Experimental Methods

### A. General Methods

All reagents were purchased from commercial sources and used without treatment, unless otherwise indicated. The products were purified by column chromatography over silica gel. ¹H NMR and ¹³C NMR spectra were recorded at 25° C. at 600, 500, and 400 MHz and 150, 125, and 100 MHz, respectively, with TMS as internal standard. Abbreviations for signal coupling are as follows: s, singlet; d, doublet; t, triplet; q, quartet; m, multiplet; br, broad. Column chromatography was performed using SiO₂ (0.060-0.2 mm, 70-230 mesh) from Alfa Aeser. All reagents were obtained from commercial sources.

### b. General Procedure for the Synthesis of Borylated Amidoximes

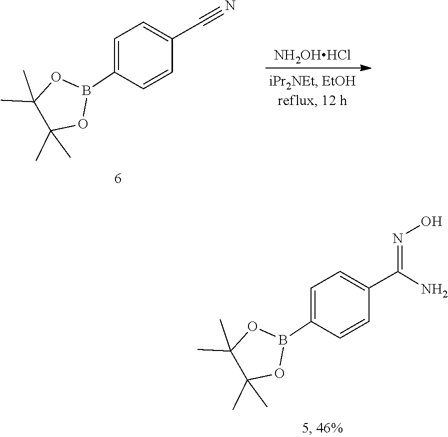 [SMILES: CC1(C)OB(c2ccc(C#N)cc2)OC1(C)C ; "NH2OH·HCl" ; CC1(C)OB(c2ccc(/C(N)=N/O)cc2)OC1(C)C]

(4-(4,4,5,5-tetramethyl-1,3,2-dioxaborolan-2-yl)benzonitrile (0.115 g, 0.5 mmol) was added into ethanol (2 mL) in a 50 mL round bottom flask. To this NH₂OH·HCl (1.0 mmol), IPr₂NEt (1.0 mmol) were added. The resultant reaction mixture was stirred at reflux for 20 hours. After completion of the reaction, ethanol was evaporated, the crude reaction mixture was crystallized from ethyl acetate-petroleum ether (1:4) mixture to obtain the pure product 5 (46%).

Z)—N′-hydroxy-4-(4,4,5,5-tetramethyl-1,3,2-dioxaborolan-2-yl)benzimidamide. White solid. Yield: 46%, ¹H NMR (500 MHz, DMSO-d₆) δ 9.75 (s, 1H), 7.72-7.64 (m, 4H), 5.85 (s, 2H), 1.30 (s, 12H). ¹³C NMR (125 MHz, DMSO) δ 150.5, 136.0, 134.1, 126.8, 124.7, 83.7, 24.6. HRMS (EI) Calcd. for C₁₃H₁₉BN₂O₃[M+H]⁺ requires 263.1561, found 263.1566.

### c. General Procedure for the Synthesis of Boron-Containing Functionalized Oxadiazole Derivatives

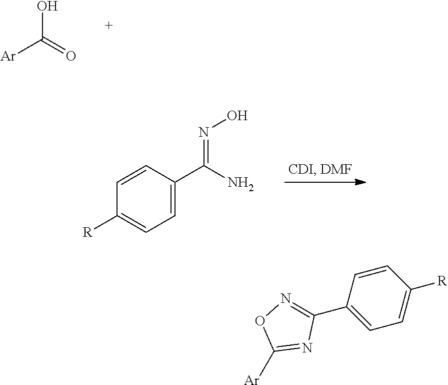

Acid 1 (0.5 mmol) and CDI (Carbonyl diimidazole) (0.5 mmol) were dissolved in 3.0 mL of DMF and stirred at room temperature. After 30 min, amidoxime (0.5 mmol) was added and the reaction mixture was stirred at 70-80° C. for 10 h (monitored by TLC). Then the mixture was poured into water (20.0 mL), extracted by ethyl acetate (3×15.0 mL), and the combined organic solvent was dried over Na₂SO₄, filtered and concentrated in vacuo. The crude product was purified by silica-gel chromatography to give the oxadiazole product.

### i. 3-(4-(4,4,5,5-tetramethyl-1,3,2-dioxaborolan-2-yl)phenyl)-5-(3,4,5-trimethoxyphenyl)-1,2,4-oxadiazole (4)

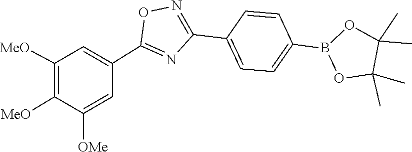 [SMILES: COc1cc(-c2nc(-c3ccc(B4OC(C)(C)C(C)(C)O4)cc3)no2)cc(OC)c1OC]

White solid. Yield: 45%. ¹H NMR (500 MHz, DMSO-d₆) δ 8.13 (d, J=7.8 Hz, 2H), 7.90 (d, J=7.8 Hz, 2H), 7.46 (s, 2H), 3.94 (s, 6H), 3.80 (s, 3H), 1.34 (s, 12H). ¹³C NMR (125 MHz, DMSO) δ 175.4, 168.0, 153.42, 141.6, 135.1, 128.5, 126.4, 118.3, 105.2, 84.0, 60.2, 56.2, 24.7. HRMS (EI) Calcd. for C₂₃H₂₇BN₂O₆[M+H]⁺ requires 439.2040, found 439.2041.

### ii. (4-(5-(3,4,5-trimethoxyphenyl)-1,2,4-oxadiazol-3-yl)phenyl)boronic acid (9)

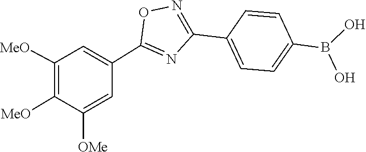 [SMILES: COc1cc(-c2nc(-c3ccc(B(O)O)cc3)no2)cc(OC)c1OC]

White solid. Yield: 43%, 1H NMR (DMSO, 300 MHz, TMS) δ 3.80 (s, 3H), 3.94 (s, 6H), 7.48 (s, 2H), 7.99 (d, J=8.4 Hz, 2H), 8.08 (d, J=8.4 Hz, 2H), 8.27 (d, J=2.4 Hz, 2H, B(OH)₂); ¹³C NMR (DMSO, 75 MHz, TMS) δ 56.4, 61.0, 84.1, 105.4, 119.3, 126.6, 129.2, 135.1, 142.0, 153.6, 169.0, 175.6. HRMS (EI) Calcd. for C₁₇H₁₇BN₂O₆ [M+H]⁺ requires 357.1252, found 357.1257.

### iii. 3-(4-(Trifluoro-l4-boranyl)phenyl)-5-(3,4,5-trimethoxyphenyl)-1,2,4-oxadiazole, potassium salt (8)

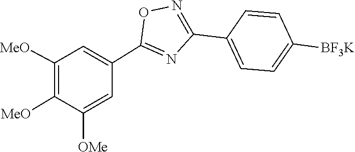

White solid. Yield: 52%, ¹H NMR (500 MHz, DMSO-d₆) δ 7.87 (d, J=7.5 Hz, 2H), 7.54 (d, J=7.5 Hz, 2H), 7.46 (s, 2H), 3.94 (s, 6H), 3.80 (s, 3H). ¹³C NMR (125 MHz, DMSO) δ 175.26, 169.56, 153.93, 142.01, 132.44, 125.64, 123.25, 119.17, 105.70, 60.75, 56.73. HRMS (EI) Calcd. for C₁₇H₁₅BF₃N₂O₄ [M-K]-requires 379.1077, found 379.1078.

### iv. 6-Chloro-3-(3-(4-(4,4,5,5-tetramethyl-1,3,2-dioxaborolan-2-yl)phenyl)-1,2,4-oxadiazol-5-yl)-2H-chromen-2-one (12)

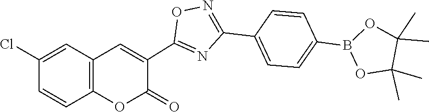 [SMILES: CC1(C)OB(c2ccc(-c3noc(-c4cc5cc(Cl)ccc5oc4=O)n3)cc2)OC1(C)C]

A yellow solid, Yield: 44%, ¹H NMR (DMSO, 600 MHz) δ 9.04 (s, 1H), 8.11 (d, J=2.4 Hz, 1H), 7.82 (d, J=9.0, 1H), 7.77 (m, 2H), 7.53 (d, J=8.4 Hz, 1H), 7.3 (d, J=9 Hz, 2H), 1.31 (s, 12H) ppm; ¹³C NMR (DMSO, 150 MHz) (8161.0, 155.03, 153.2, 149.1, 136.7, 134.1, 129.5, 129.0, 121.8, 119.5, 118.7, 118.2, 84.3, 25.1 ppm. HRMS (EI) Calcd. for C₂₃H₂₀BClN₂O₅[M+Na]⁺ requires 473.1051, found 473.3843.

### v. 6-chloro-3-(3-(4-(4,4,5,5-tetramethyl-1,3,2-dioxaborolan-2-yl)phenyl)-1,2,4-oxadiazol-5-yl)quinolin-2(1H)-one (13)

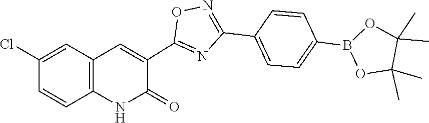 [SMILES: CC1(C)OB(c2ccc(-c3noc(-c4cc5cc(Cl)ccc5[nH]c4=O)n3)cc2)OC1(C)C]

A yellow solid, Yield: 39%, ¹H NMR (DMSO, 600 MHz) δ 8.90 (s, 1H), 8.30 (s, 2H), 8.01 (d, J=8.4, 2H), 7.93 (d, J=8.4 Hz, 2H), 7.40 (d, J=8.4 Hz, 1H), 6.72 (d, J=8.4 Hz, 1H), 1.26 (s, 12H); ¹³C NMR (DMSO, 150 MHz) δ 165.9, 160.8, 147.3, 146.2, 140.9, 136.8, 133.5, 132.7, 130.2, 128.0, 127.2, 126.9, 119.6, 115.6, 115.3, 83.6, 25.1. HRMS (EI) Calcd. for C₂₃H₂₁BClN₃O₄[M+H]⁺ requires 449.1314, found 449.1750.

### vi. 5-(6-Chloroimidazo[1,2-a]pyridin-3-yl)-3-(4-(4,4,5,5-tetramethyl-1,3,2-dioxaborolan-2-yl)phenyl)-1,2,4-oxadiazole (15a)

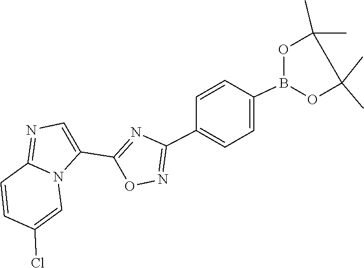 [SMILES: CC1(C)OB(c2ccc(-c3noc(-c4cnc5ccc(Cl)cn45)n3)cc2)OC1(C)C]

Off-White solid, Yield=51%, ¹H NMR (600 MHz, DMSO-d₆) δ 9.43 (s, 1H), 8.70 (s, 1H), 8.16 (d, J=7.2 Hz, 2H), 7.97 (d, J=9.6 Hz, 1H), 7.88 (d, J=7.8 Hz, 2H), 7.73 (d, J=9.6 Hz, 1H), 1.32 (s, 12H). ¹³C NMR (150 MHz, DMSO-d₆) δ 168.0, 167.9, 147.0, 140.9, 135.7, 134.7, 129.8, 127.1, 125.8, 122.6, 119.1, 116.9, 112.0, 84.6, 25.20. HRMS (ESI) calcd for C₂₁H₂₁BClN₄O₃ 423.1390 found 423.1393 [M+H]⁺.

### vii. 5-(6-Bromoimidazo[1,2-a]pyridin-3-yl)-3-(4-(4,4,5,5-tetramethyl-1,3,2-dioxaborolan-2-yl)phenyl)-1,2,4-oxadiazole (15b)

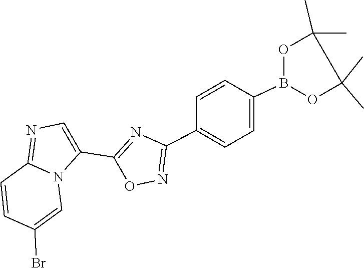 [SMILES: CC1(C)OB(c2ccc(-c3noc(-c4cnc5ccc(Br)cn45)n3)cc2)OC1(C)C]

White solid, Yield=47%, ¹H NMR (500 MHz, Chloroform-d) (9.69 (s, 1H), 8.54 (s, 1H), 8.23-8.18 (m, 2H), 7.98 (d, J=7.6 Hz, 2H), 7.74 (d, J=9.5 Hz, 1H), 7.58 (d, J=9.3 Hz, 1H), 1.39 (s, 12H). ¹³C NMR (125 MHz, CDCl₃) δ 168.3, 167.2, 140.0, 135.2, 131.3, 128.6, 127.8, 126.7, 118.7, 109.8, 84.2, 24.9. HRMS (ESI) calcd for C₂₁H₂₁BBrN₄O₃ 467.0885 found 467.0890 [M+H]⁺.

### viii. 3-(4-(4,4,5,5-tetramethyl-1,3,2-dioxaborolan-2-yl)phenyl)-5-(6-(trifluoromethyl)imidazo[1,2-a]pyridin-2-yl)-1,2,4-oxadiazole (15c)

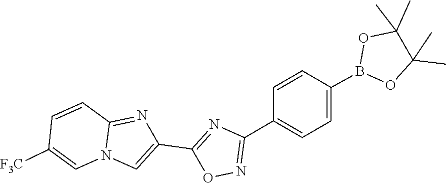 [SMILES: CC1(C)OB(c2ccc(-c3noc(-c4cn5cc(C(F)(F)F)ccc5n4)n3)cc2)OC1(C)C]

White solid, Yield=45%, ¹H NMR (500 MHz, Chloroform-d) (8.54 (s, 1H), 8.41 (s, 1H), 8.16 (d, J=7.5 Hz, 2H), 7.88 (d, J=7.7 Hz, 2H), 7.82 (d, J=9.5 Hz, 1H), 7.40 (d, J=9.5 Hz, 1H), 1.30 (s, 12H). ¹³C NMR (125 MHz, CDCl₃) δ 169.9, 168.3, 144.7, 134.1, 131.9, 127.7, 125.8, 124.3, 124.3, 121.6, 121.6, 118.7, 114.9, 83.1, 23.9. HRMS (ESI) calcd for C₂₂H₂₁BF₃N₄O₃ 457.1653 found 457.1659 [M+H]⁺.

### ix. 5-(3-Bromoimidazo[1,2-a]pyridin-7-yl)-3-(4-(4,4,5,5-tetramethyl-1,3,2-dioxaborolan-2-yl)phenyl)-1,2,4-oxadiazole (15d)

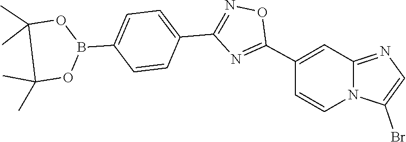 [SMILES: CC1(C)OB(c2ccc(-c3noc(-c4ccn5c(Br)cnc5c4)n3)cc2)OC1(C)C]

White solid, Yield=55%, ¹H NMR (500 MHz, DMSO-d₆) δ 8.56 (d, J=7.1 Hz, 1H), 8.49 (s, 1H), 8.21 (s, 1H), 8.14 (d, J=7.5 Hz, 2H), 7.94 (s, 1H), 7.90 (d, J=7.7 Hz, 1H), 7.78 (s, 1H), 1.35 (s, 12H). ¹³C NMR (125 MHz, DMSO) δ 174.0, 168.3, 136.2, 135.0, 128.4, 126.3, 125.3, 119.1, 117.7, 111.0, 83.8, 24.6. HRMS (ESI) calcd for C₂₁H₂₁BBrN₄O₃ 467.0885 found 467.0894 [M+H]⁺.

### x. (Z)—N′-hydroxy-3-(4,4,5,5-tetramethyl-1,3,2-dioxaborolan-2-yl)benzimidamide (20)

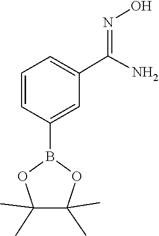 [SMILES: CC1(C)OB(c2cccc(/C(N)=N/O)c2)OC1(C)C]

Yellow liquid, Yield=40%, ¹H NMR (400 MHz, DMSO) δ 9.60 (s, 1H), 8.01 (s, 1H), 7.77 (d, J=8.0 Hz, 1H), 7.66 (d, J=7.3 Hz, 1H), 7.38 (t, J=7.6 Hz, 1H), 5.81 (s, 2H), 1.31 (s, 12H). ¹³C NMR (100 MHz, DMSO) δ 151.2, 135.2, 133.3, 132.1, 128.8, 128.14, 84.2, 25.4.

### xi. 3-(3-(4,4,5,5-tetramethyl-1,3,2-dioxaborolan-2-yl)phenyl)-5-(3,4,5 trimethoxyphenyl)-1,2,4-oxadiazole (21)

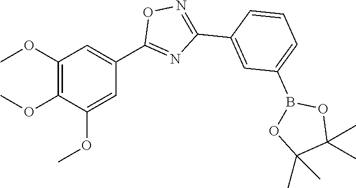

Yellow Solid, Yield=37%, ¹H NMR (400 MHz, CDCl₃) δ 8.54 (s, 1H), 8.19 (d, J=7.7 Hz, 1H), 7.90 (d, J=7.4 Hz, 1H), 7.40 (s, 2H), 7.19 (s, 1H), 3.93 (s, 6H), 3.88 (s, 3H), 1.31 (s, 12H). ¹³C NMR (101 MHz, CDCl₃) δ 174.5, 168.0, 152.6, 141.0, 136.5, 132.8, 129.2, 127.2, 125.4, 118.3, 104.4, 83.1, 60.0, 55.4, 23.9.

### 2. Procedure for the Synthesis of Boron-Containing Quinazolinones

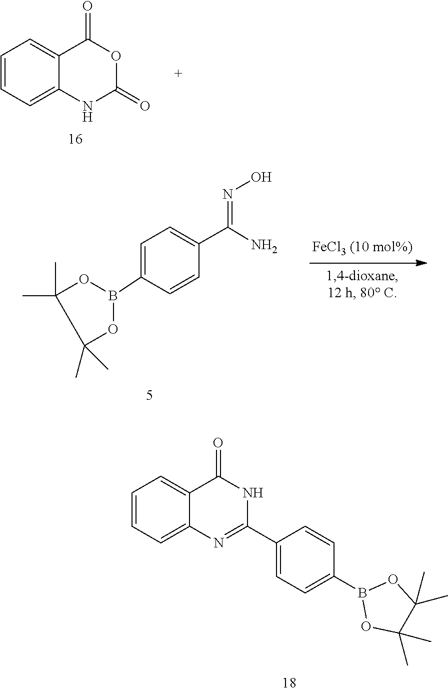 [SMILES: O=c1[nH]c2ccccc2c(=O)o1 ; CC1(C)OB(c2ccc(/C(N)=N/O)cc2)OC1(C)C ; CC1(C)OB(c2ccc(-c3nc4ccccc4c(=O)[nH]3)cc2)OC1(C)C]

To a solution of amidoxime (5) in 1,4-dioxane, isatoic anhydride (16), FeCl₃ (10 mol %) were added and reaction mixture was stirred at 80° C. for 12 h (monitored by TLC). The reaction was allowed to cool at ambient temperature, the mixture was poured into water (20.0 mL), extracted by ethyl acetate (3×15.0 mL), and the combined organic solvent was dried over Na₂SO₄, filtered and concentrated in vacuo. The crude product was purified by silica-gel chromatography to give the quinazolinone product (18).

2-(4-(4,4,5,5-tetramethyl-1,3,2-dioxaborolan-2-yl)phenyl)quinazolin-4(3H)-one (18). White solid, Yield=41%, ¹H NMR (400 MHz, DMSO) δ 12.61 (s, 1H), 8.21-8.15 (m, 3H), 7.85-7.76 (m, 3H), 7.56-7.54 (m, 1H), 7.52 (s, 1H), 1.30 (s, 1H). ¹³C NMR (100 MHz, DMSO) δ 162.6, 152.5, 149.1, 135.1, 134.9, 132.1, 130.3, 128.0, 127.6, 127.2, 126.3, 121.5, 84.5, 25.1. HRMS (ESI) calcd for C₂₀H₂₂BN₂O₃ 349.1718 found 349.1945 [M+H]⁺.

### 3. Optimization of Amidoxime Formation

Amidoximes provide extensive pathways to reach certain bioactive heterocycles, including oxadiazoles and quinazolinone (Baykov, et al. Tetrahedron Lett. 2020, 152403). Oxadiazoles are highly important pharmacologically, and are well-studied core structural units of various muscarinic agonists, benzodiazepine receptor partial agonists (Katritzky, et al. Comprehensive heterocyclic chemistry II; Pergamon, 1996), dopamine transporters (Orlek et al. J. Med. Chem. 1991, 34, 2726), antirhinovirals (Watjen et al. J. Med. Chem. 2002, 32, 228), a growth hormone secretagogue (Carroll et al. J. Med. Chem. 1993, 36, 2886), and 5-HT agonists (Diana et al. J. Med. Chem. 1994, 37, 2421), as well as a urea bioisostere in β3-adrenergic receptor agonists (Ankersen, M.; Peschke, B.; Hansen, B. S.; Hansen, T. K. Bioorganic Med. Chem. Lett. 1997, 7, 1293).

In ongoing chemical biology studies, the synthesis of biology-oriented boron chemicals (BioBCs) as potential probes has been examined to study developmental biology and pharmacological agents for neurodegenerative and other diseases (Liu et al. Tetrahedron Lett. 2008, 49, 1578; Torregroza et al. Chem Biol Drug Des 2009, 73, 339; Das et al. Tetrahedron Lett. 2009, 50, 3031). Previously, the synthesis of Combretastatin A-4 (CA-4), an antimitotic agent binds to the colchicine site on tubulin causing inhibition of tubulin polymerization, microtubule depolymerization, and mitotic block, was reported (Das et al. Tetrahedron Lett. 2009, 50, 3031; Pettit et al. J Nat. Prod. 1987, 50, 119; Lin et al. Biochemistry 1989, 28, 6984). CA-4 exhibits potent cytotoxicity against a broad spectrum of human cancer lines, including multidrug resistance (MDR) lines, and also acts as a vascular disrupting agent (VDA) (Griggs et al. The Lancet. Oncology 2001, 2, 82; Pettit et al. J Nat Prod 1987, 50, 386; Pettit et al. Experientia 1989, 45, 209; Nabha et al. Anti-cancer drugs 2001, 12, 57; McGown and Fox Cancer Chemother Pharmacol 1990, 26, 79; Siemann and Horsman Cell Tissue Res 2009, 335, 241; Bedard et al. Nature reviews. Clinical oncology 2010, 7, 22; Das et al. Tetrahedron Lett. 2012, 53, 3947). With an objective to increase the cytotoxicity and anti-tubulin activity of CA-4, the development of a set of boron containing, 3, 5-disubstituted, 1, 2, 4-oxadiazole derivatives as potential new analogs of CA-4 was envisioned.

In order to limit the steps needed to generate the target compound 3-(4-(4,4,5,5-tetramethyl-1,3,2-dioxaborolan-2-yl)phenyl)-5-(3,4,5-trimethoxyphenyl)-1,2,4-oxadiazole (4), a simple and efficient protocol was strategized. The plan included a new anticipated boronate pre-installed amidoxime moiety 5, which could be easily transformed into the product oxadiazole in a single step method (Scheme 4). Toward this goal, the synthesis of amidoximes via easily obtained chemicals and based on published methods was focused on (Burns et al. Org. Biomol. Chem. 2010, 8, 2777). Generally, the synthetic methods available employ aromatic as well as aliphatic nitriles with hydroxylamine under basic conditions to furnish the corresponding amidoximes (Yang et al. Org. Biomol. Chem. 2015, 13, 2541; Wang et al. Org Biomol Chem 2016, 14, 9814). However, a recent report employed aryl halide to convert directly into amidoxime via a palladium catalysed process in a one-pot cyanation and amidoximation (Yang et al. Org. Biomol. Chem. 2015, 13, 2541).

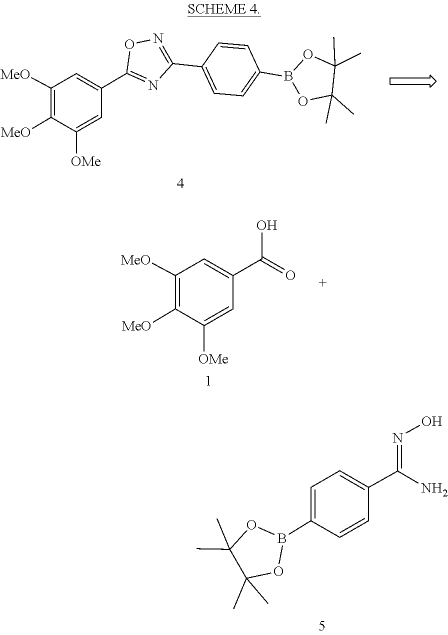

To achieve the amidoxime (5), the study was initiated with 4-cyanophenyl boronic acid pinacol ester (6) as a prototype substrate with hydroxylamine hydrochloride salt as the reagent. Initially, the approach to synthesize the target compound failed using published protocols (Festa et al. ACS Med. Chem. Lett. 2019, 10, 504). Without wishing to be bound by theory, this can likely be explained due to predominant formation of product (Z)—N′,4-dihydroxybenzimidamide (7) (Table 1, entries 1-2). This has been a well-studied reaction in the literature (Kianmehr et al. Tetrahedron Lett. 2007, 48, 2713). To avoid the formation of product 7 and obtain the desired product 5, amine bases were screened as replacements for oxygen bases. No significant formation of the expected product was observed with trimethylamine (Table 1, entry 3). Subsequently, conditions with different temperatures and bases were examined. Surprisingly, under N,N-diisopropylethylamine as base exclusively in ethanol, the corresponding amidoxime product was produced with good yield as a white solid (Table 1, entry 4, 46%) and target product might be lost during the recrystallization process (Burns et al. Org. Biomol. Chem. 2010, 8, 2777). This was further tested under room temperature conditions, which resulted in no product formation (Table 1, entry 5).

TABLE 1

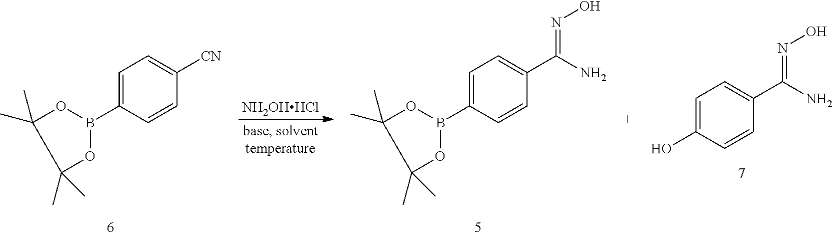 [SMILES: CC1(C)OB(c2ccc(C#N)cc2)OC1(C)C ; "NH2OH·HCl" ; CC1(C)OB(c2ccc(/C(N)=N/O)cc2)OC1(C)C ; N/C(=N\O)c1ccc(O)cc1]

| | | | | Yield (%)^{b} | |
|---|---|---|---|---|---|
| Entry | Base | Solvent | Temperature | 9 | 10 |
| 1 | Na₂CO₃ | Ethanol | reflux | nd | 61 |
| 2 | NaHCO₃ | Ethanol | reflux | trace | 50 |
| 3 | Et₃N | Ethanol | Reflux | 10 | 45 |
| 4 | IPr₂NEt | Ethanol | reflux | 46 | nd |
| 5 | IPr₂NEt | Ethanol | rt | nd | nd |

^{a}Reaction conditions: substate 6 (0.5 mmol), NH₂OH·HCl (1 mmol), base (1 mmol), under reflux conditions.
^{b}Isolated yields.

In brief, (Z)—N′-hydroxy-4-(4,4,5,5-tetramethyl-1,3,2-dioxaborolan-2-yl)benzimidamide (5) was successfully synthesized from 4-(4,4,5,5-tetramethyl-1,3,2-dioxaborolan-2-yl)benzonitrile (6) by using N,N-diisopropylethylamine as base in ethanol under refluxed conditions. The structure of 5 was ascertained by NMR and mass spectrometry data: ¹H NMR (500 MHz, DMSO-d₆) δ 9.75 (s, 1H), 7.72-7.64 (m, 4H), 5.85 (s, 2H), 1.30 (s, 12H). ¹³C NMR (125 MHz, DMSO) δ 150.5, 136.0, 134.1, 126.8, 124.7, 83.7, 24.6. HRMS (EI) Calcd. for C₁₃H₁₉BN₂O₃ [M+H]⁺ requires 263.1561, found 263.1566.

Significantly, it is believed that this is the first report to synthesize this class of boron-containing amidoximes, which further leads to a variety of boron-containing pharmacophore groups. As boron-based compounds are gaining high importance in both academia and the pharmaceutical industry, this type of reagent is highly significant for further development of boron-based biological agents.

### 4. Application to the Synthesis of 1,2,4-Oxadiazoles

In the attempt to synthesize the target compound 4 with the new class of boronated amidoxime compound (5), established conditions were successful. The target compound 4 was synthesized in a single step with good yield (45%, Scheme 5), compared to the previous protocol (Das et al. Tetrahedron Lett. 2012, 53, 3947). Interestingly, the method proves cost effective as it avoids the metal catalyzed protocols and limits the two-step process. Moreover, compounds 8 and 9 were also synthesized by using previously reported method with good yields (Vedejs et al. J. Org. Chem. 1995, 60, 3020; Yuen and Hutton Tetrahedron Lett. 2005, 46, 7899; Molander et al. J. Org. Chem. 2009, 74, 7364; Lennox and Lloyd-Jones Chem. Soc. Rev. 2014, 43, 412).

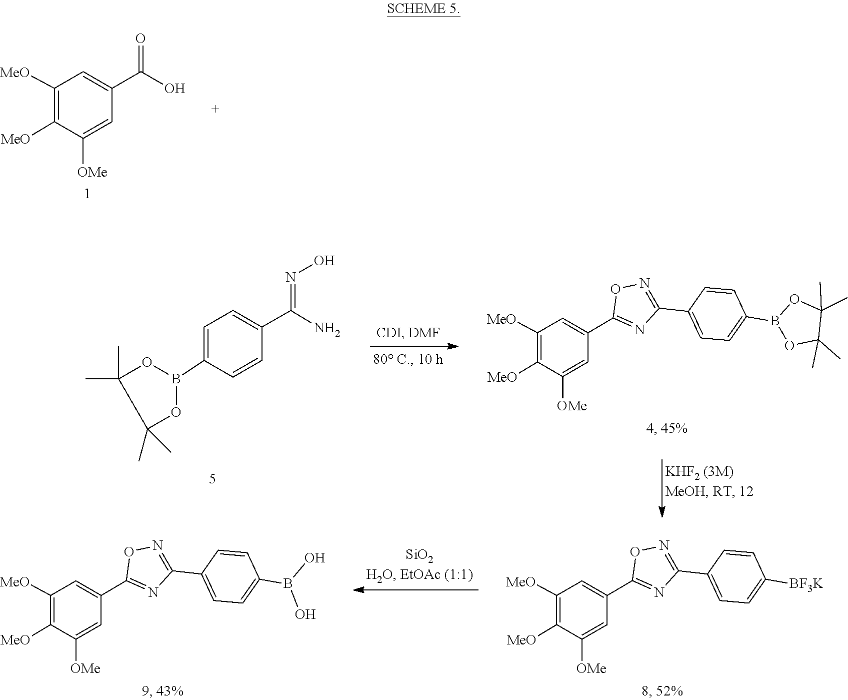

Having achieved proof of concept, the scope was expanded and the reagent was explored with different substrates. In this regard, for the ongoing program to develop potential anti-angiogenic agents through zebrafish phenotypic screening, 6-chloro-3-(3-(4-(4,4,5,5-tetramethyl-1,3,2-dioxaborolan-2-yl)phenyl)-1,2,4-oxadiazol-5-yl)-2H-chromen-2-one (12) and 6-chloro-3-(3-(4-(4,4,5,5-tetramethyl-1,3,2-dioxaborolan-2-yl)phenyl)-1,2,4-oxadiazol-5-yl)quinolin-2(1H)-one (13) were synthesized.

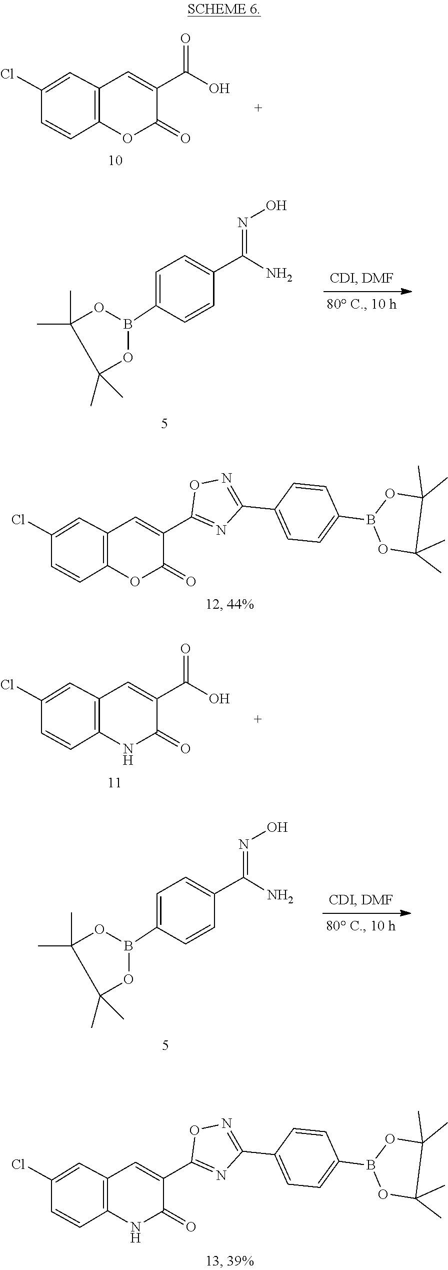

Interestingly, under the standard reaction conditions 2-oxo-chromene carboxylic acid (10) and quinolone carboxylic acid (11) were reacted smoothly with boronated amidoximes (5) and provided the respective products (12, 13) with good yields, (12-44%) and (13-39%) respectively (Scheme 6). It was found that the developed protocol produces the expected products in a single step by using easily available commodities. This procedure overcomes the difficult and costly palladium catalyzed borylation reaction. This methodology will open new avenues to synthesize boron-containing oxadiazoles as potential pharmacological agents.

### 5. Synthesis of Imidazo[1,2-a]Pyridine-Based Compounds

The protocol was further expanded to synthesize imidazo[1,2-a]pyridine based biological active compounds. Imidazo[1,2-a]pyridine is an important pharmacophore group in medicinal chemistry and exhibits a broad range of biological activities such as antifungal, anti-inflammatory, anticancer, antipyretic, antiapoptotic, analgesic, antimicrobial, antiprotozoal, and hypnoselective activities (Patel et al. Adv. Synth. Catal. 2020, 362, 4226; Nandwana et al. ACS Omega 2019, 4, 10140; Patel et al. J. Org. Chem. 2020, 85, 7309; Patel et al. Org. Biomol. Chem. 2018, 16, 8620; Pericherla et al. Synthesis 2015, 47, 887; Nandwana et al. Eur. J. Org. Chem. 2020, 2020, 2576). In addition, the imidazo[1,2-a]pyridine motif is present in various marketed drugs including zolpidem, alpidem, saripidem, zolimidine, necopidem, GSK812397, and GABA receptor.

The synthesis of boron-based imidazo[1,2-a]pyridine compounds was examined. It was found that 7-chloroimidazo[1,2-a]pyridine-3-carboxylic acid (14a) reacted smoothly with boronated amidoxime (5) in the presence of 1,1′-carbonyldiimidazole (CDI) in DMF at 70° C. and afforded the respective product (15a) in 51% yield (Scheme 7). Furthermore, the developed protocol was successfully utilized for the synthesis of other boron based imidazo[1,2-a]pyridine derivatives (15b-d) in 45-55% yields.

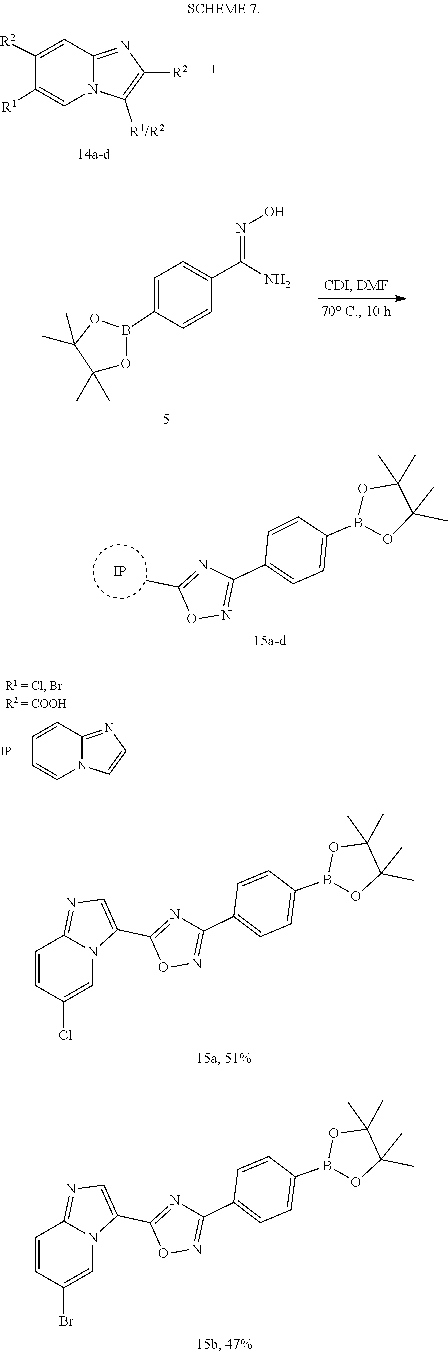

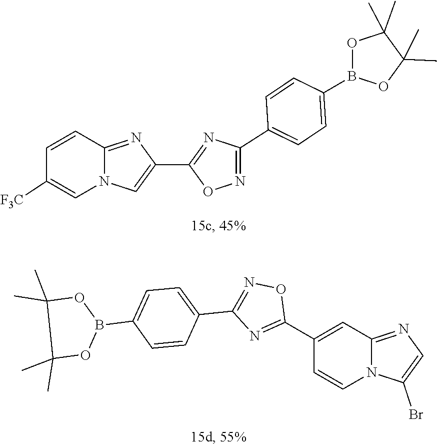

### 6. Synthesis of Quinazolinones

Quinazolinones have received significant attention in medicinal chemistry due to their wide range of biological applications such as antibacterial, anticonvulsant, antifungal, anticancer, anti-inflammatory, anti-HIV, and analgesic activities (Dhiman et al. Chemistry Select 2017, 2, 8016; Nandwana et al. Eur. J. Org. Chem. 2017, 2017, 514; C Sharma et al. Curr. Med. Chem. 2011, 18, 4786). Due to high importance of quinazolinone in drug discovery, the newly synthesized amidoxime reagent were utilized for the synthesis of quinazolinone under reported reaction condition (Mekala et al. Synlett. 2014, 25, 821). For this strategy, compound 5 was reacted with isatoic anhydride (16) using FeCl₃ (10 mol %) as catalyst in 1,4-dioxane at 80° C. for 12 h. The desired product (18) was observed with 41% yield, which reduces the two step synthesis of quinazolinone in a single step and avoids the costly palladium catalyzed borylation reaction (Scheme 8). The structure of 18 was ascertained by NMR and mass spectrometry data: ¹H NMR (400 MHz, DMSO) δ 12.61 (s, 1H), 8.21-8.15 (m, 3H), 7.85-7.76 (m, 3H), 7.56-7.54 (m, 1H), 7.52 (s, 1H), 1.30 (s, 1H). ¹³C NMR (100 MHz, DMSO) δ 162.6, 152.5, 149.1, 135.1, 134.9, 132.1, 130.3, 128.0, 127.6, 127.2, 126.3, 121.5, 84.5, 25.1. HRMS (ESI) calcd for C₂₀H₂₂BN₂O₃ 349.1718 found 349.1945 [M+H]⁺.

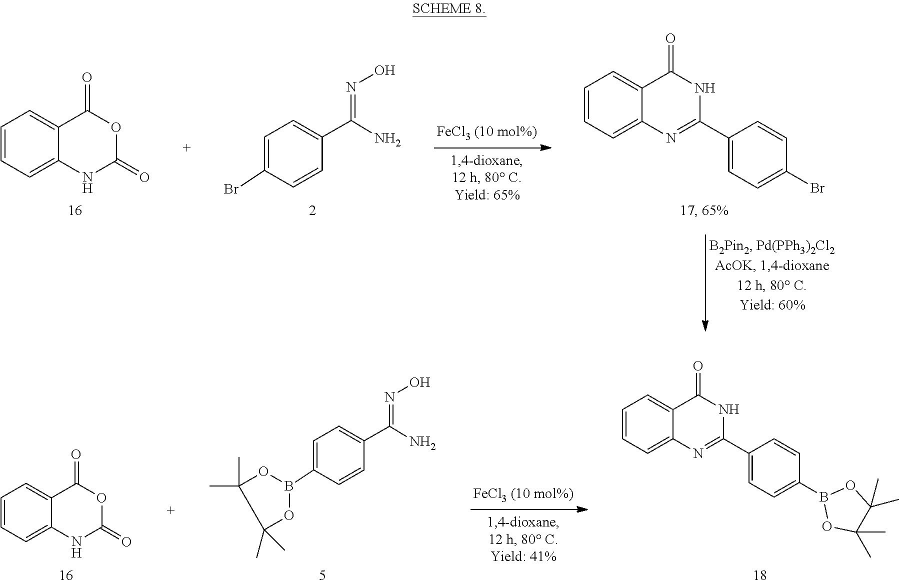 [SMILES: O=c1[nH]c2ccccc2c(=O)o1 ; N/C(=N\O)c1ccc(Br)cc1 ; O=c1[nH]c(-c2ccc(Br)cc2)nc2ccccc12 ; O=c1[nH]c2ccccc2c(=O)o1 ; CC1(C)OB(c2ccc(/C(N)=N/O)cc2)OC1(C)C ; CC1(C)OB(c2ccc(-c3nc4ccccc4c(=O)[nH]3)cc2)OC1(C)C]

### 7. Synthesis of 3-(3-(4,4,5,5-tetramethyl-1,3,2-dioxaborolan-2-yl)phenyl)-5-(3,4,5-trimethoxyphenyl)-1,2,4-oxadiazole from 3-(4,4,5,5-tetramethyl-1,3,2-dioxaborolan-2-yl)benzonitrile

To further explore the utility of the developed protocol, the approach was applied for the synthesis of 3-(3-(4,4,5,5-tetramethyl-1,3,2-dioxaborolan-2-yl)phenyl)-5-(3,4,5-trimethoxyphenyl)-1,2,4-oxadiazole from 3-(4,4,5,5-tetramethyl-1,3,2-dioxaborolan-2-yl)benzonitrile under optimal reaction conditions. Target product (21) was observed with 40% yield, which will open the new window for medicinal chemist for the synthesis of diversely substituted oxadiazole derivatives.

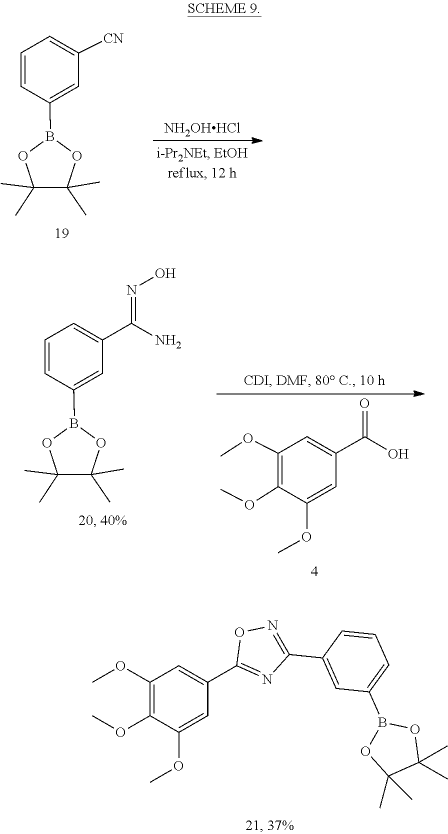

### 8. Discussion

In conclusion, herein is reported the design and synthesis of boron-containing amidoxime reagent (5). This reagent was used to synthesize potential protease inhibitors and antimicrobial agents. This reagent significantly simplifies the synthesis of various pharmacophore groups. An important advantage of this advancement is that it can display different boron-containing prodrugs in a direct transformation as well as avoiding the pre-functionalized substrates. These protocols have demonstrated high synthetic utility via the synthesis of oxadiazoles and quinazolinone derivatives. The developed reagent also shows a wide range of tolerance with Cl, Br, CF₃, and other functional groups under developed reaction conditions. The detail biological studies of these pharmacological agents as potential biological agents is currently undergoing in our laboratory.

### H. REFERENCES

Das, B. C.; Thapa, P.; Karki, R.; Schinke, C.; Das, S.; Kambhampati, S.; Banerjee, S. K.; Van Veldhuizen, P.; Verma, A.; Weiss, L. M. Future Med. Chem. 2013, 5, 653.
Adamczyk-Wozniak, A.; Borys, K. M.; Sporzynski, A. Chem. Rev. 2015, 115, 5224.
Baker, S. J.; Ding, C. Z.; Akama, T.; Zhang, Y.-K.; Hemandez, V.; Xia, Y. Future Med. Chem. 2009, 1, 1275.
Baker, S. J.; Tomsho, J. W.; Benkovic, S. J. Chem. Soc. Rev. 2011, 40, 4279.
Diaz, D. B.; Yudin, A. K. Nat Chem 2017, 9, 731.
Smoum, R.; Rubinstein, A.; Dembitsky, V. M.; Srebnik, M. Chem Rev 2012, 112, 4156.
Touchet, S.; Carreaux, F.; Carboni, B.; Bouillon, A.; Boucher, J. L. Chem Soc Rev 2011, 40, 3895.
Pekol, T.; Daniels, J. S.; Labutti, J.; Parsons, I.; Nix, D.; Baronas, E.; Hsieh, F.; Gan, L. S.; Miwa, G. Drug Metab Dispos 2005, 33, 771.
Baker, S. J.; Zhang, Y. K.; Akama, T.; Lau, A.; Zhou, H.; Hemandez, V.; Mao, W.; Alley, M. R.; Sanders, V.; Plattner, J. J. J Med Chem 2006, 49, 4447.
Hui, X.; Baker, S. J.; Wester, R. C.; Barbadillo, S.; Cashmore, A. K.; Sanders, V.; Hold, K. M.; Akama, T.; Zhang, Y. K.; Plattner, J. J.; Maibach, H. I. J Pharm Sci 2007, 96, 2622.
Moreau, P.; Masszi, T.; Grzasko, N.; Bahlis, N. J.; Hansson, M.; Pour, L.; Sandhu, I.; Ganly, P.; Baker, B. W.; Jackson, S. R. N. Engl. J. Med. 2016, 374, 1621.
Nazarian, R.; Weinberg, J. M. Current opinion in investigational drugs (London, England: 2000) 2009, 10, 1236.
Moustafa, F.; Feldman, S. R. Dermatol Online J2014, 20, 22608.
Peng, X.; Gandhi, V. Ther. Deliv. 2012, 3, 823.
Chen, W.; Balakrishnan, K.; Kuang, Y.; Han, Y.; Fu, M.; Gandhi, V.; Peng, X. J Med. Chem. 2014, 57, 4498.
Baykov, S.; Semenov, A.; Tarasenko, M.; Boyarskiy, V. P. Tetrahedron Lett. 2020, 152403.
Katritzky, A. R.; Rees, C. W.; Scriven, E. F. Comprehensive heterocyclic chemistry II; Pergamon, 1996.
Orlek, B. S.; Blaney, F. E.; Brown, F.; Clark, M. S.; Hadley, M. S.; Hatcher, J.; Riley, G. J.; Rosenberg, H. E.; Wadsworth, H. J.; Wyman, P. J. Med. Chem. 1991, 34, 2726.
Watjen, F.; Baker, R.; Engelstoff, M.; Herbert, R.; MacLeod, A.; Knight, A.; Merchant, K.; Moseley, J.; Saunders, J.; Swain, C. J. J Med. Chem. 2002, 32, 2282.
Carroll, F. I.; Gray, J. L.; Abraham, P.; Kuzemko, M. A.; Lewin, A. H.; Boja, J. W.; Kuhar, M. J. J Med. Chem. 1993, 36, 2886.
Diana, G. D.; Volkots, D. L.; Nitz, T. J.; Bailey, T. R.; Long, M. A.; Vescio, N.; Aldous, S.; Pevear, D. C.; Dutko, F. J. J Med. Chem. 1994, 37, 2421.
Ankersen, M.; Peschke, B.; Hansen, B. S.; Hansen, T. K. Bioorganic Med. Chem. Lett. 1997, 7, 1293.
Liu, F.; Evans, T.; Das, B. C. Tetrahedron Lett. 2008, 49, 1578.
Torregroza, I.; Evans, T.; Das, B. C. Chem Biol Drug Des 2009, 73, 339.
Das, B. C.; Mahalingam, S. M.; Evans, T. Tetrahedron Lett. 2009, 50, 3031.
Pettit, G. R.; Singh, S. B.; Niven, M. L.; Hamel, E.; Schmidt, J. M. J. Nat. Prod. 1987, 50, 119.
Lin, C. M.; Ho, H. H.; Pettit, G. R.; Hamel, E. Biochemistry 1989, 28, 6984.
Griggs, J.; Metcalfe, J. C.; Hesketh, R. The Lancet. Oncology 2001, 2, 82.
Pettit, G. R.; Cragg, G. M.; Singh, S. B. J Nat Prod 1987, 50, 386.
Pettit, G. R.; Singh, S. B.; Hamel, E.; Lin, C. M.; Alberts, D. S.; Garcia-Kendall, D. Experientia 1989, 45, 209.
Nabha, S. M.; Mohammad, R. M.; Wall, N. R.; Dutcher, J. A.; Salkini, B. M.; Pettit, G. R.; Al-Katib, A. M. Anti-cancer drugs 2001, 12, 57.
McGown, A. T.; Fox, B. W. Cancer Chemother Pharmacol 1990, 26, 79.
Siemann, D. W.; Horsman, M. R. Cell Tissue Res 2009, 335, 241.
Bedard, P. L.; Di Leo, A.; Piccart-Gebhart, M. J. Nature reviews. Clinical oncology 2010, 7, 22.
Das, B. C.; Tang, X.-Y.; Rogler, P.; Evans, T. Tetrahedron Lett. 2012, 53, 3947.
Burns, A. R.; Kerr, J. H.; Kerr, W. J.; Passmore, J.; Paterson, L. C.; Watson, A. J. Org. Biomol. Chem. 2010, 8, 2777.
Yang, C. T.; Han, J.; Liu, J.; Gu, M.; Li, Y.; Wen, J.; Yu, H. Z.; Hu, S.; Wang, X. Org. Biomol. Chem. 2015, 13, 2541.
Wang, W.; Xu, H.; Xu, Y.; Ding, T.; Zhang, W.; Ren, Y.; Chang, H. Org Biomol Chem 2016, 14, 9814.
Festa, C.; Finamore, C.; Marchianò, S.; Di Leva, F. S.; Carino, A.; Monti, M. C.; Del Gaudio, F.; Ceccacci, S.; Limongelli, V.; Zampella, A. ACS Med. Chem. Lett. 2019, 10, 504.
Kianmehr, E.; Yahyaee, M.; Tabatabai, K. Tetrahedron Lett. 2007, 48, 2713.
Vedejs, E.; Chapman, R. W.; Fields, S. C.; Lin, S.; Schrimpf, M. R. J. Org. Chem. 1995, 60, 3020.
Yuen, A. K.; Hutton, C. A. Tetrahedron Lett. 2005, 46, 7899.
Molander, G. A.; Cavalcanti, L. N.; Canturk, B.; Pan, P.-S.; Kennedy, L. E. J Org. Chem. 2009, 74, 7364.
Lennox, A. J.; Lloyd-Jones, G. C. Chem. Soc. Rev. 2014, 43, 412.
Patel, O. P.; Nandwana, N. K.; Legoabe, L. J.; Das, B. C.; Kumar, A. Adv. Synth. Catal. 2020, 362, 4226.
Nandwana, N. K.; Patel, O. P.; Srivathsa, M. R.; Kumar, A. ACS Omega 2019, 4, 10140.
Patel, O. P.; Jaspal, S.; Shinde, V. N.; Nandwana, N. K.; Rangan, K.; Kumar, A. J. Org. Chem. 2020, 85, 7309.
Patel, O. P.; Nandwana, N. K.; Sah, A. K.; Kumar, A. Org. Biomol. Chem. 2018, 16, 8620.
Pericherla, K.; Kaswan, P.; Pandey, K.; Kumar, A. Synthesis 2015, 47, 887.
Nandwana, N. K.; Dhiman, S.; Shinde, V. N.; Beifuss, U.; Kumar, A. Eur. J Org. Chem. 2020, 2020, 2576.
Dhiman, S.; Nandwana, N. K.; Dhayal, S.; Saini, H. K.; Kumar, D.; Kumar, A. Chemistry Select 2017, 2, 8016.
Nandwana, N. K.; Dhiman, S.; Saini, H. K.; Kumar, I.; Kumar, A. Eur. J. Org. Chem. 2017, 2017, 514.
C Sharma, P.; Kaur, G.; Pahwa, R.; Sharma, A.; Rajak, H. Curr. Med. Chem. 2011, 18, 4786.
Mekala, R.; Akula, R.; Kamaraju, R. R.; Bannoth, C. K.; Regati, S.; Sarva, J. Synlett. 2014, 25, 821.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of making a compound having a structure represented by a formula: 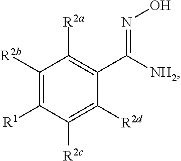
wherein R¹ is selected from —B(OR¹⁰)₂ and —B(R¹¹)₃X;
wherein each occurrence of R¹⁰, when present, is independently selected from hydrogen and C1-C8 alkyl;
wherein each occurrence of R¹¹, when present, is independently halogen;
wherein X, when present, is a counterion; and
wherein each of R^{2a}, R^{2b}, R^{2c}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino,
or a salt thereof, the method comprising reacting an aryl cyanide having a structure represented by a formula: 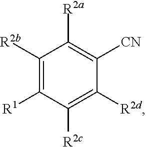
and a hydroxylamine, thereby making the compound.

2. (canceled)

3. The method of claim 1, wherein the compound has a structure represented by a formula: 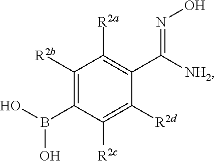
or a salt thereof.

4. (canceled)

5. The method of claim 1, wherein the compound has a structure represented by a formula: 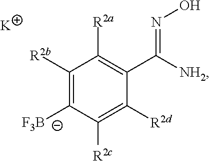
or a salt thereof.

6. The method of claim 1, wherein the compound has a structure represented by a formula: 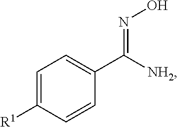
or a salt thereof.

7. (canceled)

8. The method of claim 1, wherein the compound is: 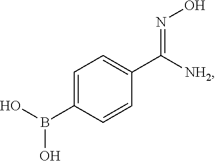 [SMILES: N/C(=N\O)c1ccc(B(O)O)cc1]
or a salt thereof.

9. (canceled)

10. The method of claim 1, wherein the compound is: 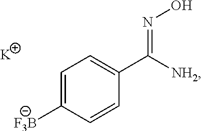
or a salt thereof.

11. The method of claim 1, wherein the hydroxylamine is present as a salt.

12. The method of claim 0, wherein the salt is selected from a halide, acetate, alginate, ascorbate, benzoate, carbonate, cinnamate, citrate, diphosphate, fumarate, gluconate, lactate, laurate, malate, maleate, mesylate, myristate, nitrate, palmitate, phosphate, propionate, sorbate, succinate, sulfate, and tartrate salt.

13. (canceled)

14. The method of claim 1, wherein reacting is in the presence of a base.

15. The method of claim 0, wherein the base is an amine base.

16. (canceled)

17. The method of claim 1, wherein reacting is in the presence of a solvent.

18. (canceled)

19. The method of claim 0, wherein the solvent is an alcohol.

20-21. (canceled)

22. The method of claim 1, wherein reacting is at an elevated temperature.

23. (canceled)

24. The method of claim 1, wherein reacting is for a time period of at least 5 hours.

25-34. (canceled)

35. The method of claim 1, wherein the compound is selected from:

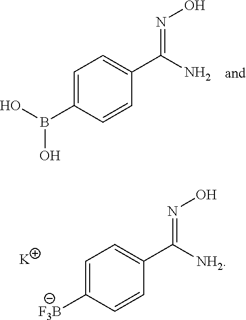

36-37. (canceled)

38. A method of making a compound having a structure represented by a formula: 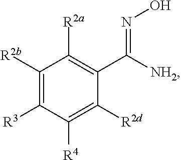
wherein R³ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, and —B(OR¹²)₂;
wherein each occurrence of R¹², when present, is covalently bonded, and, together with the intermediate atoms, comprise a C6 bicyclic heterocycle or a C2-C3 heterocycloalkyl, and is substituted with 0, 12, 2, 3, or 4 C1-C4 alkyl groups;
wherein R⁴ is selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, —B(OR¹³)₂, and —B(R¹⁴)₃X;
wherein each occurrence of R¹³, when present, is independently selected from hydrogen and C1-C8 alkyl;
wherein each occurrence of R¹⁴, when present, is independently halogen;
wherein X, when present, is a counterion; and
wherein each of R^{2a}, R^{2b}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino,
provided that either R³ is —B(OR¹²)₂ or R⁴ is selected from —B(OR¹³)₂ and —B(R¹⁴)₃, and
provided that when R³ is —B(OR¹²)₂, then R⁴ is not —B(OR¹³)₂ or —B(R⁴)₃,
or a salt thereof, the method comprising reacting an aryl cyanide having a structure represented by a formula: 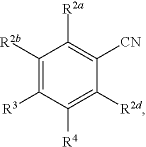
and a hydroxylamine, thereby making the compound.

39-47. (canceled)

48. The method of claim 38, wherein the compound is selected from:

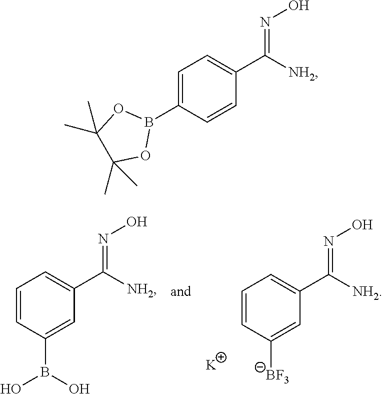

49-74. (canceled)

75. A compound having a structure represented by a formula: 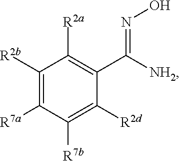
wherein each of R^{7a} and R^{7b} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, C1-C4 alkylamino, and —B(R²⁰)₃X, provided that exactly one of R^{7a} and R^{7b} is —B(R²⁰)₃X;
wherein each occurrence of R²⁰, when present, is independently halogen;
wherein X, when present, is a counterion; and
wherein each of R^{2a}, R^{2b}, and R^{2d} is independently selected from hydrogen, halogen, —CN, —NH₂, —OH, —NO₂, C1-C4 alkyl, C2-C4 alkenyl, C1-C4 haloalkyl, C1-C4 cyanoalkyl, C1-C4 hydroxyalkyl, C1-C4 haloalkoxy, C1-C4 alkoxy, C1-C4 alkylamino, (C1-C4)(C1-C4) dialkylamino, and C1-C4 alkylamino,
or a salt thereof.

76. (canceled)

77. The compound of claim 0, wherein the compound has a structure represented by a formula: 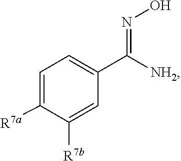
or a salt thereof.

78. The compound of claim 0, wherein the compound is selected from:

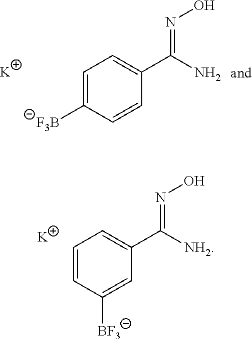

79-118. (canceled)
